(19) United States
(12) Patent Application Publication
(10) Pub. No.: US 2026/0204654 A1
(43) Pub. Date: Jul. 16, 2026

(54) ELECTROLYTES AND ELECTROLYTE ADDITIVES FOR AQUEOUS RECHARGEABLE ZINC BATTERIES

(71) Applicant: NEWSOUTH INNOVATIONS PTY LIMITED, Sydney, New South Wales (AU)

(72) Inventors: Dipan Kundu, Sydney, New South Wales (AU); Yuan Shang, Sydney, New South Wales (AU); Priyank Kumar, Sydney, New South Wales (AU)

(21) Appl. No.: 19/133,498

(22) PCT Filed: Dec. 15, 2023
(86) PCT No.: PCT/AU2023/051302

§ 371 Date: May 28, 2025

(30) Foreign Application Priority Data
Dec. 15, 2022 (AU) 2022903850

(51) Int. Cl. H01M 10/36

(52) U.S. Cl. CPC H01M 10/36; H01M 2300/0002

(57) ABSTRACT

Electrolytes and electrolyte additives for aqueous rechargeable zinc batteries Disclosed herein are electrolytes and electrolyte additives for aqueous rechargeable zinc batteries, as well as aqueous rechargeable zinc batteries incorporating said electrolytes and electrolyte additives. The electrolytes and electrolyte additives comprise an aliphatic alcohol compound having from 4 to 10 carbon atoms.

### CROSS REFERENCE

The present application claims priority to Australian provisional patent application no. 2022903850, filed 15 Dec. 2022, the entire content of which is incorporated herein by reference in its entirety.

### FIELD OF THE INVENTION

The invention relates to electrolytes and electrolyte additives for aqueous rechargeable zinc batteries, as well as aqueous rechargeable zinc batteries incorporating said electrolytes and electrolyte additives. However, it will be appreciated that the invention is not limited to this particular field of use.

### BACKGROUND

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Over the past few decades, batteries, especially Li-ion batteries (LIBs), which have been commercialized with great success, have had disruptive impacts on various industries, such as portable electronic devices, electrical vehicles (EV), and renewable energy storage. However, considering the scarcity of raw materials resources and safety concerns, the large-scale and stationary deployment of LIBs has raised concerns and scrutiny. In this regard, aqueous Zn-metal batteries (AZMBs) are one of the promising alternatives to LIB owing to absolute safety, the resource abundance of raw materials, potential low cost, and competitive energy densities.

Despite the advantages that have inspired aggressive research efforts, scalable development of AZMB technology remains a challenge. (Electro)chemical corrosion of zinc in aqueous zinc salt solution and dendritic zinc metal growth, which are intertwined, severely restrict zinc anode and thus AZMB rechargeability (lifetime), particularly under practically viable conditions. Thermodynamically favorable hydrogen evolution reaction (HER) during Zn deposition can induce a continuous local alkaline environment on the Zn surface, which aside from consuming the aqueous electrolyte, may result in the formation of insulating byproducts such as zinc layered double hydroxides (LDHs)—Zn₄SO₄(OH)₆·xH₂O and Zn(OH)₂. The randomly distributed porous byproducts on zinc can disturb the zinc deposition behavior and trigger early failure by the formation of Zn dendrites.

Further, when a limited zinc anode is used, it can quickly run out due to aggressive corrosion and cell failure by polarization. In view of these problem, AZMBs may suffer from poor cyclability and unsatisfactory Coulombic efficiency (CE) that can severely affect the overall cell performance.

To address these performance-limiting issues and enhance the Zn reversibility and rechargeability, a number of strategies have been explored, including zinc surface coating, improved design of separators, and engineering of electrolyte formulation. In particular, there is interest in exploring novel electrolytes or electrolyte additives to eliminate the water-induced side reactions and chemical/electrochemical corrosion because of their ease of implementation and compatibility with existing battery manufacturing processes.

A variety of different organic additives have been reported to modify the solvation sheath of Zn²⁺ and tame the water activity, which in turn reduces the extent of HER and related side reactions. However, the large fraction of organic additives (≥50%) often employed using such additives is not ideal, as it can counteract the virtues of aqueous electrolytes and lead to a critical drop in ionic conductivity, which may undermine the full cell performance at scale due to an increased polarization on both the anode and cathode side. Accordingly, there is a need to develop novel electrolytes and electrolyte additives that can enable long-term zinc cyclability at low additive concentration and under practical testing conditions for AZMBs.

It is an object of the present invention to overcome or ameliorate one or more the disadvantages of the prior art, or at least to provide a useful alternative.

### SUMMARY OF THE INVENTION

The inventors of the present application have surprisingly discovered that by incorporating an aqueous rechargeable zinc battery electrolyte additive comprising an aliphatic alcohol compound having from 4 to 10 carbon atoms into an aqueous rechargeable zinc battery electrolyte, it is possible to reduce unfavourable water-induced side reactions and/or corrosion in an aqueous rechargeable zinc battery, which in turn may suppress dendritic zinc deposition, thereby improving its rechargeability.

In a first aspect of the invention there is provided an aqueous rechargeable zinc battery electrolyte additive comprising: an aliphatic alcohol compound having from 4 to 10 carbon atoms.

The following options may be used in conjunction with the first aspect, either individually or in any combination.

In certain embodiments, the aliphatic alcohol compound has from 4 to 8 carbon atoms; optionally the aliphatic alcohol compound has from 4 to 7 carbon atoms.

In certain embodiments, the aliphatic alcohol compound is saturated and acyclic.

In certain embodiments, the aliphatic alcohol compound contains one or two hydroxyl groups.

In certain embodiments, the aliphatic alcohol is a diol. In certain embodiments, the diol has the molecular formula O₂CₙHₙ₊₂, wherein n is an integer from 4 to 10, optionally wherein n is an integer from 4 to 8, optionally wherein n is an integer from 4 to 7. In certain embodiments, the diol is selected from the group consisting of butanediol, pentanediol, hexanediol, heptanediol, octanediol, and mixtures thereof. In certain specific embodiments, the diol is selected from the group consisting of 1,2-butanediol; 1,3-butanediol; 1,4-butanediol; 2,3-butanediol; 1,2-pentanediol; 1,3-pentanediol; 1,4-pentanediol; 1,5-pentanediol; 2,3-pentanediol; 2,4-pentanediol; 1,2-hexanediol; 1,3-hexanediol; 1,4-hexanediol; 1,5-hexanediol; 1,6-hexanediol; 1,2-heptanediol; 1,2-octanediol; and mixtures thereof. In certain specific embodiments, the diol is a 1,2-diol. In certain particularly specific embodiments, the diol is 1,2-butanediol or 1,2-pentanediol.

In certain embodiments, the aliphatic alcohol compound is selected from the group consisting of 1-butanol; 1,2-butanediol; and 1,2-pentanediol.

The concentration of the aliphatic alcohol in the aqueous rechargeable zinc battery electrolyte additive may be from about 10% (w/w) to about 100% (w/w), or from about 20% (w/w) to about 100% (w/w), about 30% (w/w) to about 100% (w/w), about 40% (w/w) to about 100% (w/w), about 50% (w/w) to about 100% (w/w), about 60% (w/w) to about 100% (w/w), about 70% (w/w) to about 100% (w/w), about 80% (w/w) to about 100% (w/w), about 90% (w/w) to about 100% (w/w), about 95% (w/w) to about 100% (w/w), about 97% (w/w) to about 100% (w/w), about 50% (w/w) to about 90% (w/w), about 50% (w/w) to about 80% (w/w), about 50% (w/w) to about 70% (w/w), or about 50% (w/w) to about 60% (w/w). It may be greater than or equal to about 10% (w/w), 20% (w/w), 30% (w/w), 40% (w/w), 50% (w/w), 60% (w/w), 70% (w/w), 80% (w/w), 90% (w/w), 95% (w/w), or 97% (w/w). In certain embodiments, it may be, for example, about 10% (w/w), 20% (w/w), 30% (w/w), 40% (w/w), 50% (w/w), 50% (w/w), 60% (w/w), 60% (w/w), 70% (w/w), 80% (w/w), 90% (w/w), 95% (w/w), 97% (w/w), 99% (w/w), 99.5% (w/w), 99.7% (w/w), or 100% (w/w).

In a second aspect of the invention there is provided an aqueous rechargeable zinc battery electrolyte comprising:
the zinc ion battery electrolyte additive according to the first aspect; and
a zinc salt.

The following options may be used in conjunction with the second aspect, either individually or in any combination.

The pH of the electrolyte may be from about 0 to about 7, or from about 0.4 to about 7, about 0.8 to about 7, about 1.2 to about 7, about 1.6 to about 7, about 2 to about 7, about 2.3 to about 7, about 2.6 to about 7, about 2.9 to about 7, about 3.2 to about 7, about 3.5 to about 7, about 3.8 to about 7, about 4.1 to about 7, about 4.4 to about 7, about 4.7 to about 7, about 5 to about 7, about 0 to about 6.8, about 0 to about 6.6, about 0 to about 6.4, about 0 to about 6.2, about 0 to about 6, about 0 to about 5.8, about 0 to about 5.6, about 0 to about 5.4, about 0 to about 5.2, about 0 to about 5, about 2 to about 5, about 2.6 to about 5, about 3.2 to about 5, about 3.8 to about 5, about 4.4 to about 5, about 2 to about 4.4, about 2 to about 3.8, about 2 to about 3.2, or about 2 to about 2.6. It may be greater than or equal to about 0, 0.2, 0.4, 0.6, 0.8, 1, 1.2, 1.4, 1.6, 1.8, 2, 2.3, 2.6, 2.9, or 3.2. It may be less than or equal to about 7, 6.8, 6.6, 6.4, 6.2, 6, 5.8, 5.6, 5.4, 5.2, 5, 4.7, 4.4, 4.1, or 3.8. In certain embodiments, it may be, for example, about 0, 0.2, 0.4, 0.6, 0.8, 1, 1.2, 1.4, 1.6, 1.8, 2, 2.2, 2.3, 2.4, 2.6, 2.8, 2.9, 3, 3.2, 3.4, 3.5, 3.6, 3.8, 4, 4.1, 4.2, 4.4, 4.6, 4.7, 4.8, 5, 5.4, 5.6, 5.8, 6, 6.2, 6.4, 6.6, 6.8, or 7. In certain embodiments, the electrolyte has a pH from about 0 to about 7, optionally from about 3 to about 6.

In certain embodiments, the zinc ion battery electrolyte comprises no, or substantially no glycolate. In certain embodiments, the zinc ion battery electrolyte comprises no, or substantially no glycolate in gel form.

Without being bound by theory, the inventors of the present application postulate that having the alcohol substantially in a protonated form (i.e. substantially in an —OH (alcohol) rather than —O⁻ (alkoxide) form) may enable the —OH groups to adsorb onto the metal electrode surface, thereby preventing corrosion of said surface.

In certain embodiments, the zinc ion battery electrolyte is not a gel electrolyte.

The concentration of the zinc ion battery electrolyte additive in the aqueous rechargeable zinc battery electrolyte may be from about 0.01 vol. % to about 15 vol. %, or from about 0.028 vol. % to about 15 vol. %, about 0.046 vol. % to about 15 vol. %, about 0.064 vol. % to about 15 vol. %, about 0.082 vol. % to about 15 vol. %, about 0.1 vol. % to about 15 vol. %, about 0.59 vol. % to about 15 vol. %, about 1.1 vol. % to about 15 vol. %, about 1.6 vol. % to about 15 vol. %, about 2.1 vol. % to about 15 vol. %, about 2.6 vol. % to about 15 vol. %, about 3 vol. % to about 15 vol. %, about 3.5 vol. % to about 15 vol. %, about 4 vol. % to about 15 vol. %, about 4.5 vol. % to about 15 vol. %, about 5 vol. % to about 15 vol. %, about 0.01 vol. % to about 14 vol. %, about 0.01 vol. % to about 13 vol. %, about 0.01 vol. % to about 12 vol. %, about 0.01 vol. % to about 11 vol. %, about 0.01 vol. % to about 10 vol. %, about 0.01 vol. % to about 9 vol. %, about 0.01 vol. % to about 8 vol. %, about 0.01 vol. % to about 7 vol. %, about 0.01 vol. % to about 6 vol. %, about 0.01 vol. % to about 5 vol. %, about 0.1 vol. % to about 5 vol. %, about 1.1 vol. % to about 5 vol. %, about 2.1 vol. % to about 5 vol. %, about 3 vol. % to about 5 vol. %, about 4 vol. % to about 5 vol. %, about 0.1 vol. % to about 4 vol. %, about 0.1 vol. % to about 3 vol. %, about 0.1 vol. % to about 2.1 vol. %, or about 0.1 vol. % to about 1.1 vol. %. It may be greater than or equal to about 0.01 vol. %, 0.019 vol. %, 0.028 vol. %, 0.037 vol. %, 0.046 vol. %, 0.055 vol. %, 0.064 vol. %, 0.073 vol. %, 0.082 vol. %, 0.091 vol. %, 0.1 vol. %, 0.59 vol. %, 1.1 vol. %, 1.6 vol. %, or 2.1 vol. %. It may be less than or equal to about 15 vol. %, 14 vol. %, 13 vol. %, 12 vol. %, 11 vol. %, 10 vol. %, 9 vol. %, 8 vol. %, 7 vol. %, 6 vol. %, 5 vol. %, 4.5 vol. %, 4 vol. %, 3.5 vol. %, or 3 vol. %. In certain embodiments, it may be, for example, about 0.01 vol. %, 0.019 vol. %, 0.028 vol. %, 0.037 vol. %, 0.046 vol. %, 0.055 vol. %, 0.064 vol. %, 0.073 vol. %, 0.082 vol. %, 0.091 vol. %, 0.1 vol. %, 0.34 vol. %, 0.59 vol. %, 0.84 vol. %, 1.1 vol. %, 1.3 vol. %, 1.6 vol. %, 1.8 vol. %, 2.1 vol. %, 2.3 vol. %, 2.6 vol. %, 2.8 vol. %, 3 vol. %, 3.3 vol. %, 3.5 vol. %, 3.8 vol. %, 4 vol. %, 4.3 vol. %, 4.5 vol. %, 4.8 vol. %, 5 vol. %, 7 vol. %, 8 vol. %, 9 vol. %, 10 vol. %, 11 vol. %, 12 vol. %, 13 vol. %, 14 vol. %, or 15 vol. %. In certain embodiments, the electrolyte comprises from about 0.05 vol. % to about 10 vol. % of the aliphatic alcohol compound. In certain embodiments, the electrolyte comprises from about 0.1 vol. % to about 2 vol. % of the aliphatic alcohol compound; optionally about 1 vol. % of the aliphatic alcohol compound.

The concentration of the zinc salt in the electrolyte may be from about 10 mM to about 5 M, or from about 18 mM to about 5 M, about 26 mM to about 5 M, about 34 mM to about 5 M, about 42 mM to about 5 M, about 50 mM to about 5 M, about 340 mM to about 5 M, about 640 mM to about 5 M, about 940 mM to about 5 M, about 1.2 M to about 5 M, about 1.5 M to about 5 M, about 1.8 M to about 5 M, about 2.1 M to about 5 M, about 2.4 M to about 5 M, about 2.7 M to about 5 M, about 3 M to about 5 M, about 10 mM to about 4.8 M, about 10 mM to about 4.6 M, about 10 mM to about 4.4 M, about 10 mM to about 4.2 M, about 10 mM to about 4 M, about 10 mM to about 3.8 M, about 10 mM to about 3.6 M, about 10 mM to about 3.4 M, about 10 mM to about 3.2 M, about 10 mM to about 3 M, about 50 mM to about 3 M, about 640 mM to about 3 M, about 1.2 M to about 3 M, about 1.8 M to about 3 M, about 2.4 M to about 3 M, about 50 mM to about 2.4 M, about 50 mM to about 1.8 M, about 50 mM to about 1.2 M, or about 50 mM to about 640 mM. It may be greater than or equal to about 10 mM, 14 mM, 18 mM, 22 mM, 26 mM, 30 mM, 34 mM, 38 mM, 42 mM, 46 mM, 50 mM, 340 mM, 640 mM, 940 mM, or 1.2 M. It may be less than or equal to about 5 M, 4.8 M, 4.6 M, 4.4 M, 4.2 M, 4 M, 3.8 M, 3.6 M, 3.4 M, 3.2 M, 3 M, 2.7 M, 2.4 M, 2.1 M, or 1.8 M. In certain embodiments, it may be, for example, about 10 mM, 14 mM, 18 mM, 22 mM, 26 mM, 30 mM, 34 mM, 38 mM, 42 mM, 46 mM, 50 mM, 200 mM, 340 mM, 490 mM, 640 mM, 790 mM, 940 mM, 1.1 M, 1.2 M, 1.4 M, 1.5 M, 1.7 M, 1.8 M, 2 M, 2.1 M, 2.3 M, 2.4 M, 2.6 M, 2.7 M, 2.9 M, 3 M, 3.4 M, 3.6 M, 3.8 M, 4 M, 4.2 M, 4.4 M, 4.6 M, 4.8 M, or 5 M. In certain embodiments, the concentration of the zinc salt in the electrolyte is from about 0.05 M to about 3 M; optionally wherein the concentration of the zinc salt in the electrolyte is about 1 M.

The concentration of water in the aqueous rechargeable zinc battery electrolyte may be from about 50 vol. % to about 99.98 vol. %, or from about 59 vol. % to about 99.98 vol. %, about 68 vol. % to about 99.98 vol. %, about 77 vol. % to about 99.98 vol. %, about 86 vol. % to about 99.98 vol. %, about 95 vol. % to about 99.98 vol. %, about 95.45 vol. % to about 99.98 vol. %, about 95.9 vol. % to about 99.98 vol. %, about 96.35 vol. % to about 99.98 vol. %, about 96.8 vol. % to about 99.98 vol. %, about 97.25 vol. % to about 99.98 vol. %, about 97.7 vol. % to about 99.98 vol. %, about 98.15 vol. % to about 99.98 vol. %, about 98.6 vol. % to about 99.98 vol. %, about 99.05 vol. % to about 99.98 vol. %, about 99.5 vol. % to about 99.98 vol. %, about 50 vol. % to about 99.93 vol. %, about 50 vol. % to about 99.88 vol. %, about 50 vol. % to about 99.84 vol. %, about 50 vol. % to about 99.79 vol. %, about 50 vol. % to about 99.74 vol. %, about 50 vol. % to about 99.69 vol. %, about 50 vol. % to about 99.64 vol. %, about 50 vol. % to about 99.6 vol. %, about 50 vol. % to about 99.55 vol. %, about 50 vol. % to about 99.5 vol. %, about 95 vol. % to about 99.5 vol. %, about 95.9 vol. % to about 99.5 vol. %, about 96.8 vol. % to about 99.5 vol. %, about 97.7 vol. % to about 99.5 vol. %, about 98.6 vol. % to about 99.5 vol. %, about 95 vol. % to about 98.6 vol. %, about 95 vol. % to about 97.7 vol. %, about 95 vol. % to about 96.8 vol. %, or about 95 vol. % to about 95.9 vol. %. It may be greater than or equal to about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.45 vol. %, 95.9 vol. %, 96.35 vol. %, or 96.8 vol. %. It may be less than or equal to about 99.98 vol. %, 99.93 vol. %, 99.88 vol. %, 99.84 vol. %, 99.79 vol. %, 99.74 vol. %, 99.69 vol. %, 99.64 vol. %, 99.6 vol. %, 99.55 vol. %, 99.5 vol. %, 99.05 vol. %, 98.6 vol. %, 98.15 vol. %, or 97.7 vol. %. In certain embodiments, it may be, for example, about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.22 vol. %, 95.45 vol. %, 95.68 vol. %, 95.9 vol. %, 96.12 vol. %, 96.35 vol. %, 96.58 vol. %, 96.8 vol. %, 97.02 vol. %, 97.25 vol. %, 97.48 vol. %, 97.7 vol. %, 97.92 vol. %, 98.15 vol. %, 98.38 vol. %, 98.6 vol. %, 98.82 vol. %, 99.05 vol. %, 99.28 vol. %, 99.5 vol. %, 99.6 vol. %, 99.64 vol. %, 99.69 vol. %, 99.74 vol. %, 99.79 vol. %, 99.84 vol. %, 99.88 vol. %, 99.93 vol. %, or 99.98 vol. %.

The zinc salt may be any zinc salt known in the art. It may be, for example, a halide, sulfate, acetate, or triflate zinc salt. In certain embodiments, the zinc salt is zinc sulfate.

In a third aspect of the invention there is provided an aqueous rechargeable zinc battery, comprising the aqueous zinc battery electrolyte according to the second aspect.

The following options may be used in conjunction with the third aspect, either individually or in any combination.

The aqueous rechargeable zinc battery may comprise a cathode, which may be, for example, a manganese oxide, a transition metal cyanoferrate, a lithium manganese oxide, or a zinc vanadium oxide cathode. In certain embodiments, the aqueous rechargeable zinc battery comprises a ZVO (Zinc Vanadium Oxide) cathode. In certain embodiments, the ZVO cathode comprises Zn_{0.25}V₂O₅ which may optionally be in a hydrated form.

In a fourth aspect of the invention, there is provided use of the aqueous rechargeable zinc battery electrolyte additive according to the first aspect, to improve the rechargeability of a zinc battery.

The following options may be used in conjunction with the fourth aspect, either individually or in any combination.

The use may improve the rechargeability of the aqueous rechargeable zinc battery by from about 10% to about 1000%, or from about 18% to about 1000%, about 26% to about 1000%, about 34% to about 1000%, about 42% to about 1000%, about 50% to about 1000%, about 65% to about 1000%, about 80% to about 1000%, about 95% to about 1000%, about 110% to about 1000%, about 120% to about 1000%, about 140% to about 1000%, about 160% to about 1000%, about 170% to about 1000%, about 180% to about 1000%, about 200% to about 1000%, about 10% to about 920%, about 10% to about 840%, about 10% to about 760%, about 10% to about 680%, about 10% to about 600%, about 10% to about 520%, about 10% to about 440%, about 10% to about 360%, about 10% to about 280%, about 10% to about 200%, about 50% to about 200%, about 80% to about 200%, about 110% to about 200%, about 140% to about 200%, about 170% to about 200%, about 50% to about 170%, about 50% to about 140%, about 50% to about 110%, or about 50% to about 80% compared with an otherwise identical aqueous rechargeable zinc battery without the aqueous zinc battery electrolyte additive in its electrolyte. It may improve the rechargeability of the aqueous rechargeable zinc battery by an amount greater than or equal to about 10%, 14%, 18%, 22%, 26%, 30%, 34%, 38%, 42%, 46%, 50%, 65%, 80%, 95%, or 110% compared with an otherwise identical aqueous rechargeable zinc battery without the aqueous zinc battery electrolyte additive in its electrolyte. In certain embodiments, it may improve the rechargeability of the aqueous rechargeable zinc battery by an amount, for example, about 10%, 14%, 18%, 22%, 26%, 30%, 34%, 38%, 42%, 46%, 50%, 58%, 65%, 72%, 80%, 88%, 95%, 100%, 110%, 120%, 120%, 130%, 140%, 150%, 160%, 160%, 170%, 180%, 180%, 190%, 200%, 360%, 440%, 520%, 600%, 680%, 760%, 840%, 920%, or 1000% compared with an otherwise identical aqueous rechargeable zinc battery without the aqueous zinc battery electrolyte additive in its electrolyte.

In certain embodiments, the zinc battery comprises a base electrolyte that comprises a zinc salt and water.

The concentration of the zinc salt in the base electrolyte may be from about 10 mM to about 5 M, or from about 18 mM to about 5 M, about 26 mM to about 5 M, about 34 mM to about 5 M, about 42 mM to about 5 M, about 50 mM to about 5 M, about 340 mM to about 5 M, about 640 mM to about 5 M, about 940 mM to about 5 M, about 1.2 M to about 5 M, about 1.5 M to about 5 M, about 1.8 M to about 5 M, about 2.1 M to about 5 M, about 2.4 M to about 5 M, about 2.7 M to about 5 M, about 3 M to about 5 M, about 10 mM to about 4.8 M, about 10 mM to about 4.6 M, about 10 mM to about 4.4 M, about 10 mM to about 4.2 M, about 10 mM to about 4 M, about 10 mM to about 3.8 M, about 10 mM to about 3.6 M, about 10 mM to about 3.4 M, about 10 mM to about 3.2 M, about 10 mM to about 3 M, about 50 mM to about 3 M, about 640 mM to about 3 M, about 1.2 M to about 3 M, about 1.8 M to about 3 M, about 2.4 M to about 3 M, about 50 mM to about 2.4 M, about 50 mM to about 1.8 M, about 50 mM to about 1.2 M, or about 50 mM to about 640 mM. It may be greater than or equal to about 10 mM, 14 mM, 18 mM, 22 mM, 26 mM, 30 mM, 34 mM, 38 mM, 42 mM, 46 mM, 50 mM, 340 mM, 640 mM, 940 mM, or 1.2 M. It may be less than or equal to about 5 M, 4.8 M, 4.6 M, 4.4 M, 4.2 M, 4 M, 3.8 M, 3.6 M, 3.4 M, 3.2 M, 3 M, 2.7 M, 2.4 M, 2.1 M, or 1.8 M. In certain embodiments, it may be, for example, about 10 mM, 14 mM, 18 mM, 22 mM, 26 mM, 30 mM, 34 mM, 38 mM, 42 mM, 46 mM, 50 mM, 200 mM, 340 mM, 490 mM, 640 mM, 790 mM, 940 mM, 1.1 M, 1.2 M, 1.4 M, 1.5 M, 1.7 M, 1.8 M, 2 M, 2.1 M, 2.3 M, 2.4 M, 2.6 M, 2.7 M, 2.9 M, 3 M, 3.4 M, 3.6 M, 3.8 M, 4 M, 4.2 M, 4.4 M, 4.6 M, 4.8 M, or 5 M. In certain embodiments, the concentration of the zinc salt in the electrolyte is from about 0.05 M to about 3 M; optionally wherein the concentration of the zinc salt in the electrolyte is about 1 M.

The concentration of water in the base electrolyte may be from about 50 vol. % to about 99.98 vol. %, or from about 59 vol. % to about 99.98 vol. %, about 68 vol. % to about 99.98 vol. %, about 77 vol. % to about 99.98 vol. %, about 86 vol. % to about 99.98 vol. %, about 95 vol. % to about 99.98 vol. %, about 95.45 vol. % to about 99.98 vol. %, about 95.9 vol. % to about 99.98 vol. %, about 96.35 vol. % to about 99.98 vol. %, about 96.8 vol. % to about 99.98 vol. %, about 97.25 vol. % to about 99.98 vol. %, about 97.7 vol. % to about 99.98 vol. %, about 98.15 vol. % to about 99.98 vol. %, about 98.6 vol. % to about 99.98 vol. %, about 99.05 vol. % to about 99.98 vol. %, about 99.5 vol. % to about 99.98 vol. %, about 50 vol. % to about 99.93 vol. %, about 50 vol. % to about 99.88 vol. %, about 50 vol. % to about 99.84 vol. %, about 50 vol. % to about 99.79 vol. %, about 50 vol. % to about 99.74 vol. %, about 50 vol. % to about 99.69 vol. %, about 50 vol. % to about 99.64 vol. %, about 50 vol. % to about 99.6 vol. %, about 50 vol. % to about 99.55 vol. %, about 50 vol. % to about 99.5 vol. %, about 95 vol. % to about 99.5 vol. %, about 95.9 vol. % to about 99.5 vol. %, about 96.8 vol. % to about 99.5 vol. %, about 97.7 vol. % to about 99.5 vol. %, about 98.6 vol. % to about 99.5 vol. %, about 95 vol. % to about 98.6 vol. %, about 95 vol. % to about 97.7 vol. %, about 95 vol. % to about 96.8 vol. %, or about 95 vol. % to about 95.9 vol. %. It may be greater than or equal to about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.45 vol. %, 95.9 vol. %, 96.35 vol. %, or 96.8 vol. %. It may be less than or equal to about 99.98 vol. %, 99.93 vol. %, 99.88 vol. %, 99.84 vol. %, 99.79 vol. %, 99.74 vol. %, 99.69 vol. %, 99.64 vol. %, 99.6 vol. %, 99.55 vol. %, 99.5 vol. %, 99.05 vol. %, 98.6 vol. %, 98.15 vol. %, or 97.7 vol. %. In certain embodiments, it may be, for example, about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.22 vol. %, 95.45 vol. %, 95.68 vol. %, 95.9 vol. %, 96.12 vol. %, 96.35 vol. %, 96.58 vol. %, 96.8 vol. %, 97.02 vol. %, 97.25 vol. %, 97.48 vol. %, 97.7 vol. %, 97.92 vol. %, 98.15 vol. %, 98.38 vol. %, 98.6 vol. %, 98.82 vol. %, 99.05 vol. %, 99.28 vol. %, 99.5 vol. %, 99.6 vol. %, 99.64 vol. %, 99.69 vol. %, 99.74 vol. %, 99.79 vol. %, 99.84 vol. %, 99.88 vol. %, 99.93 vol. %, or 99.98 vol. %.

The zinc salt may be any zinc salt known in the art. It may be, for example, a halide, sulfate, acetate, or triflate zinc salt. In certain embodiments, the zinc salt is zinc sulfate.

In certain embodiments, the use of the fourth aspect may result in the battery comprising the electrolyte according to the second aspect.

In a fifth aspect of the invention, there is provided a method for improving the rechargeability of an aqueous rechargeable zinc battery comprising an electrolyte, said method comprising the following step:
combining the aqueous zinc battery electrolyte additive according to the first aspect with the electrolyte to thereby improve the rechargeability of the zinc battery.

The following options may be used in conjunction with the fifth aspect, either individually or in any combination.

The method may improve the rechargeability of the aqueous rechargeable zinc battery by from about 10% to about 1000%, or from about 18% to about 1000%, about 26% to about 1000%, about 34% to about 1000%, about 42% to about 1000%, about 50% to about 1000%, about 65% to about 1000%, about 80% to about 1000%, about 95% to about 1000%, about 110% to about 1000%, about 120% to about 1000%, about 140% to about 1000%, about 160% to about 1000%, about 170% to about 1000%, about 180% to about 1000%, about 200% to about 1000%, about 10% to about 920%, about 10% to about 840%, about 10% to about 760%, about 10% to about 680%, about 10% to about 600%, about 10% to about 520%, about 10% to about 440%, about 10% to about 360%, about 10% to about 280%, about 10% to about 200%, about 50% to about 200%, about 80% to about 200%, about 110% to about 200%, about 140% to about 200%, about 170% to about 200%, about 50% to about 170%, about 50% to about 140%, about 50% to about 110%, or about 50% to about 80% compared with an otherwise identical aqueous rechargeable zinc battery without the aqueous zinc battery electrolyte additive in its electrolyte. It may improve the rechargeability of the aqueous rechargeable zinc battery by an amount greater than or equal to about 10%, 14%, 18%, 22%, 26%, 30%, 34%, 38%, 42%, 46%, 50%, 65%, 80%, 95%, or 110% compared with an otherwise identical aqueous rechargeable zinc battery without the aqueous zinc battery electrolyte additive in its electrolyte. In certain embodiments, it may improve the rechargeability of the aqueous rechargeable zinc battery by an amount, for example, about 10%, 14%, 18%, 22%, 26%, 30%, 34%, 38%, 42%, 46%, 50%, 58%, 65%, 72%, 80%, 88%, 95%, 100%, 110%, 120%, 120%, 130%, 140%, 150%, 160%, 160%, 170%, 180%, 180%, 190%, 200%, 360%, 440%, 520%, 600%, 680%, 760%, 840%, 920%, or 1000% compared with an otherwise identical aqueous rechargeable zinc battery without the aqueous zinc battery electrolyte additive in its electrolyte.

In certain embodiments, the zinc battery comprises a base electrolyte that comprises a zinc salt and water.

The concentration of the zinc salt in the base electrolyte may be from about 10 mM to about 5 M, or from about 18 mM to about 5 M, about 26 mM to about 5 M, about 34 mM to about 5 M, about 42 mM to about 5 M, about 50 mM to about 5 M, about 340 mM to about 5 M, about 640 mM to about 5 M, about 940 mM to about 5 M, about 1.2 M to about 5 M, about 1.5 M to about 5 M, about 1.8 M to about 5 M, about 2.1 M to about 5 M, about 2.4 M to about 5 M, about 2.7 M to about 5 M, about 3 M to about 5 M, about 10 mM to about 4.8 M, about 10 mM to about 4.6 M, about 10 mM to about 4.4 M, about 10 mM to about 4.2 M, about 10 mM to about 4 M, about 10 mM to about 3.8 M, about 10 mM to about 3.6 M, about 10 mM to about 3.4 M, about 10 mM to about 3.2 M, about 10 mM to about 3 M, about 50 mM to about 3 M, about 640 mM to about 3 M, about 1.2 M to about 3 M, about 1.8 M to about 3 M, about 2.4 M to about 3 M, about 50 mM to about 2.4 M, about 50 mM to about 1.8 M, about 50 mM to about 1.2 M, or about 50 mM to about 640 mM. It may be greater than or equal to about 10 mM, 14 mM, 18 mM, 22 mM, 26 mM, 30 mM, 34 mM, 38 mM, 42 mM, 46 mM, 50 mM, 340 mM, 640 mM, 940 mM, or 1.2 M. It may be less than or equal to about 5 M, 4.8 M, 4.6 M, 4.4 M, 4.2 M, 4 M, 3.8 M, 3.6 M, 3.4 M, 3.2 M, 3 M, 2.7 M, 2.4 M, 2.1 M, or 1.8 M. In certain embodiments, it may be, for example, about 10 mM, 14 mM, 18 mM, 22 mM, 26 mM, 30 mM, 34 mM, 38 mM, 42 mM, 46 mM, 50 mM, 200 mM, 340 mM, 490 mM, 640 mM, 790 mM, 940 mM, 1.1 M, 1.2 M, 1.4 M, 1.5 M, 1.7 M, 1.8 M, 2 M, 2.1 M, 2.3 M, 2.4 M, 2.6 M, 2.7 M, 2.9 M, 3 M, 3.4 M, 3.6 M, 3.8 M, 4 M, 4.2 M, 4.4 M, 4.6 M, 4.8 M, or 5 M. In certain embodiments, the concentration of the zinc salt in the electrolyte is from about 0.05 M to about 3 M; optionally wherein the concentration of the zinc salt in the electrolyte is about 1 M.

The concentration of water in the base electrolyte may be from about 50 vol. % to about 99.98 vol. %, or from about 59 vol. % to about 99.98 vol. %, about 68 vol. % to about 99.98 vol. %, about 77 vol. % to about 99.98 vol. %, about 86 vol. % to about 99.98 vol. %, about 95 vol. % to about 99.98 vol. %, about 95.45 vol. % to about 99.98 vol. %, about 95.9 vol. % to about 99.98 vol. %, about 96.35 vol. % to about 99.98 vol. %, about 96.8 vol. % to about 99.98 vol. %, about 97.25 vol. % to about 99.98 vol. %, about 97.7 vol. % to about 99.98 vol. %, about 98.15 vol. % to about 99.98 vol. %, about 98.6 vol. % to about 99.98 vol. %, about 99.05 vol. % to about 99.98 vol. %, about 99.5 vol. % to about 99.98 vol. %, about 50 vol. % to about 99.93 vol. %, about 50 vol. % to about 99.88 vol. %, about 50 vol. % to about 99.84 vol. %, about 50 vol. % to about 99.79 vol. %, about 50 vol. % to about 99.74 vol. %, about 50 vol. % to about 99.69 vol. %, about 50 vol. % to about 99.64 vol. %, about 50 vol. % to about 99.6 vol. %, about 50 vol. % to about 99.55 vol. %, about 50 vol. % to about 99.5 vol. %, about 95 vol. % to about 99.5 vol. %, about 95.9 vol. % to about 99.5 vol. %, about 96.8 vol. % to about 99.5 vol. %, about 97.7 vol. % to about 99.5 vol. %, about 98.6 vol. % to about 99.5 vol. %, about 95 vol. % to about 98.6 vol. %, about 95 vol. % to about 97.7 vol. %, about 95 vol. % to about 96.8 vol. %, or about 95 vol. % to about 95.9 vol. %. It may be greater than or equal to about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.45 vol. %, 95.9 vol. %, 96.35 vol. %, or 96.8 vol. %. It may be less than or equal to about 99.98 vol. %, 99.93 vol. %, 99.88 vol. %, 99.84 vol. %, 99.79 vol. %, 99.74 vol. %, 99.69 vol. %, 99.64 vol. %, 99.6 vol. %, 99.55 vol. %, 99.5 vol. %, 99.05 vol. %, 98.6 vol. %, 98.15 vol. %, or 97.7 vol. %. In certain embodiments, it may be, for example, about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.22 vol. %, 95.45 vol. %, 95.68 vol. %, 95.9 vol. %, 96.12 vol. %, 96.35 vol. %, 96.58 vol. %, 96.8 vol. %, 97.02 vol. %, 97.25 vol. %, 97.48 vol. %, 97.7 vol. %, 97.92 vol. %, 98.15 vol. %, 98.38 vol. %, 98.6 vol. %, 98.82 vol. %, 99.05 vol. %, 99.28 vol. %, 99.5 vol. %, 99.6 vol. %, 99.64 vol. %, 99.69 vol. %, 99.74 vol. %, 99.79 vol. %, 99.84 vol. %, 99.88 vol. %, 99.93 vol. %, or 99.98 vol. %.

The zinc salt may be any zinc salt known in the art. It may be, for example, a halide, sulfate, acetate, or triflate zinc salt. In certain embodiments, the zinc salt is zinc sulfate.

In certain embodiments, the method of the fifth aspect may result in the battery comprising the electrolyte according to the second aspect.

In a sixth aspect of the invention, there is provided a method for preventing zinc anode corrosion and zinc dendrite growth in an aqueous rechargeable zinc battery comprising an electrolyte, said method comprising the following step:
combining the aqueous zinc battery electrolyte additive according to the first aspect with the electrolyte to thereby prevent zinc anode corrosion and zinc dendrite growth.

The following options may be used in conjunction with the sixth aspect, either individually or in any combination.

The method may reduce the amount of zinc anode corrosion and zinc dendrite growth by from about 0.5% to about 100%, or from about 4.4% to about 100%, about 8.3% to about 100%, about 12% to about 100%, about 16% to about 100%, about 20% to about 100%, about 27% to about 100%, about 34% to about 100%, about 41% to about 100%, about 48% to about 100%, about 55% to about 100%, about 62% to about 100%, about 69% to about 100%, about 76% to about 100%, about 83% to about 100%, about 90% to about 100%, about 0.5% to about 99%, about 0.5% to about 98%, about 0.5% to about 97%, about 0.5% to about 96%, about 0.5% to about 95%, about 0.5% to about 94%, about 0.5% to about 93%, about 0.5% to about 92%, about 0.5% to about 91%, about 0.5% to about 90%, about 20% to about 90%, about 34% to about 90%, about 48% to about 90%, about 62% to about 90%, about 76% to about 90%, about 20% to about 76%, about 20% to about 62%, about 20% to about 48%, or about 20% to about 34% compared with an otherwise identical aqueous rechargeable zinc battery without the aqueous zinc battery electrolyte additive in its electrolyte. It may reduce the amount of zinc anode corrosion and zinc dendrite growth by an amount greater than or equal to about 0.5%, 2.4%, 4.4%, 6.4%, 8.3%, 10%, 12%, 14%, 16%, 18%, 20%, 27%, 34%, 41%, or 48% compared with an otherwise identical aqueous rechargeable zinc battery without the aqueous zinc battery electrolyte additive in its electrolyte. In certain embodiments, It may reduce the amount of zinc anode corrosion and zinc dendrite growth by an amount, for example, about 0.5%, 2.4%, 4.4%, 6.4%, 8.3%, 10%, 12%, 14%, 16%, 18%, 20%, 24%, 27%, 30%, 34%, 38%, 41%, 44%, 48%, 52%, 55%, 58%, 62%, 66%, 69%, 72%, 76%, 80%, 83%, 86%, 90%, 92%, 93%, 94%, 95%, 96%, 97%, 98%, 99%, or 100% compared with an otherwise identical aqueous rechargeable zinc battery without the aqueous zinc battery electrolyte additive in its electrolyte.

In certain embodiments, the aqueous rechargeable zinc battery may comprise a base electrolyte that comprises a zinc salt and water.

The concentration of the zinc salt in the base electrolyte may be from about 10 mM to about 5 M, or from about 18 mM to about 5 M, about 26 mM to about 5 M, about 34 mM to about 5 M, about 42 mM to about 5 M, about 50 mM to about 5 M, about 340 mM to about 5 M, about 640 mM to about 5 M, about 940 mM to about 5 M, about 1.2 M to about 5 M, about 1.5 M to about 5 M, about 1.8 M to about 5 M, about 2.1 M to about 5 M, about 2.4 M to about 5 M, about 2.7 M to about 5 M, about 3 M to about 5 M, about 10 mM to about 4.8 M, about 10 mM to about 4.6 M, about 10 mM to about 4.4 M, about 10 mM to about 4.2 M, about 10 mM to about 4 M, about 10 mM to about 3.8 M, about 10 mM to about 3.6 M, about 10 mM to about 3.4 M, about 10 mM to about 3.2 M, about 10 mM to about 3 M, about 50 mM to about 3 M, about 640 mM to about 3 M, about 1.2 M to about 3 M, about 1.8 M to about 3 M, about 2.4 M to about 3 M, about 50 mM to about 2.4 M, about 50 mM to about 1.8 M, about 50 mM to about 1.2 M, or about 50 mM to about 640 mM. It may be greater than or equal to about 10 mM, 14 mM, 18 mM, 22 mM, 26 mM, 30 mM, 34 mM, 38 mM, 42 mM, 46 mM, 50 mM, 340 mM, 640 mM, 940 mM, or 1.2 M. It may be less than or equal to about 5 M, 4.8 M, 4.6 M, 4.4 M, 4.2 M, 4 M, 3.8 M, 3.6 M, 3.4 M, 3.2 M, 3 M, 2.7 M, 2.4 M, 2.1 M, or 1.8 M. In certain embodiments, it may be, for example, about 10 mM, 14 mM, 18 mM, 22 mM, 26 mM, 30 mM, 34 mM, 38 mM, 42 mM, 46 mM, 50 mM, 200 mM, 340 mM, 490 mM, 640 mM, 790 mM, 940 mM, 1.1 M, 1.2 M, 1.4 M, 1.5 M, 1.7 M, 1.8 M, 2 M, 2.1 M, 2.3 M, 2.4 M, 2.6 M, 2.7 M, 2.9 M, 3 M, 3.4 M, 3.6 M, 3.8 M, 4 M, 4.2 M, 4.4 M, 4.6 M, 4.8 M, or 5 M. In certain embodiments, the concentration of the zinc salt in the electrolyte is from about 0.05 M to about 3 M; optionally wherein the concentration of the zinc salt in the electrolyte is about 1 M.

The concentration of water in the base electrolyte may be from about 50 vol. % to about 99.98 vol. %, or from about 59 vol. % to about 99.98 vol. %, about 68 vol. % to about 99.98 vol. %, about 77 vol. % to about 99.98 vol. %, about 86 vol. % to about 99.98 vol. %, about 95 vol. % to about 99.98 vol. %, about 95.45 vol. % to about 99.98 vol. %, about 95.9 vol. % to about 99.98 vol. %, about 96.35 vol. % to about 99.98 vol. %, about 96.8 vol. % to about 99.98 vol. %, about 97.25 vol. % to about 99.98 vol. %, about 97.7 vol. % to about 99.98 vol. %, about 98.15 vol. % to about 99.98 vol. %, about 98.6 vol. % to about 99.98 vol. %, about 99.05 vol. % to about 99.98 vol. %, about 99.5 vol. % to about 99.98 vol. %, about 50 vol. % to about 99.93 vol. %, about 50 vol. % to about 99.88 vol. %, about 50 vol. % to about 99.84 vol. %, about 50 vol. % to about 99.79 vol. %, about 50 vol. % to about 99.74 vol. %, about 50 vol. % to about 99.69 vol. %, about 50 vol. % to about 99.64 vol. %, about 50 vol. % to about 99.6 vol. %, about 50 vol. % to about 99.55 vol. %, about 50 vol. % to about 99.5 vol. %, about 95 vol. % to about 99.5 vol. %, about 95.9 vol. % to about 99.5 vol. %, about 96.8 vol. % to about 99.5 vol. %, about 97.7 vol. % to about 99.5 vol. %, about 98.6 vol. % to about 99.5 vol. %, about 95 vol. % to about 98.6 vol. %, about 95 vol. % to about 97.7 vol. %, about 95 vol. % to about 96.8 vol. %, or about 95 vol. % to about 95.9 vol. %. It may be greater than or equal to about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.45 vol. %, 95.9 vol. %, 96.35 vol. %, or 96.8 vol. %. It may be less than or equal to about 99.98 vol. %, 99.93 vol. %, 99.88 vol. %, 99.84 vol. %, 99.79 vol. %, 99.74 vol. %, 99.69 vol. %, 99.64 vol. %, 99.6 vol. %, 99.55 vol. %, 99.5 vol. %, 99.05 vol. %, 98.6 vol. %, 98.15 vol. %, or 97.7 vol. %. In certain embodiments, it may be, for example, about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.22 vol. %, 95.45 vol. %, 95.68 vol. %, 95.9 vol. %, 96.12 vol. %, 96.35 vol. %, 96.58 vol. %, 96.8 vol. %, 97.02 vol. %, 97.25 vol. %, 97.48 vol. %, 97.7 vol. %, 97.92 vol. %, 98.15 vol. %, 98.38 vol. %, 98.6 vol. %, 98.82 vol. %, 99.05 vol. %, 99.28 vol. %, 99.5 vol. %, 99.6 vol. %, 99.64 vol. %, 99.69 vol. %, 99.74 vol. %, 99.79 vol. %, 99.84 vol. %, 99.88 vol. %, 99.93 vol. %, or 99.98 vol. %.

The zinc salt may be any zinc salt known in the art. It may be, for example, a halide, sulfate, acetate, or triflate zinc salt. In certain embodiments, the zinc salt is zinc sulfate.

In certain embodiments, the method of the sixth aspect may result in the battery comprising the electrolyte according to the second aspect.

In a seventh aspect of the invention, there is provided a method for producing an aqueous rechargeable zinc battery electrolyte, comprising combining the aqueous zinc battery electrolyte additive according to the first aspect with a base electrolyte, wherein the base electrolyte comprises a zinc ion.

The following options may be used in conjunction with the sixth aspect, either individually or in any combination.

In certain embodiments, the base electrolyte that comprises a zinc salt and water.

The concentration of the zinc salt in the base electrolyte may be from about 10 mM to about 5 M, or from about 18 mM to about 5 M, about 26 mM to about 5 M, about 34 mM to about 5 M, about 42 mM to about 5 M, about 50 mM to about 5 M, about 340 mM to about 5 M, about 640 mM to about 5 M, about 940 mM to about 5 M, about 1.2 M to about 5 M, about 1.5 M to about 5 M, about 1.8 M to about 5 M, about 2.1 M to about 5 M, about 2.4 M to about 5 M, about 2.7 M to about 5 M, about 3 M to about 5 M, about 10 mM to about 4.8 M, about 10 mM to about 4.6 M, about 10 mM to about 4.4 M, about 10 mM to about 4.2 M, about 10 mM to about 4 M, about 10 mM to about 3.8 M, about 10 mM to about 3.6 M, about 10 mM to about 3.4 M, about 10 mM to about 3.2 M, about 10 mM to about 3 M, about 50 mM to about 3 M, about 640 mM to about 3 M, about 1.2 M to about 3 M, about 1.8 M to about 3 M, about 2.4 M to about 3 M, about 50 mM to about 2.4 M, about 50 mM to about 1.8 M, about 50 mM to about 1.2 M, or about 50 mM to about 640 mM. It may be greater than or equal to about 10 mM, 14 mM, 18 mM, 22 mM, 26 mM, 30 mM, 34 mM, 38 mM, 42 mM, 46 mM, 50 mM, 340 mM, 640 mM, 940 mM, or 1.2 M. It may be less than or equal to about 5 M, 4.8 M, 4.6 M, 4.4 M, 4.2 M, 4 M, 3.8 M, 3.6 M, 3.4 M, 3.2 M, 3 M, 2.7 M, 2.4 M, 2.1 M, or 1.8 M. In certain embodiments, it may be, for example, about 10 mM, 14 mM, 18 mM, 22 mM, 26 mM, 30 mM, 34 mM, 38 mM, 42 mM, 46 mM, 50 mM, 200 mM, 340 mM, 490 mM, 640 mM, 790 mM, 940 mM, 1.1 M, 1.2 M, 1.4 M, 1.5 M, 1.7 M, 1.8 M, 2 M, 2.1 M, 2.3 M, 2.4 M, 2.6 M, 2.7 M, 2.9 M, 3 M, 3.4 M, 3.6 M, 3.8 M, 4 M, 4.2 M, 4.4 M, 4.6 M, 4.8 M, or 5 M. In certain embodiments, the concentration of the zinc salt in the electrolyte is from about 0.05 M to about 3 M; optionally wherein the concentration of the zinc salt in the electrolyte is about 1 M.

The concentration of water in the base electrolyte may be from about 50 vol. % to about 99.98 vol. %, or from about 59 vol. % to about 99.98 vol. %, about 68 vol. % to about 99.98 vol. %, about 77 vol. % to about 99.98 vol. %, about 86 vol. % to about 99.98 vol. %, about 95 vol. % to about 99.98 vol. %, about 95.45 vol. % to about 99.98 vol. %, about 95.9 vol. % to about 99.98 vol. %, about 96.35 vol. % to about 99.98 vol. %, about 96.8 vol. % to about 99.98 vol. %, about 97.25 vol. % to about 99.98 vol. %, about 97.7 vol. % to about 99.98 vol. %, about 98.15 vol. % to about 99.98 vol. %, about 98.6 vol. % to about 99.98 vol. %, about 99.05 vol. % to about 99.98 vol. %, about 99.5 vol. % to about 99.98 vol. %, about 50 vol. % to about 99.93 vol. %, about 50 vol. % to about 99.88 vol. %, about 50 vol. % to about 99.84 vol. %, about 50 vol. % to about 99.79 vol. %, about 50 vol. % to about 99.74 vol. %, about 50 vol. % to about 99.69 vol. %, about 50 vol. % to about 99.64 vol. %, about 50 vol. % to about 99.6 vol. %, about 50 vol. % to about 99.55 vol. %, about 50 vol. % to about 99.5 vol. %, about 95 vol. % to about 99.5 vol. %, about 95.9 vol. % to about 99.5 vol. %, about 96.8 vol. % to about 99.5 vol. %, about 97.7 vol. % to about 99.5 vol. %, about 98.6 vol. % to about 99.5 vol. %, about 95 vol. % to about 98.6 vol. %, about 95 vol. % to about 97.7 vol. %, about 95 vol. % to about 96.8 vol. %, or about 95 vol. % to about 95.9 vol. %. It may be greater than or equal to about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.45 vol. %, 95.9 vol. %, 96.35 vol. %, or 96.8 vol. %. It may be less than or equal to about 99.98 vol. %, 99.93 vol. %, 99.88 vol. %, 99.84 vol. %, 99.79 vol. %, 99.74 vol. %, 99.69 vol. %, 99.64 vol. %, 99.6 vol. %, 99.55 vol. %, 99.5 vol. %, 99.05 vol. %, 98.6 vol. %, 98.15 vol. %, or 97.7 vol. %. In certain embodiments, it may be, for example, about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.22 vol. %, 95.45 vol. %, 95.68 vol. %, 95.9 vol. %, 96.12 vol. %, 96.35 vol. %, 96.58 vol. %, 96.8 vol. %, 97.02 vol. %, 97.25 vol. %, 97.48 vol. %, 97.7 vol. %, 97.92 vol. %, 98.15 vol. %, 98.38 vol. %, 98.6 vol. %, 98.82 vol. %, 99.05 vol. %, 99.28 vol. %, 99.5 vol. %, 99.6 vol. %, 99.64 vol. %, 99.69 vol. %, 99.74 vol. %, 99.79 vol. %, 99.84 vol. %, 99.88 vol. %, 99.93 vol. %, or 99.98 vol. %.

The zinc salt may be any zinc salt known in the art. It may be, for example, a halide, sulfate, acetate, or triflate zinc salt. In certain embodiments, the zinc salt is zinc sulfate.

In certain embodiments, the aqueous rechargeable zinc battery electrolyte produced according to the method of the seventh aspect, may be the aqueous rechargeable zinc battery electrolyte according to the second aspect. In certain embodiments, the aqueous rechargeable zinc battery electrolyte according to the second aspect may be formed according to the method of the seventh aspect.

### BRIEF DESCRIPTION OF THE DRAWINGS

FIG. 1: Cyclic voltammetry (CV) profiles of Zn plating/stripping in an exemplary 1% butanediol and 1 M ZnSO₄ electrolyte (1% Butanediol); and in a 1 M ZnSO₄ electrolyte (additive free).

FIG. 2: Electrochemical tests for Zn anode in different electrolytes. Voltage-time profile of Zn cycling tested in additive-free and 1% butanediol electrolyte by applying current density and areal capacity of 2 mA cm⁻² and 2 mAh cm⁻², respectively for: (a) Zn—Zn symmetric cell with 100 μm Zn and (b) Zn/Ti asymmetric cell with 20 μm Zn (DoD: 17%), where DoD stands for “depth of discharge”. (c) The corresponding CE evolution on cycling Zn/Ti asymmetric cell at 2 mA cm⁻² and 2 mAh cm⁻². (d) Rate performance of Zn/Zn cell in baseline and 1% butanediol electrolyte. Voltage-time profile for Zn/Ti asymmetric cell in additive-free and 1% butanediol electrolyte at current density and areal capacity of (e) 4 mA cm⁻² and 4 mAh cm⁻² (20 μm Zn, DoD: 34%), (f) 50 mA cm⁻² and 2 mAh cm⁻² (20 um Zn, DoD: 17%), and (g) 2 mA cm⁻² and 2 mAh cm⁻² (10 μm Zn, DoD: 34%). The corresponding voltage-capacity profiles for (h) additive-free and (i) 1% butanediol electrolyte cells at 2 mA cm⁻² and 2 mAh cm⁻² with 10 μm Zn. (j) The comparison of cumulative plated capacity, electrolyte to capacity (E/C) ratio, Zn utilization, separator thickness, and additive concentration with other reported low-concentration organic additives and in situ SEI constructing electrolyte additives.

FIG. 3: Nyquist plot of Zn—Zn symmetric cells during the cycling in (a) 1% butanediol electrolyte and (b) additive-free electrolyte.

FIG. 4: The polarization profile for the Aurbach method Coulombic efficiency measurement using the (a) additive-free and (b) 1% butanediol electrolyte.

FIG. 5: The galvanostatic charging/discharging in 1M ZnSO₄ electrolyte with (a) 0.01% butanediol additive, (b) 0.1% butanediol additive, (c) 10% butanediol additive, and (d) 30% butanediol additive electrolyte at 2 mA cm⁻²-2 mAh cm⁻².

FIG. 6: The corresponding Coulombic efficiency for different concentrations of butanediol additives cycling at 2 mA cm⁻²-2 mAh cm⁻².

FIG. 7: The ionic conductivity of the different electrolytes as measured by electrochemical impedance spectroscopy.

FIG. 8: Coulombic efficiency measurements of Zn—Ti cells in 1% butanediol and additive-free electrolyte at 4 mA cm⁻² and 4 mAh cm 2.

FIG. 9: Coulombic efficiency measurements of Zn—Ti cells in 1% butanediol and additive-free electrolyte at 50 mA cm⁻² and 2 mAh cm⁻².

FIG. 10: Voltage-time profiles for Zn plating/stripping in 1 M ZnSO₄ with 1% butanediol and without additive at 3 mA-3 mAh cm⁻².

FIG. 11: Anti-corrosion effects of butanediol. The LSV response curve in different electrolytes at a scan rate of 5 mV s⁻¹ for: (a) cathodic scan and (b) anodic scan. (c) The Tafel plot for additive-free and 1% butandiol electrolyte. The morphology evolution of Zn electrode after soaking in 1M ZnSO₄ baseline electrolyte for (d) 24 h and (e) 72 h. (f) The corresponding EDS mapping of Zn electrode after soaking in 1 M ZnSO₄ electrolyte for 72 h. The byproduct-free morphology of Zn electrode after soaking in 1% butanediol electrolyte for (g) 24 h and (h) 72 h. (i) The corresponding EDS mapping of Zn electrode after soaking in 1% butanediol electrolyte for 72 h. (j) The XRD pattern of the same Zn electrodes after soaking. The EIS measurement for Zn/Zn symmetric cells during resting in (k) additive-free electrolyte and (1) 1% butanediol electrolyte for 24 h.

FIG. 12: Scanning electron microscopy (SEM) image of bare Zn foil.

FIG. 13: SEM and energy-dispersive X-ray spectroscopy (EDS) mapping image of Zn foil after 24 h soaking in 1 M ZnSO₄ electrolyte.

FIG. 14: After 24 h resting, the Nyquist plot of Zn—Zn symmetric cell in 1% butanediol electrolyte during cycling at 2 mA cm⁻² and 2 mAh cm⁻².

FIG. 15: After 24 h resting, the Nyquist plot of Zn—Zn symmetric cell in the additive-free electrolyte during cycling at 2 mA cm⁻² and 2 mAh cm⁻².

FIG. 16: After resting 24 h in 1 M ZnSO₄ and 1% butanediol electrolyte, the corresponding voltage-time profiles cycled at 2 mA-2 mAh cm⁻² for Zn—Zn symmetric cell.

FIG. 17: The role of butanediol in regulating plated Zn morphology. SEM images of Zn electrode plated at a current density of 2 mA cm⁻² in 1 M ZnSO₄ electrolyte (a-c) and 1% butanediol electrolyte (d-f) for 1 min (a and d), 5 mins (b and e), and 20 min (c and f). (g) The second plating voltage profile of Zn/Ti cells at 2 mA cm⁻² and 2 mAh cm⁻². SEM images of Zn electrodes after 10th plating in: (h) 1% butanediol electrolyte and (i) additive-free electrolyte. The XRD pattern for Zn electrodes after plating in different electrolytes. Laser confocal scanning microscopy images for Zn electrodes after 10th plating in (k) 1% butanediol electrolyte and (1) additive-free electrolyte.

FIG. 18: Potentiostatic current-time transient curves of Zn/Zn cells in 1 M ZnSO₄ aqueous electrolyte with and without 1% butanediol additive.

FIG. 19: SEM image of Zn electrode after 10th plating in: (a) 1% butanediol electrolyte and (b) additive-free electrolyte.

FIG. 20: Laser confocal scanning microscopy (LCSM) of bare Zn electrode.

FIG. 21: SEM image of pristine Zn_{0.25}V₂O₅·nH₂O powder.

FIG. 22: XRD profile of pristine Zn_{0.25}V₂O₅·nH₂O powder.

FIG. 23: Electrochemistry of ZVO/Zn full cell at practical conditions. (a) Rate performance of ZVO/Zn full cell at different electrolytes. (b) Long-term stability of full cells in different electrolytes at a current of 2 A g⁻¹. (c) Long-term cyclability of ZVO/Zn full cells in different electrolytes under harsh conditions (N/P ratio=4.1, E/C ratio=21 μL mAh⁻¹ and at a current of 0.5 A g⁻¹) and corresponding voltage-capacity profile in: (d) 1% butanediol electrolyte and (e) additive-free electrolyte. (f) The long-term cycling performance of ZVO/Zn pouch cell in 1% butanediol electrolyte. (g) Long-term cyclability of ZVO∥Zn cells for the two electrolytes at a temperature of 40° C. (h) The voltage-time profiles of asymmetric cells with the two electrolytes at 4 mA-4 mAh cm⁻² (34% DoD) and 40° C.

FIG. 24: Corresponding voltage-capacity profile for a fuel cell with a 1% butanediol electrolyte, cycling at 2 A g⁻¹.

FIG. 25: Corresponding voltage-capacity profile for a fuel cell without any butanediol in its electrolyte, cycling at 2 A g⁻¹.

FIG. 26: The EIS curve of ZVO/Zn full cell in additive-free and 1% butanediol electrolyte before cycling.

FIG. 27: The EIS curve of ZVO/Zn full cell in additive-free and 1% butanediol electrolyte after 200 cycles.

FIG. 28: The long-term cycling of active carbon (AC)/Zn full cell cycled in additive-free and 1% butanediol electrolyte at the current density of 1 A g⁻¹.

FIG. 29: The long-term cycling of ZVO/Zn full cell performed with high mass loading, limited Zn source and electrolyte, in additive-free and 1% butanediol electrolyte at the current density of 0.5 A g⁻¹.

FIG. 30: Practical demonstration of the exemplary inventive butanediol additive. (a) The voltage-capacity profile for series-connected ZVO/Zn pouch cell in 1% butanediol electrolyte with voltage window of 1-2.8 V. (b) The digital picture of powering three electrical fans by series-connected ZVO/Zn pouch cell. The demonstration of charging a ZVO/Zn pouch cell using a solar panel after (c) discharging the electrical fans and (d) fully charged.

FIG. 31: The current output from solar panel under lab light.

FIG. 32: The voltage evolution of pouch cells charged by a solar panel.

FIG. 33: Screening of various diol additives for zinc anode cycling in asymmetric Ti—Zn configuration at 4 mA-4 mAh cm⁻² for a zinc DoD of 40%.

FIG. 34: Screening of various butanediol structural isomer additives for zinc anode cycling in asymmetric Ti—Zn configuration at 2 mA-2 mAh cm⁻² for a zinc DoD of 17%.

FIG. 35: Voltage-time profile of Zn cycling tested in different butanediol electrolytes (1% vol.) by applying current density and areal capacity of 2 mA cm⁻² and 2 mAh cm⁻² for Zn/Ti asymmetric cell (DoD: 17%): (a) 1,3-butanediol; (b) 1,4-butanediol.

FIG. 36: Voltage-time profile of Zn cycling tested in different diol electrolytes by applying current density and areal capacity of 4 mA cm⁻² and 4 mAh cm⁻² for Zn/Ti asymmetric cell (DoD: 34%): (a) 1% vol. ethylene glycol; (b) 1% vol. 1,2-propylene glycol; (c) 1% vol. 1,2-pentanediol; (d) 1% vol. hexanediol; and (e) 0.3% vol. 1,2-octanediol.

FIG. 37: Voltage-time profile of Zn cycling tested in different butanediol electrolytes by applying current density and areal capacity of 4 mA cm⁻² and 4 mAh cm⁻² for Zn/Ti asymmetric cell (DoD: 34%): (a) 0.1% vol. 1,2-pentanediol; (b) 0.1% vol. hexanediol; and (c) 0.1% vol. 1,2-octanediol.

FIG. 38: Screening of various monohydric alcohol additives for zinc anode cycling in asymmetric Ti—Zn configuration at 4 mA-4 mAh cm⁻² for a zinc DoD of 40%.

FIG. 39: Screening of electrolyte additives at a low volume concentration. (a) Zn cycling lifetime obtained from the screening of the alkanol and alkanediol additives for zinc anode cycling in asymmetric Ti∥Zn configuration at 4 mA-4 mAh cm⁻² for a zinc DoD of 34%. Quartz-crystal microbalance with energy dissipation (QCM-D) based investigation of the additive filming at the metal anode interface in (b) 1%-1,2 butanediol (BD) and (c) 1,2-pentanediol (PD) electrolytes. Here, Δf is the frequency change, and Δdissipation is the dissipation change. F_1:X (X=3, 5, 7, 9) represent different harmonics, and D_1:X (X=1, 3, 5, 9) represent different dissipation values. (d) The corresponding adsorption layer thickness is derived from the QCM-D measurement. (e) The schematic illustration of the effect of an interfacial film forming additive like 1,2-butanediol on the electric double layer at the electrode interface.

### DEFINITIONS

In describing and claiming the present invention, the following terminology will be used in accordance with the definitions set out below. It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Unless the context clearly requires otherwise, throughout the description and the claims, the terms “comprise”, “comprising”, and the like are to be construed in an inclusive sense as opposed to an exclusive or exhaustive sense; that is to say, in the sense of “including, but not limited to”. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, process or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising”, it should be readily understood that (unless otherwise stated) the description should be interpreted to also describe such an invention using the terms “consisting essentially of” or “consisting of”. In other words, with respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the claims or operating examples, or where otherwise indicated, all numbers expressing quantities of ingredients or reaction conditions used herein are to be understood as modified in all instances by the term “about”. The examples are not intended to limit the scope of the invention.

In what follows, or where otherwise indicated, “%” will mean “weight”, “ratio” will mean “weight ratio” and “parts” will mean “weight parts”.

The terms “predominantly”, “predominant”, and “substantially” as used herein shall mean comprising more than 50% by weight, unless otherwise indicated.

As used herein, with reference to numbers in a range of numerals, the terms “about,” “approximately” and “substantially” are understood to refer to the range of −10% to +10% of the referenced number, preferably −5% to +5% of the referenced number, more preferably −1 to +1 of the referenced number, most preferably −0.1 to +0.1 of the referenced number. Moreover, with reference to numerical ranges, these terms should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, from 8 to 10, and so forth.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “aqueous rechargeable zinc battery”, means a rechargeable battery (i.e. a battery that is able to have its electrical energy restored by connection to a power supply) comprising at least one electrode that includes zinc, and further comprising an electrolyte that contains water, optionally an electrolyte that predominantly contains water.

As used herein, the term “electrolyte” means the medium that provides the ion transport mechanism between the cathode and anode of a cell.

As used herein, the term “alcohol” means, particularly in the context of the “aliphatic alcohol compound”, a compound that comprises at least one hydroxyl functional group, and includes monohydric alcohols (i.e. mono alcohols, e.g. 1-butanol, 2-butanol, 1-pentanol, etc.), dihydric alcohols (i.e. diols, e.g. 1,4-butanediol; 1,3-butanediol; 1,1-butanediol; 1,5-pentanediol, etc.), and polyhydric alcohols (i.e. compounds containing two or more hydroxyl groups, e.g. 1,4-butanediol; 1,2,4-butanetriol etc.).

### Abbreviations

Active carbon (AC); Aqueous Zn-metal batteries (AZMBs); Chronoamperometry (CA); Coulombic efficiency (CE); Cyclic voltammetry (CV); Deionised (DI); Depth of discharge (DoD); Electrical vehicles (EV); Electrochemical impedance spectroscopy (EIS); Energy-dispersive X-ray spectroscopy (EDS); Fourier transform infrared (FTIR); Hydrogen evolution reaction (HER); Laser confocal scanning microscopy (LCSM); Layered double hydroxides (LDHs); Li-ion batteries (LIBs); Linear sweep voltammetry (LSV); N-methyl-2-pyrrolidone (NMP); Polyvinylidene difluoride (PVDF); Reduced graphene oxide (rGO); Scanning electron microscopy (SEM); Styrene butadiene rubber/sodium carboxyl methyl cellulose (SBR/CMC); X-ray diffraction (XRD).

Preferred features, embodiments and variations of the invention may be discerned from the following Examples which provides sufficient information for those skilled in the art to perform the invention. The following Examples are not to be regarded as limiting the scope of the preceding Summary of the Invention in any way.

### Examples

### Experimental Methods

Preparation of Example ZnSO₄-butanediol Electrolytes

ZnSO₄ (heptahydrate; 99.5%, Sigma-Aldrich) and the various alcohols (≥99.5%; Sigma-Aldrich) were used along with Milli-Q® water to prepare the electrolytes. The electrolytes were obtained by dissolving ZnSO₄ (heptahydrate) into the alcohol-water solution (mixed water with different volume concentrations of alcohol) to form a 1 mol L⁻¹ (1M) ZnSO₄ solution with the alcohol additive.

Preparation of Zn_{0.25}V₂O₅·nH₂O cathode material

First, 20 mg reduced graphene oxide (rGO) was dispersed in 50 ml of 15:1 water/acetone (volume) mixture by ultrasonication. Then, 2 mmol V₂O₅ and 1.3 mmol of zinc acetate were directly added to the former solution and stirred for 1 h. After that, the obtained solution was transferred into a Teflon lined stainless-steel autoclave (Parr Instrument) and held at 180° C. for 48 h. The final products were collected by infiltration and washed with water and ethanol 3 times.

### Electrochemical Measurement

The ZVO cathode was mixed with conductive carbon (Super P®, Timcal) and styrene butadiene rubber/sodium carboxyl methyl cellulose (SBR/CMC) binder in a weight ratio of 70:25:5 in DI water (solvent). The mixture was ultrasonicated for 1.5 h and free-standing electrode discs were obtained by vacuum filtration. After 12 h vacuum drying at 80° C., 1 cm⁻² electrode coins with an average active material loading of ~6-7 mg cm⁻² were punched out for the full cell studies. The active carbon (AC, Sigma-Aldrich) was mixed with conductive carbon and polyvinylidene difluoride (PVDF) in a weight ratio of 7:2:1 in N-methyl-2-pyrrolidone (NMP; anhydrous, 99.5%; Sigma-Aldrich) and cast on graphite foil. After drying at 80° C. vacuum oven for 12 h, the electrodes were punched into 1 cm⁻² coins having an average loading of 11-12 mg cm⁻².

Zinc foil (≥99.9%), with different thicknesses (100, 20, and 10 μm), was punched into 1 cm⁻² (geometric surface area) coins for the electrochemical studies. The zinc plating/stripping studies were performed in a Swagelok® type cell in Ti/Zn asymmetric or Zn/Zn symmetric configuration using a glass fiber separator (Merck Millipore Ltd.) with a thickness of 230 μm after soaking/pressing. Ti and Zn electrodes were polished with alumina powder slurry, washed with water, and dried before using. Cell assembly and all other procedures were carried out in ambient air. The galvanostatic cycling studies were performed using a LAND CT2001A cycler. The electrochemical impedance spectroscopy (VMP-3, BioLogic) was performed in a symmetric (Ti/Ti or Zn/Zn) configuration in the 1 MHz to 0.1 Hz frequency range by applying an AC amplitude of 10 mV. The electrolyte resistance was acquired from the intercept of the Nyquist plot on the real (impedance, Z) axis and the ionic conductivity was calculated according to the following equation:

$$σ = \frac{L}{{R}_{s} A}$$

Where σ (S cm⁻¹) is the conductivity, R, is the electrolyte resistance, L (cm) is the distance between the two Ti electrodes, and A is electrode area (cm⁻²).

Linear sweep voltammetry (LSV) of the electrolytes, using 1 M Na₂SO₄ (adjusted to the pH of 1M ZnSO₄) to avoid Zn deposition on cathodic sweep, was examined at a scan rate of 5 mV s⁻¹ in a three-electrode system, with Ti as the working electrode, a graphite foil as the counter electrode, and an Ag/AgCl reference electrode (VMP-3, BioLogic). A potentiodynamic polarization experiment for the Tafel analysis was conducted at scan rate of 1 mV s⁻¹ in the same three-electrode configuration. Cyclic voltammetry (CV) profiles for the Zn plating/stripping were recorded in the Zn/Zn symmetric system at scan rate of 1 mV s⁻¹. The Chronoamperometry polarization experiment (CA) was performed in a Zn/Zn symmetric cell with −200 mV polarization.

### Physicochemical Characterization

Corrosion byproduct formation in different electrolytes was investigated by X-ray diffraction (PANalytical Xpert Multipurpose X-ray Diffraction System (MPD)) with Cu Ku radiation. The patterns were recorded in a 20 window of 5 and 80° at a scanning speed of 0.04° sec⁻¹. The surface roughness of the cycled Zn electrodes were measured with a laser scanning confocal microscope (LSCM, VK-X250, Keyence Co., Osaka, Japan), which is capable of non-contact profile and roughness measurements with nanometer resolution. The morphology of the Zn foils before/after cycling and resting in electrolytes was probed using FEI Nova NanoSEM 230 field emission scanning electron microscope. Raman spectroscopy data were collected on a Renishaw inVia Raman spectrometer equipped with a 532 nm argon ion laser (power 5%), 1800 l/mm grating (vis), and Renishaw Centrus 0281P4 detector. The measurements were performed under ×20 objective lens in the spectral range 100-4000 cm⁻¹ with an exposure time of 10 s. Fourier transform infrared (FTIR) spectra of all electrolytes were acquired in the range 4000-600 cm⁻¹ using a Tensor27 FTIR spectrometer.

1,2-butanediol Electrolyte Additive

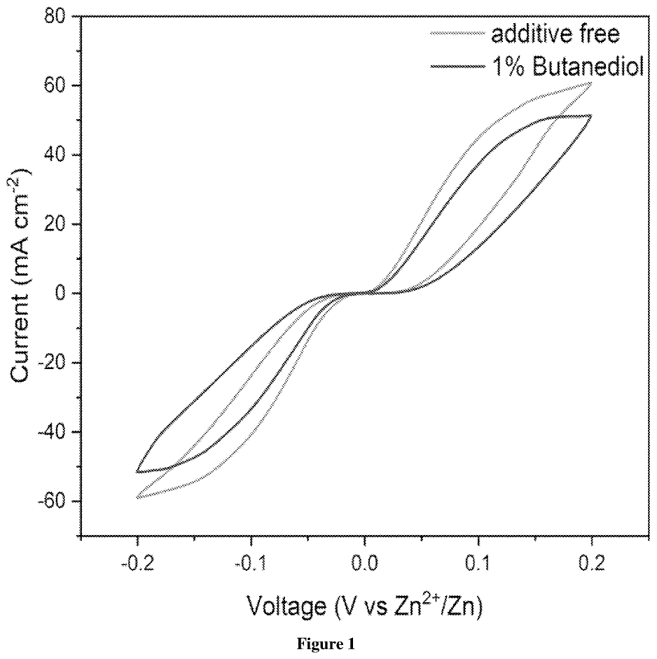

To evaluate the efficacy of 1,2-butanediol as an electrolyte additive toward boosting zinc metal anode cycling reversibility, 100 μm thick Zn foil electrodes (such thick Zn is typically used as electrodes for assessing Zn cyclability) were initially tested in Zn/Zn symmetric cells under a current density and areal capacity of 2 mA cm⁻² and 2 mAh cm⁻², respectively. Cyclic voltammetry (FIG. 1) confirmed that Zn²⁺/Zn redox behavior remained unchanged upon introduction of the butanediol into the electrolyte.

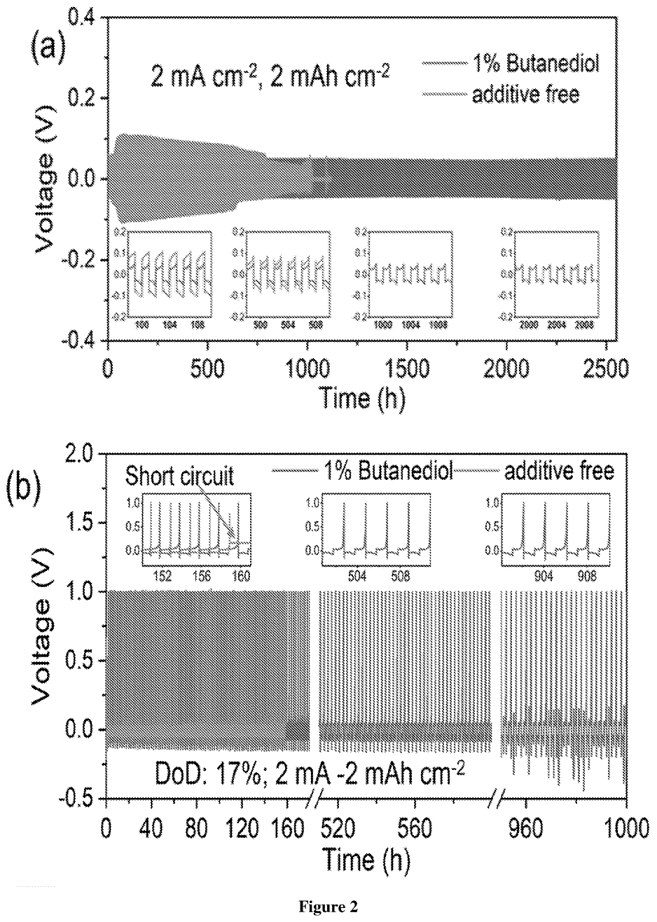

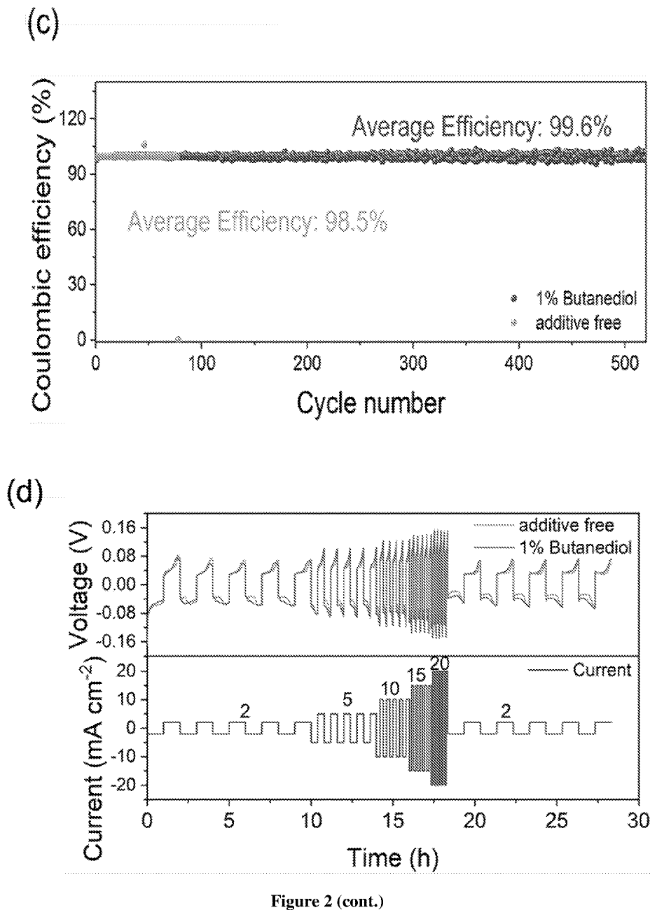

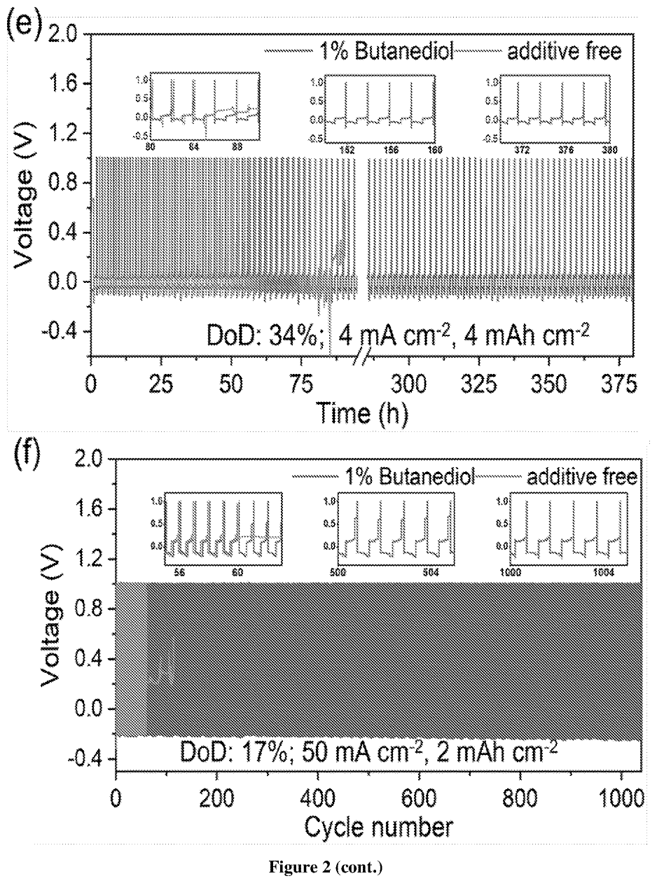

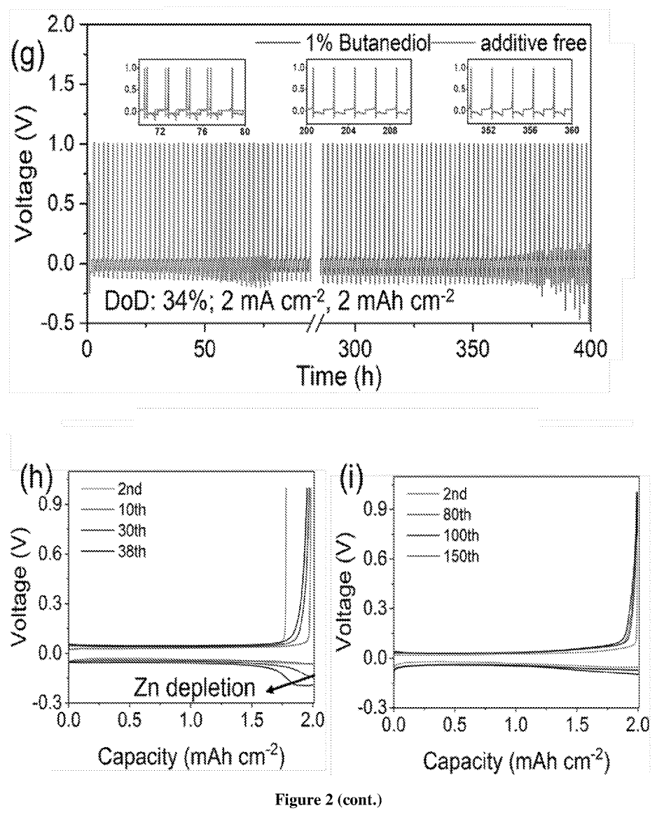

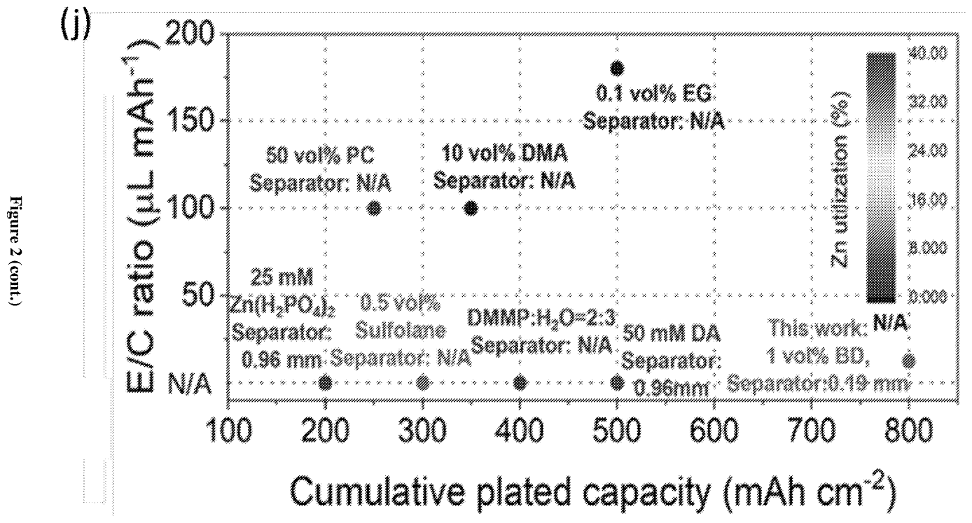

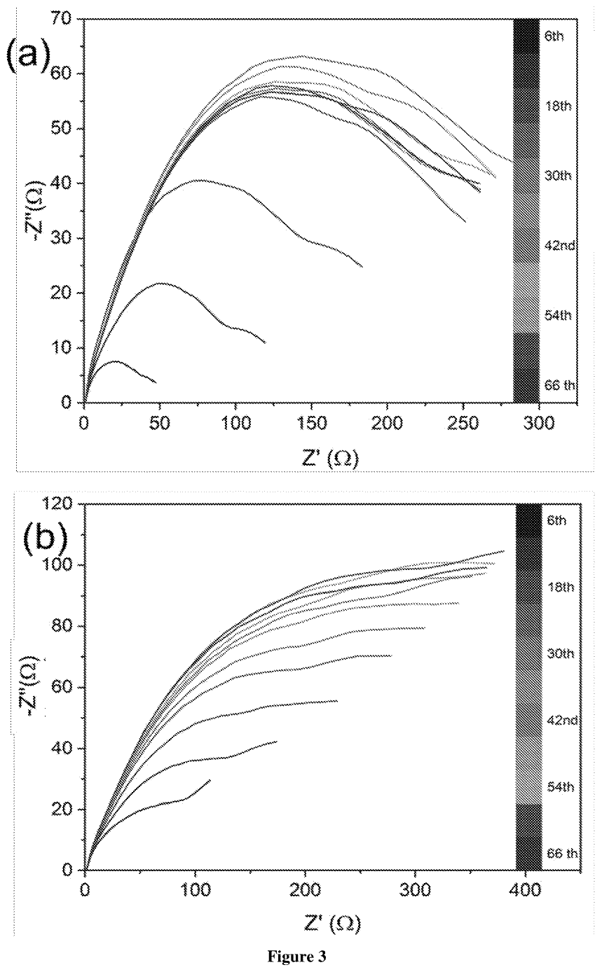

As evident from FIG. 2a, the Zn/Zn symmetric cell in 1 M ZnSO₄-1 vol % butanediol (denoted as 1% Butanediol) can steadily operate up to 1290 cycles (2580 h) with a steady voltage profile. This may be attributed to the fact that the butanediol additive not only renders a smaller charge transfer resistance but also stabilizes the impedance growth during the initial cycles (FIG. 3a).

In contrast, the symmetric cell with the 1 M ZnSO₄ baseline electrolyte (the additive-free electrolyte) showed unstable voltage curves and failed at 920 h (460 cycles) by short circuit. Here the irregular voltage profile marked by increasing polarization during the first 50 cycles may be ascribed to the steadily rising impedance (FIG. 3b) as a result of a continuous corrosion reaction between the electrolyte and anode.

Notably, such a thick Zn anode with excessive capacity (58.5 mAh cm⁻²) can serve as a large inventory and avoid corrosion-related failure, hence displaying a rather long Zn anode cycling lifespan even in 1 M ZnSO₄ electrolyte. However, this is not practically viable as a large excess of metal will lead to a dramatic increase in the weight and cost of batteries.

“Soft shorts” can be imperceptible in symmetric cell cycling unless attention is paid to the squarewave-like polarization profiles which indicate short circuits resulting in misinterpretation or exaggeration of the cycling performance of the Zn anode. Consequently, a Zn/Ti asymmetric configuration was adopted to enable the monitoring of Coulombic efficiency (CE). This configuration unmistakably revealed an internal short by a longer than expected stripping profile which was limited by voltage. Therefore, a much thinner Zn (20 m) foil anode was studied at 2 mA cm⁻² and 2 mAh cm⁻², in a Zn/Ti asymmetric configuration, realizing a depth of discharge (zinc DoD) of 17%. According to FIG. 2b, the 1% butanediol electrolyte could still endow the Zn anode with excellent stability (over 1000 h) at an average CE of 99.6% (FIG. 2c).

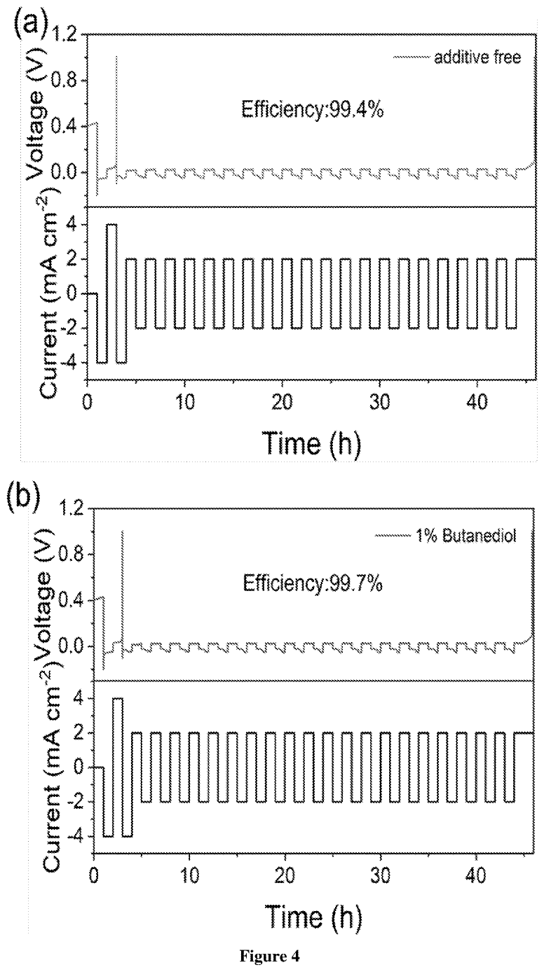

The promising CE (99.7%) for the 1% butanediol electrolyte was also confirmed by the Aurbach method (FIG. 4). In comparison, the Zn/Ti cell in the baseline electrolyte showed a relatively lower CE (98.5%) and failed after only 80 cycles (160 h). The apparent disparity of life performance between 100 μm and 20 μm Zn in pure 1 M ZnSO₄ electrolyte corroborates the fact that excessive Zn stocking can exaggerate the cycling performance of the Zn anode significantly. Corrosion exhausts the finite zinc source quickly while dumping out byproducts (zinc hydroxysulfates) on the zinc surface, leading to unstable deposition and accelerated dendritic short circuit.

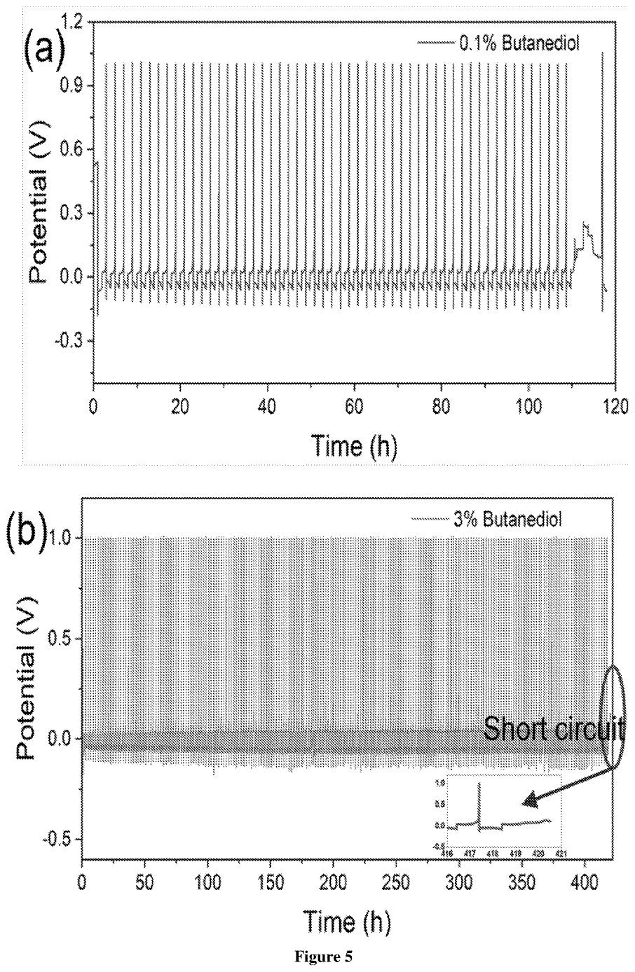

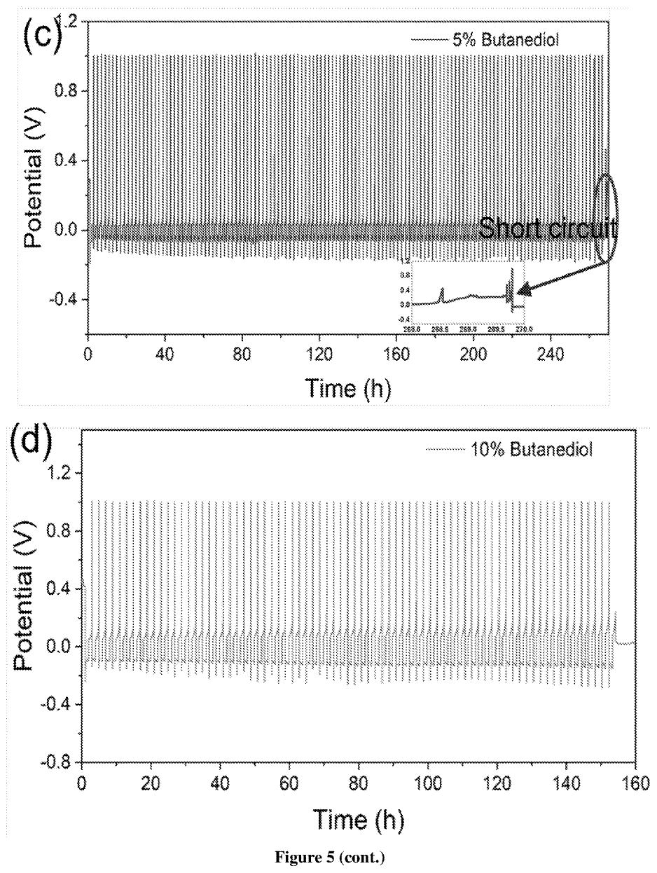

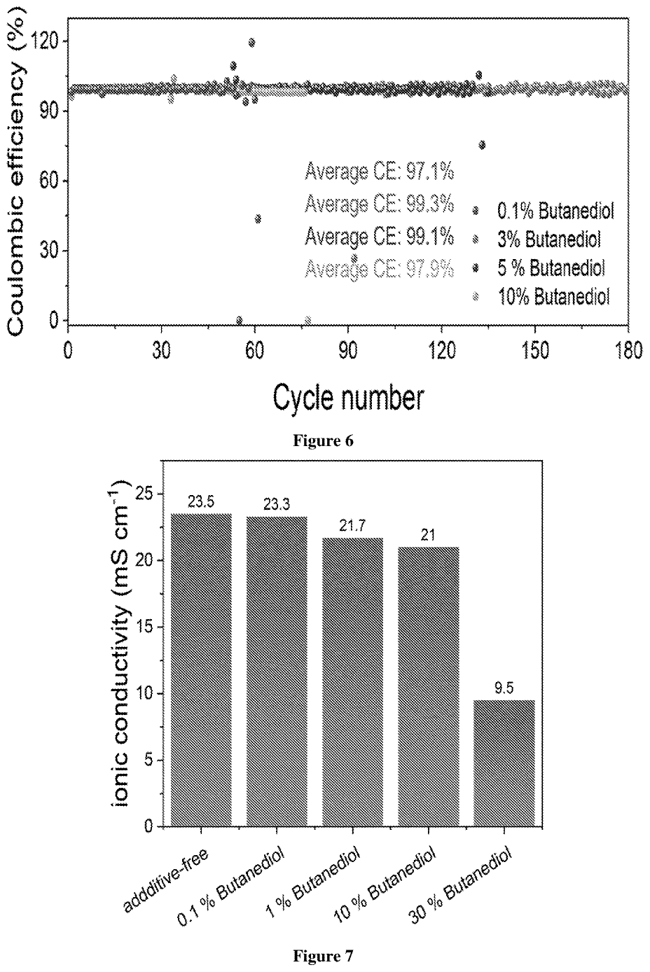

Other concentrations of butanediol, including 0.1 vol. %, 3 vol. %, 5 vol. %, and 10 vol. %, were also evaluated, with 0.1% showing little change over the baseline electrolyte and the lifespan (FIG. 5) and CE (FIG. 6) dropping with increasing concentration, confirming the optimal concentration to be around 1 vol. %.

Without being bound by theory, the inventors of the present application postulate that electrolyte additives typically adsorb onto the metal surface, level the high-field density sites, and homogenize the metal electrodeposition. However, excess additives can compromise the electrolyte conductivity considerably and induce a large overpotential and unstable deposition even at moderately high currents.

1 vol. % butanediol struck a good balance with only a very small drop in ionic conductivity relative to the baseline electrolyte (FIG. 7). As a result, 1% butanediol electrolyte yielded stable voltage profiles over a wide range of current densities: 2, 5, 10, 15, and 20 mA cm⁻² with a negligible increase in voltage hysteresis compared to the baseline 1 M ZnSO₄ electrolyte (FIG. 2d).

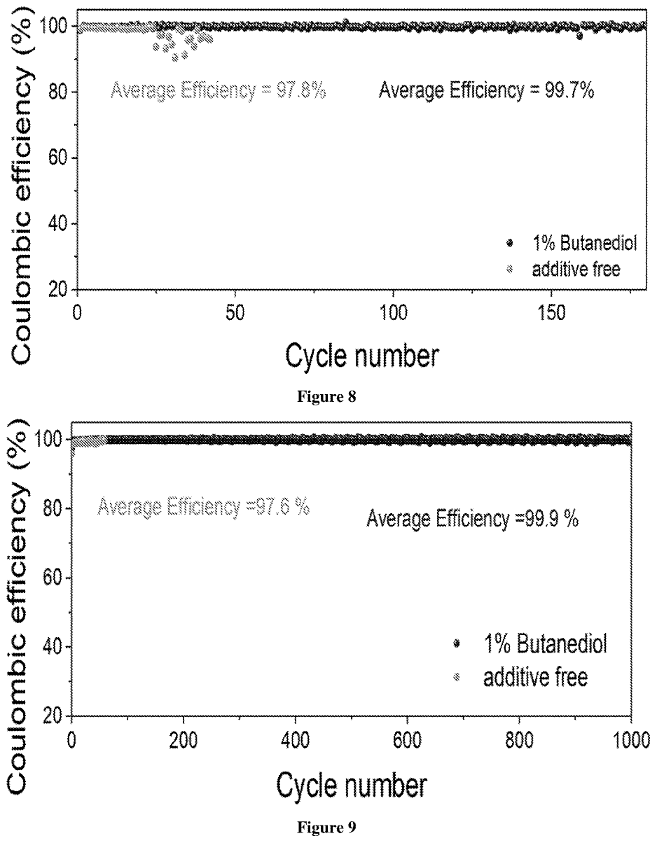

A deep-cycling study at 34% DoD at a higher current and areal capacity of 4 mA-4 mAh cm⁻² as presented in FIG. 2e and FIG. 8, further illustrated the merits of the butanediol additive. Furthermore, as FIG. 2f demonstrates, an ultra-stable Zn cycling of over 1000 cycles with significantly boosted CE (99.9%; FIG. 9) was achieved in 1% butanediol electrolyte even at an extremely high current of 50 mA cm⁻². This was a significant improvement over the baseline electrolyte that exhibited short-circuiting failure after only 60 cycles at an inferior 97.6% CE (FIGS. 2f and 9).

In an attempt to demonstrate how a limited amount of zinc and high zinc utilization could impact the cyclability and to evaluate the efficiency and feasibility of the 1% butanediol electrolyte, an ultrathin Zn foil (10 um) anode was tested at 2 mA-2 mAh cm⁻² and 3 mA-3 mAh cm⁻², corresponding to 34% and 51% DoD, respectively.

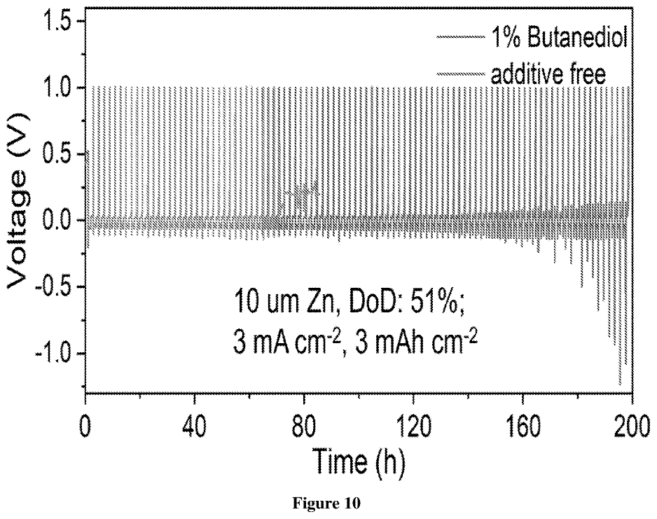

As shown in FIG. 2g and FIG. 10, the 1% butanediol electrolyte displayed remarkable improvement, especially at 34% DoD, with a stable Zn plating/stripping for 400 h. The corresponding voltage-capacity plots shown in FIGS. 2h and 2i reveal that the baseline electrolyte system (FIG. 2h) suffered from early polarization failure triggered by zinc loss. This likely stems from continuous and rapid consumption of active Zn by electrolyte-induced chemical and electrochemical corrosion, leading to Zn depletion and non-reversible byproduct formation, which increases the barrier for stripping Zn from the anode side. In contrast, the 1% butanediol electrolyte slows down the corrosion mediated depletion remarkably, leading to extended cycling. This result not only confirms the viability of 1% butanediol electrolyte, but also unravels the disparities between deep and shallow Zn utilization, highlighting that it is of great significance to evaluate the Zn anode cycling under a practically relevant condition (decent Zn utilization).

FIG. 2j summarizes the 1% Butanediol electrolyte performance compared with earlier reports employing low concentrations of organic additives for suppressing water activity or in situ SEI construction. As symmetric zinc cycling exaggerates the stability, particularly under deep DoD cycling where the presence of an additional Zn electrode serves as a reservoir of zinc and delays zinc loss-mediated polarization failure, for a more appropriate comparison, the cumulative plated capacity under asymmetric cycling was compared. Furthermore, it is noteworthy that besides the Zn utilization, the separator thickness and E/C ratio may have consequences on the cell-level specific energy and Zn cyclability, but unfortunately, they are rarely discussed or even reported in the literature. Nonetheless, the remarkable long-term zinc cycling reversibility exhibited under high Zn utilization, low E/C ratio, and thin separator, achieved with the low concentration (1 vol %) of the butanediol additive exceeds the performance of nearly all previous additive-based research work.

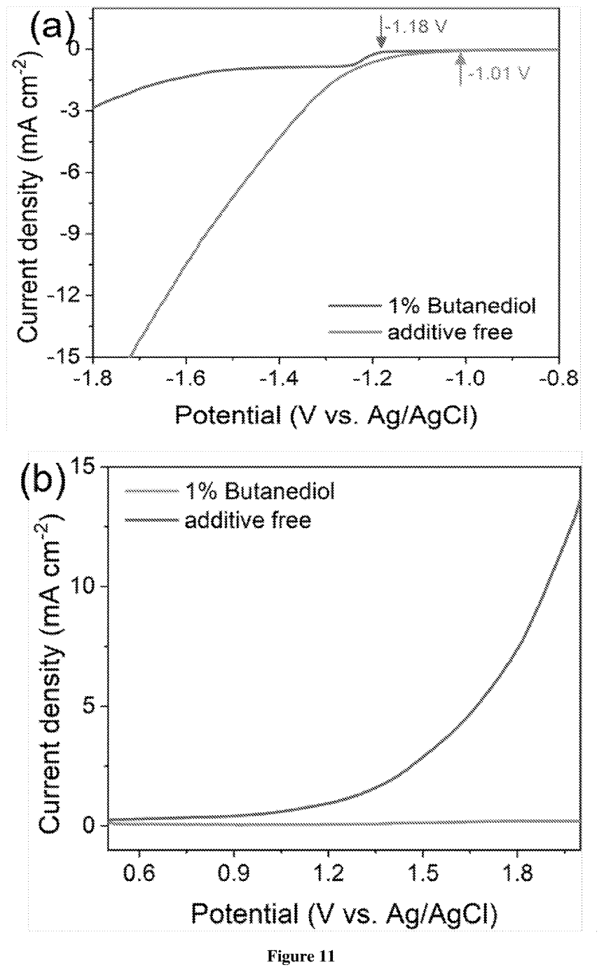

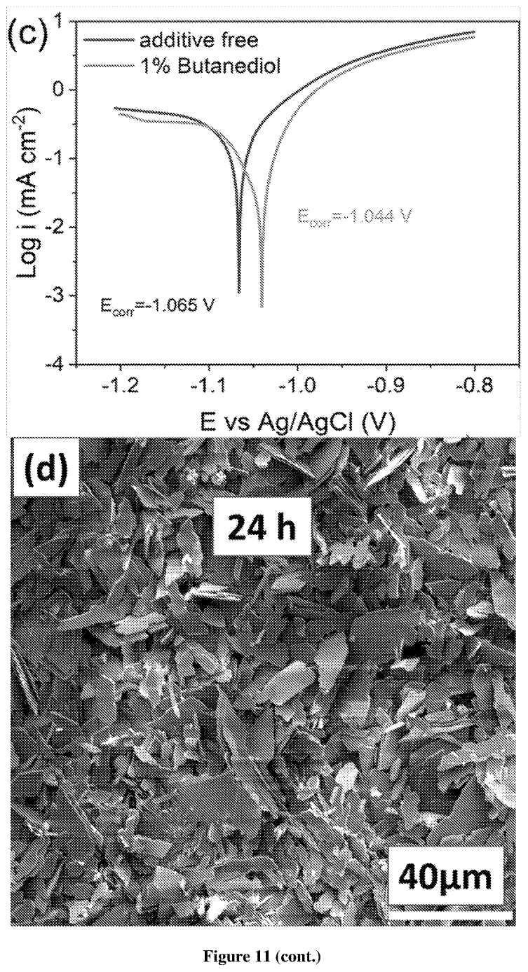

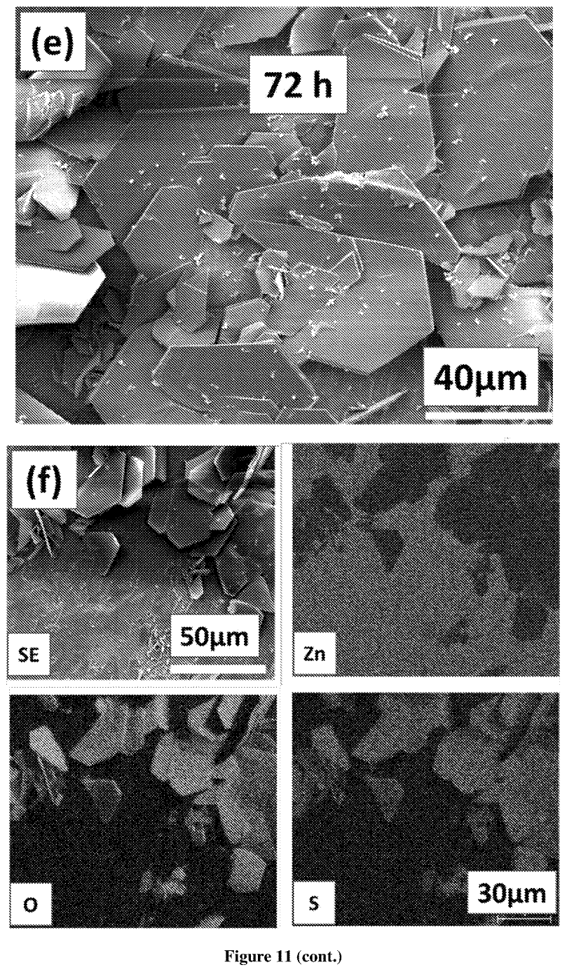

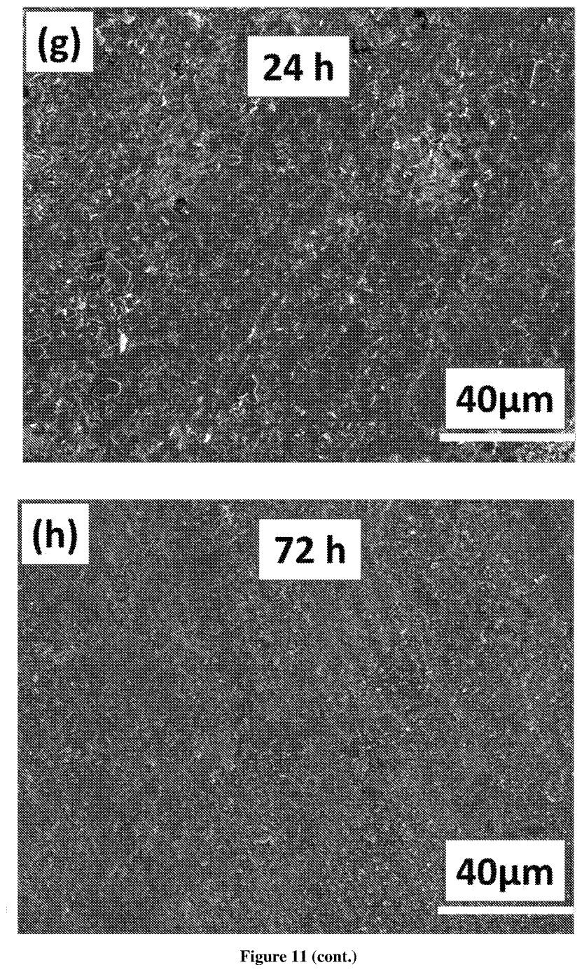

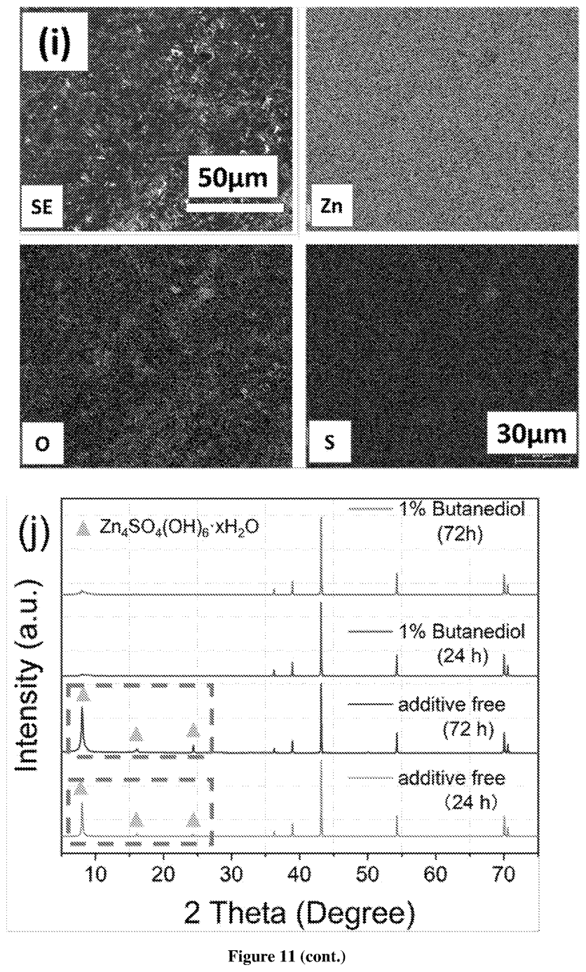

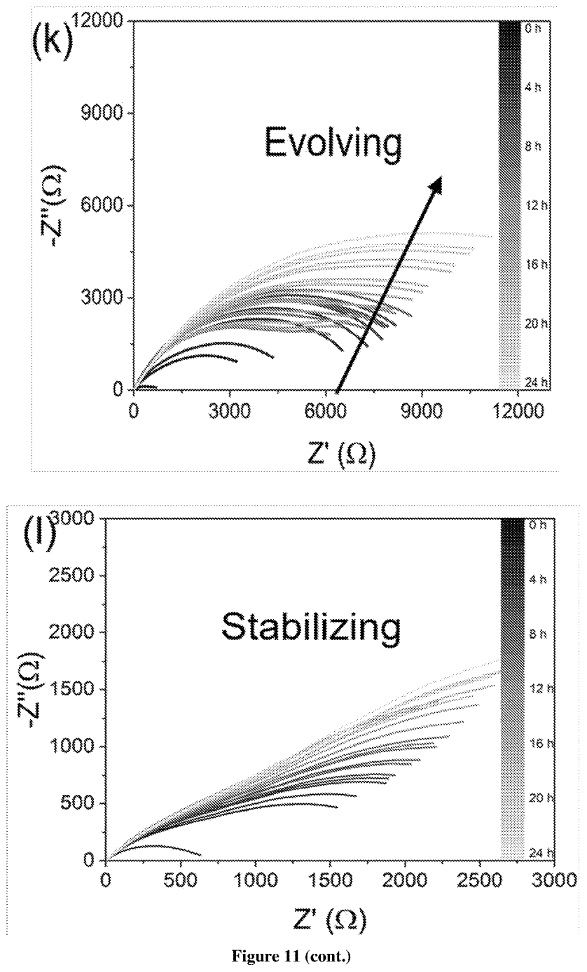

To probe the efficacy of the butanediol additive in suppressing HER, cathodic polarization was analyzed by linear sweep voltammetry (LSV) in 1M Na₂SO₄ solution with or without butanediol after adjusting the pH value of 1 M Na₂SO₄ to that of 1 M ZnSO₄ (pH: 4.2). The absence of Zn²⁺ in the electrolyte eliminated the overlapping response from zinc deposition, and the current response from the linear sweep voltammetry corresponded to HER only. As FIG. 11a reveals, the 1% butanediol electrolyte delays HER (−1.18 V) compared to the additive free electrolyte (−1.01 V), underscoring the suppression of HER in the presence of butanediol. Similar effects were also observed on anodic polarization as the 1% butanediol electrolyte presented a much-extended oxidative stability window compared to the additive-free electrolyte which showed a rapid increase in current response beyond 1.2 V (FIG. 11b).

The extent of HER related corrosion on metallic Zn was further investigated by Tafel polarization tests (FIG. 11c), which further confirm the effect of butanediol in suppressing HER on zinc which plays a defining role in boosting the Zn anode reversibility and cyclability in the 1% Butanediol electrolyte.

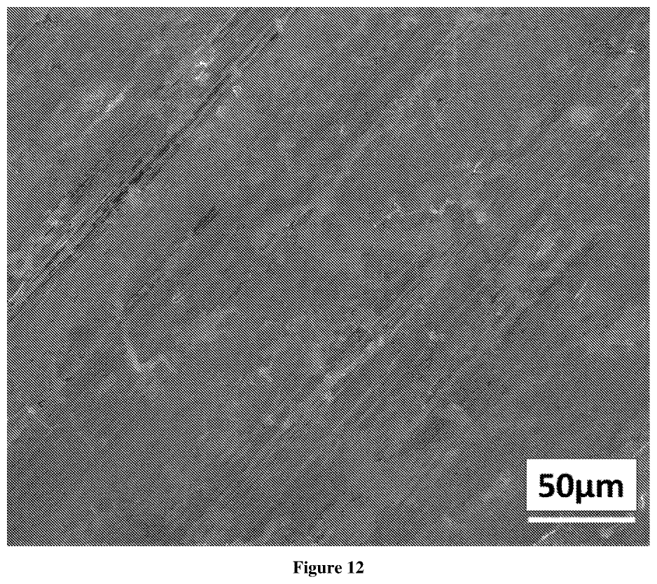

The function of the butanediol additive on limiting corrosion reactions at the Zn anode was further studied by soaking pure Zn foil in 1 M ZnSO₄ electrolyte with and without the additive. Upon soaking the pristine Zn electrode (FIG. 12) in 1 M ZnSO₄ for 24 h, the scanning electron microscope (SEM) and energy-dispersive X-ray spectroscopy (EDS) elemental mapping image (FIG. 11d and FIG. 13) reveal byproducts with irregular flake-like morphology covering the whole surface of the electrode. As shown in FIG. 11e, extending the soaking period to 72 h, the flake-like product transformed into large hexagonal platelets, suggesting that the byproduct formation through aggressive chemical corrosion of zinc by the sulfate electrolyte continued leading to the byproduct morphology growth. These byproducts are identified as zinc layered double hydroxides (LDHs, Zn₄SO₄(OH)₆·xH₂O) by EDS mapping and X-ray diffraction (XRD), shown in FIGS. 11f and 11j, respectively.

Spontaneous chemical reduction of water proton (H⁺) on zinc may leave behind OH-anions which combine with Zn²⁺ and SO₄²⁻ to precipitate as the LDHs. In contrast, the corrosion of Zn was greatly suppressed without any flakes or hexagonal-platelets species observed (FIG. 11g) after the introduction of butanediol into the 1 M ZnSO₄ electrolyte. Even after an extended time resting in the 1% butanediol electrolyte for 72 h, the Zn foil retained its surface feature (FIG. 11h) without proliferation of LDHs (FIGS. 11i and 11j).

Notably, the extent of corrosion under soaking experiments performed with excess electrolyte may be different from that in the test cells. Therefore, to understand the consequence of corrosion in electrochemical testing conditions, electrochemical impedance spectroscopy (EIS) was performed in Swagelok-type cells with symmetric Zn electrodes and a glass fiber separator with a limited amount of electrolyte. As FIG. 11k shows, with the pure 1 M ZnSO₄ electrolyte, even during the first 1 h of resting, there is a large impedance growth, increasing from 600Ω (0 h) to ~3000Ω—as extrapolated from the width of the semicircles. The impedance evolution continues with the semicircle extending beyond 12000Ω after 24 h. This result corroborates that dynamic corrosion between metallic Zn and the aqueous 1 M ZnSO₄ electrolyte persists even with a lean electrolyte. However, this unrestricted corrosion was effectively curbed in the 1% butanediol electrolyte (FIG. 11-l), as evidenced by a much smaller impedance rise and stabilization during resting.

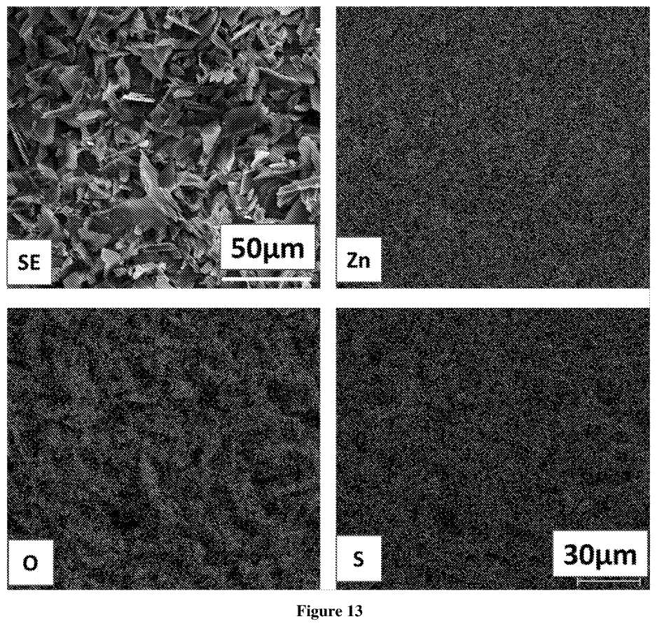

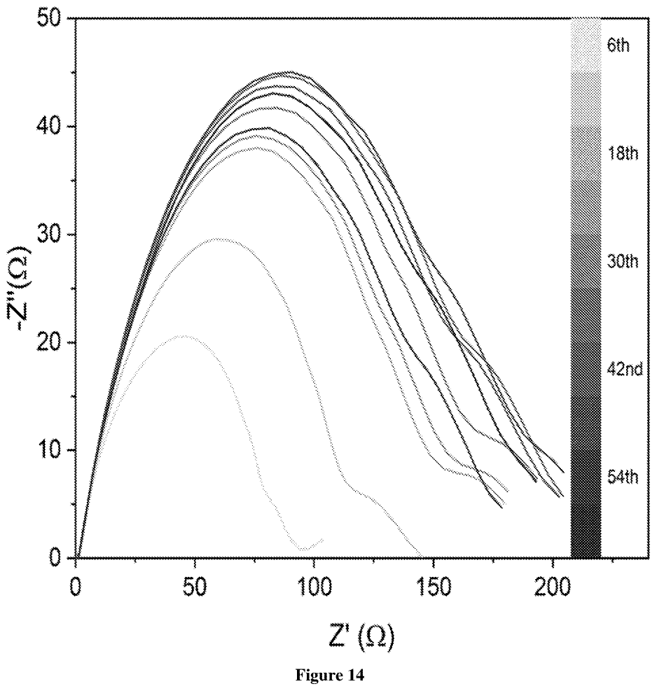

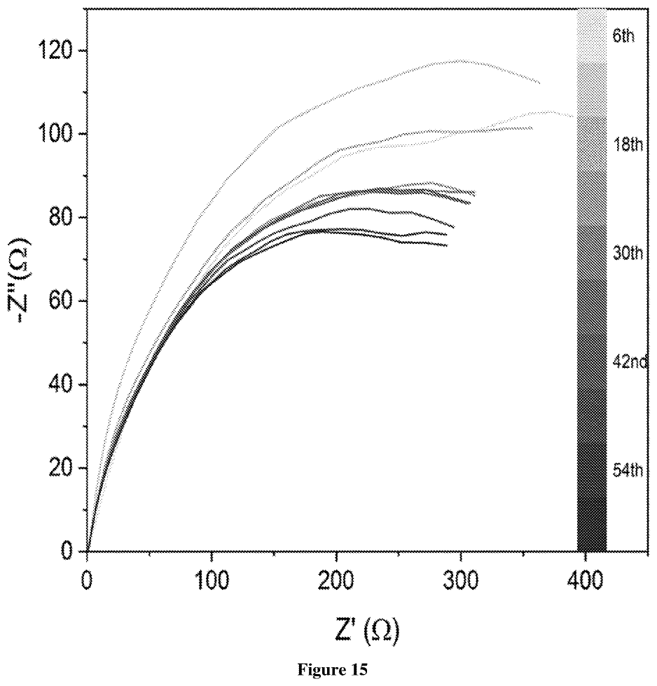

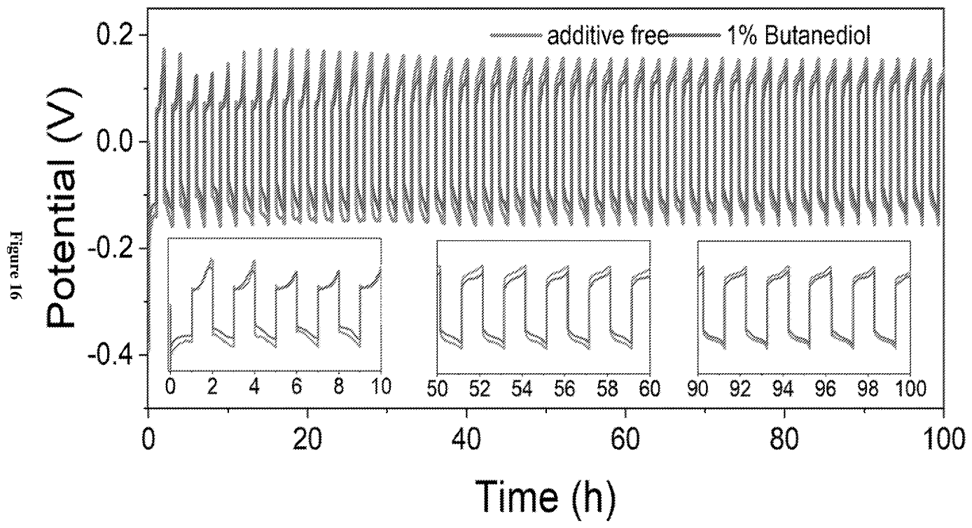

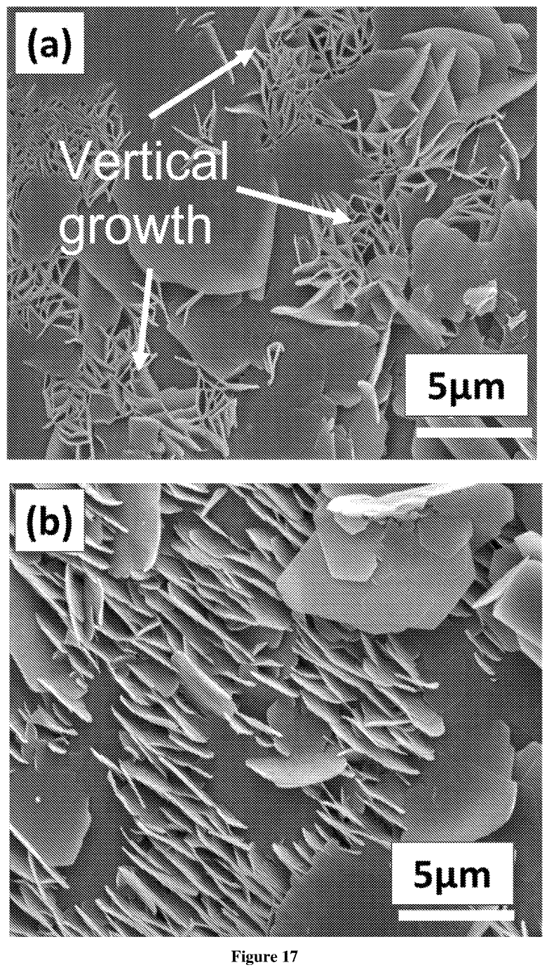

To understand the influence of the corrosion on charge-transfer resistance more deeply, the rested Zn/Zn symmetric cells were subsequently cycled at 2 mA-2 mAh cm⁻², coupling with EIS measurement. As revealed in FIG. 14, the Zn/Zn symmetric cell in 1% butanediol showed a significant drop in charge-transfer resistance (80Ω) after 6 cycles, which is in agreement with the EIS of the unrested cell during cycling (FIG. 11a). This result suggests that byproducts formed during resting in the butanediol electrolyte are mostly reversible and can be transformed by electrochemical cycling. In contrast, the irreversible and insulating Zn₄SO₄(OH)₆·xH₂O byproducts formed during soaking in the baseline electrolyte could avert the movement of the Zn²⁺ ions across the interface, thus leading to sluggish charge-transfer kinetics (FIG. 15), hence yielding a greater voltage hysteresis during cycling (FIG. 16). All these results confirm the outstanding effect of butanediol in inhibiting the Zn corrosion and thus improving the cycling stability of the Zn anode.

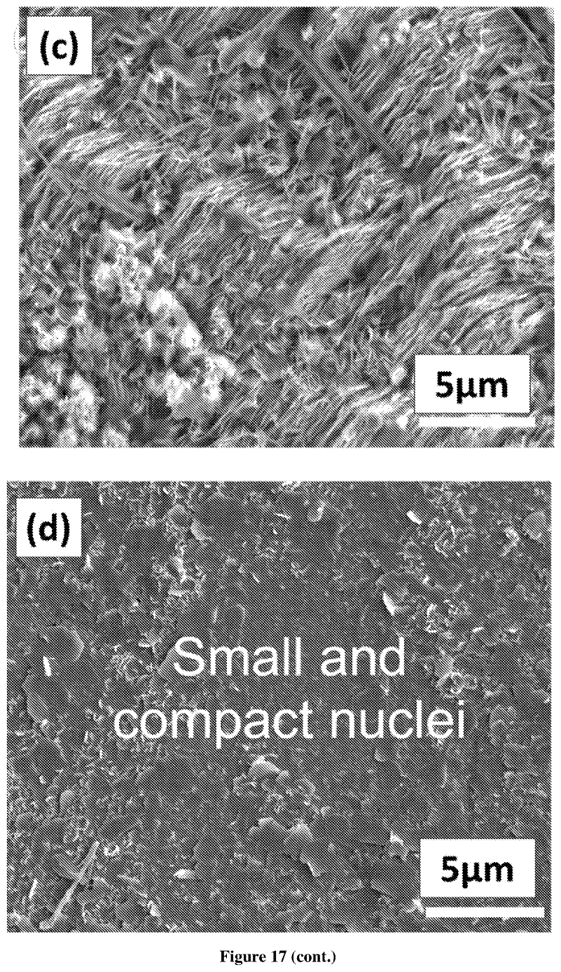

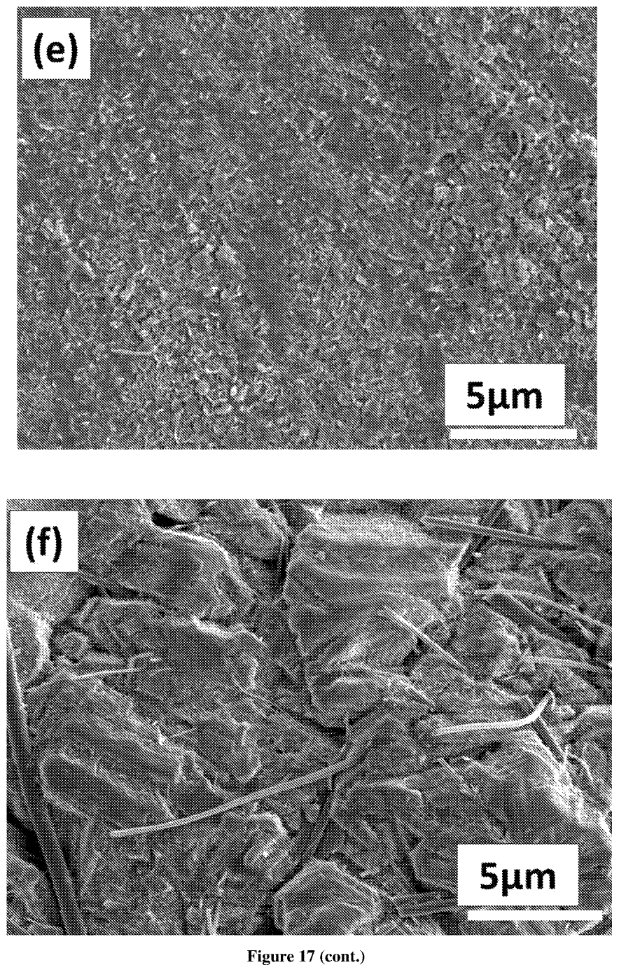

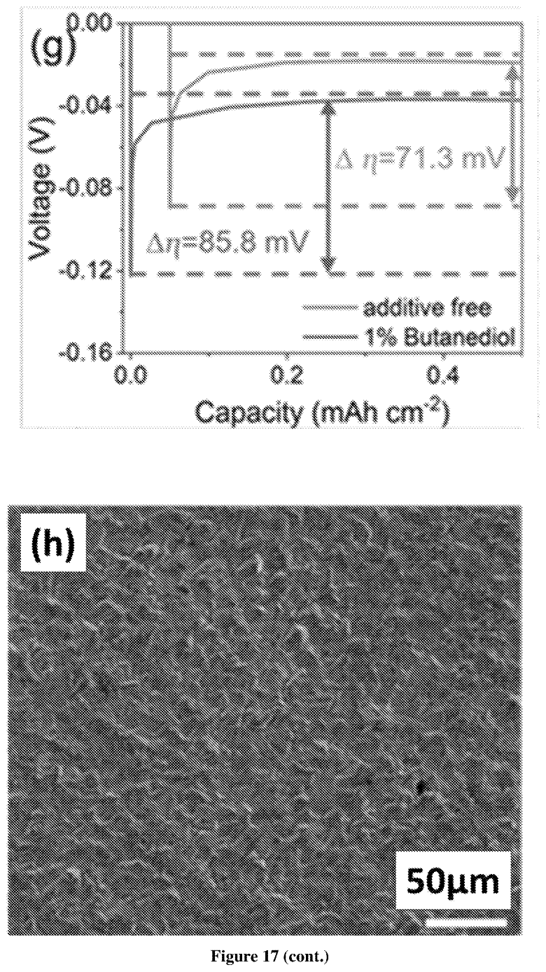

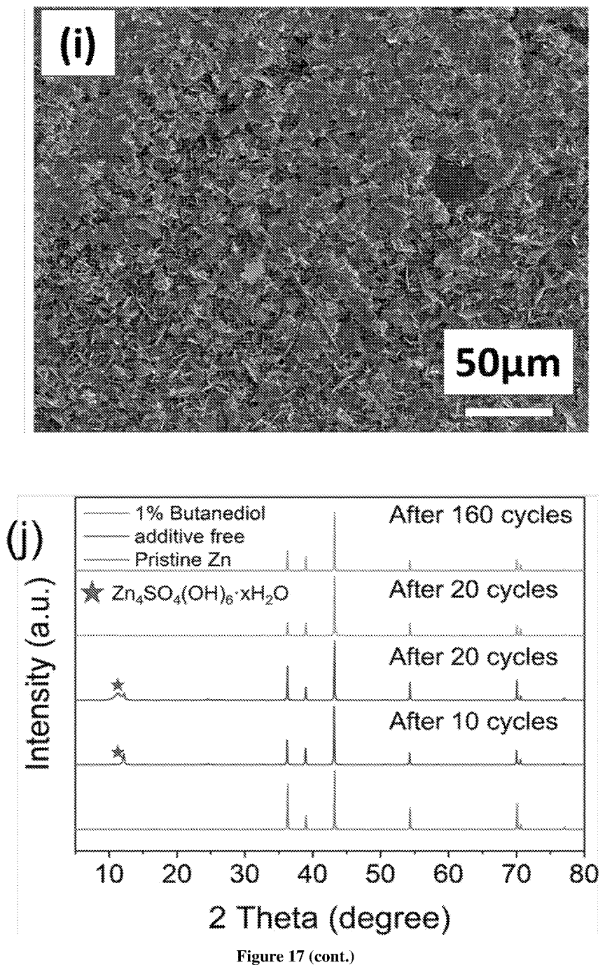

Besides the corrosion suppression, the extended long-term cycling lifespan in 1% butanediol electrolyte may also stem from the dendrite-free Zn plating/stripping, as shown in the FIG. 2 data. To confirm this, the morphology of Zn during the initial deposition and subsequent growth stages were investigated by SEM imaging. Prior to the deposition, the surface of the pristine Zn foil was smooth (FIG. 10), but after plating for 1 min at 2 mA cm⁻², needle shaped and flaky Zn nuclei were observed in the 1 M ZnSO₄ electrolyte (FIG. 17a). These non-uniform Zn nuclei grew vertically upon further plating (5 min, FIG. 17b) and finally transformed into a highly heterogeneous and rough surface (FIG. 17c), which exacerbated the non-uniformity of the Zn²⁺ flux and led to dendrite formation. In the optimized electrolyte, encouragingly, at the early stage of nucleation, the Zn deposit consisted of compact, flat, and smaller crystallites (FIG. 17d-f). Without being bound by theory, the inventors of the present application postulate that this likely stems from an optimal nucleation overpotential, which may dictate the critical Zn nuclei radius (r) as per the following relation:

$$r = 2 \frac{γ {V}_{m}}{η F}$$

where γ is the surface energy of the Zn-electrolyte interface, Vₘ is the molar volume of Zn, F is the Faraday constant, and η is the nucleation overpotential.

A relatively higher nucleation overpotential for Zn plating in the optimized electrolyte (Δη=85.9 mV, FIG. 17g) could potentially promote homogeneous deposition of fine-grained and compact Zn nuclei, whereas in 1M ZnSO₄, non-uniform Zn and larger zinc crystallites may evolve owing to a smaller nucleation overpotential of 71.3 mV.

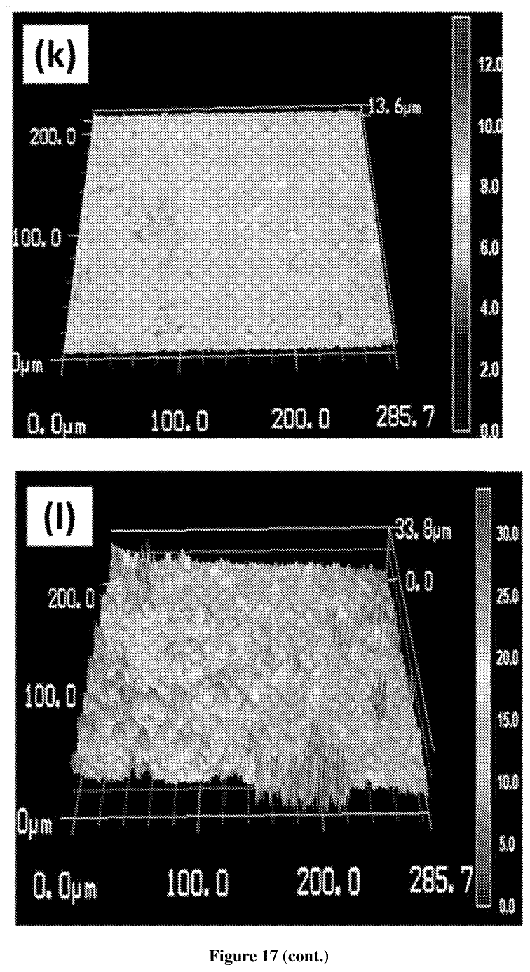

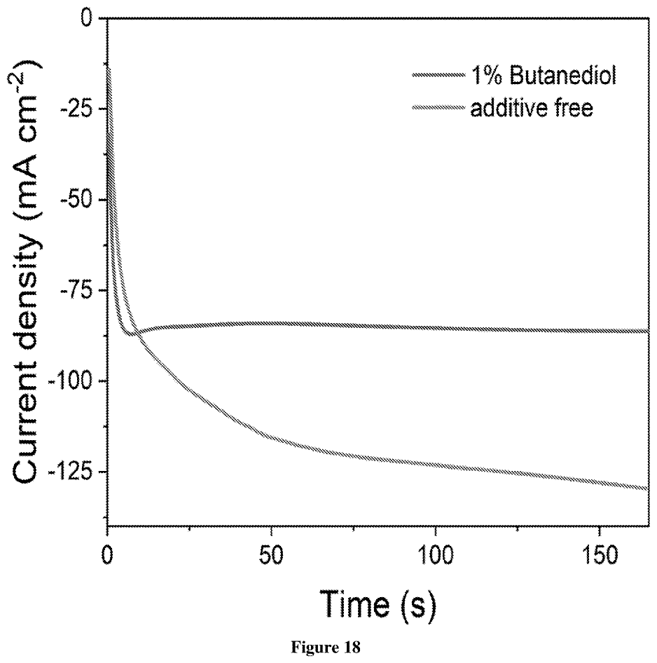

In addition, deposition regime in 1 M ZnSO₄ and 1% butanediol electrolytes were further scrutinized by chronoamperometry (CA, FIG. 18). When a fixed overpotential of 200 mV was applied to the Zn electrode in the baseline electrolyte, the current density continuously increased beyond 150 s, indicating a frantic planar diffusion process that promoted rough deposition. In sharp contrast, the Zn electrode in 1% butanediol electrolyte exhibited an initial Zn nucleation and planar diffusion for only 20 s and then proceeded into a stable 3D diffusion process, conducive for smooth deposition.

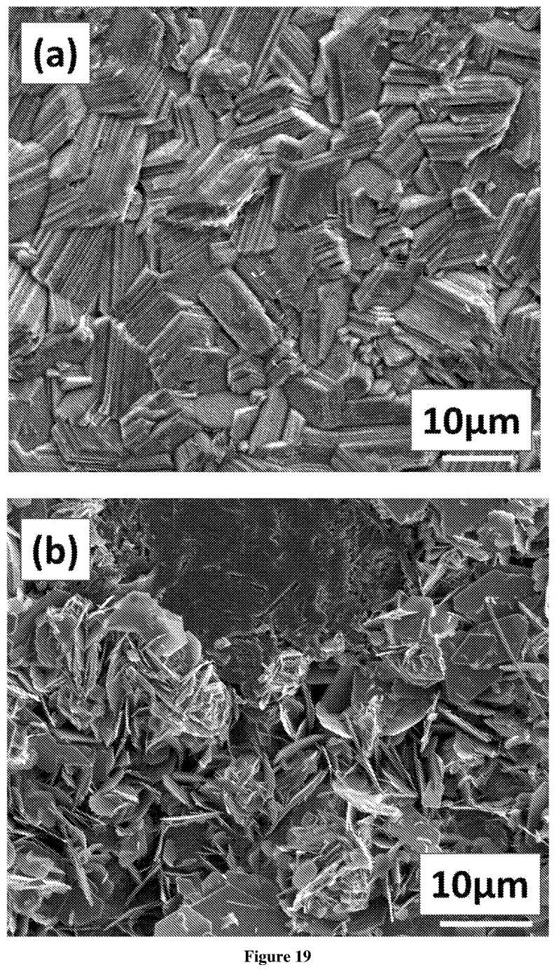

To delve more into the morphology of Zn deposition, the Zn electrodes retrieved after the 10^{th} plating in two electrolytes at 2 mA cm⁻² and 2 mAh cm⁻² were studied by SEM. As evident from FIG. 17h and FIG. 19a, the Zn plated in the optimized butanediol electrolyte showed an uniform and compact morphology, formed by merged and homogenously stacked Zn platelets, which could have been the critical reason for the high CE and stable cycling as discussed above.

Additionally, benefiting from the remarkable corrosion inhibition of the butanediol additive, even after 160 cycles in the 1% butanediol electrolyte, there was no pronounced peak of Zn₄SO₄(OH)₆·xH₂O observed in XRD (FIG. 17j). On the contrary, the Zn anode cycling in the baseline 1 M ZnSO₄ electrolyte rendered porous deposits with non-uniform distribution of Zn flakes (FIG. 17i and FIG. 19b), accompanied by LDH byproduct accumulation with cycling (FIG. 17j).

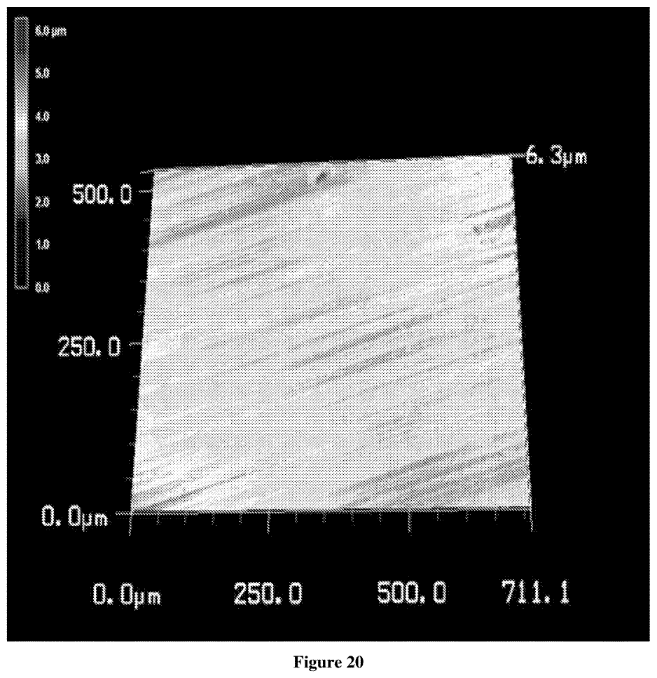

The cycled zinc electrodes were further probed by laser confocal scanning microscopy (LCSM) to visualize the three-dimensional surface microstructure and roughness. As shown in FIG. 17k, the Zn anode after 10^{th} plating in the optimized electrolyte exhibited a homogeneous and uniform Zn topography that is not too different from the smooth surface of the pristine zinc foil (FIG. 20). However, in contrast, the zinc electrode cycled in the baseline electrolyte (FIG. 17-1) showed coralloid and aiguille-like clusters distributed over the surface (height of ~33.8 um), which eventually grew and penetrated the separator and cause short-circuit of the cell.

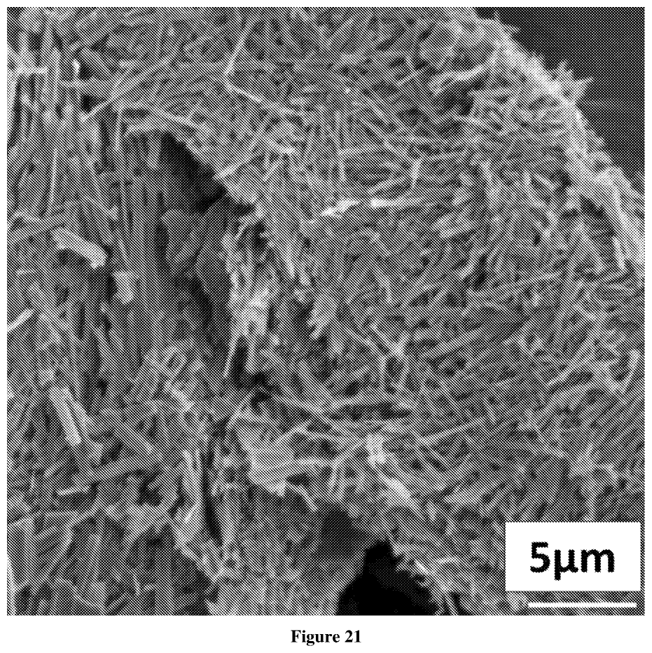

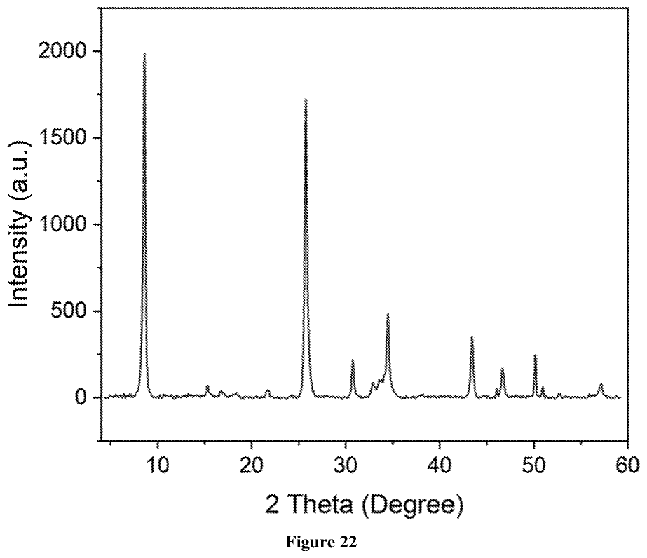

Evidently, presumably by virtue of homogeneous Zn deposition and excellent corrosion inhibition in 1% butanediol electrolyte, the zinc anode displayed greatly improved cycling stability with boosted CE even under high Zn utilization. To evaluate if this superior Zn rechargeability could be translated into promising full cell performance, the electrochemistry of the 1% butanediol electrolyte was investigated with a representative positive electrode, Zn_{0.25}V₂O₅·nH₂O³² (ZVO, FIGS. 21 and 22).

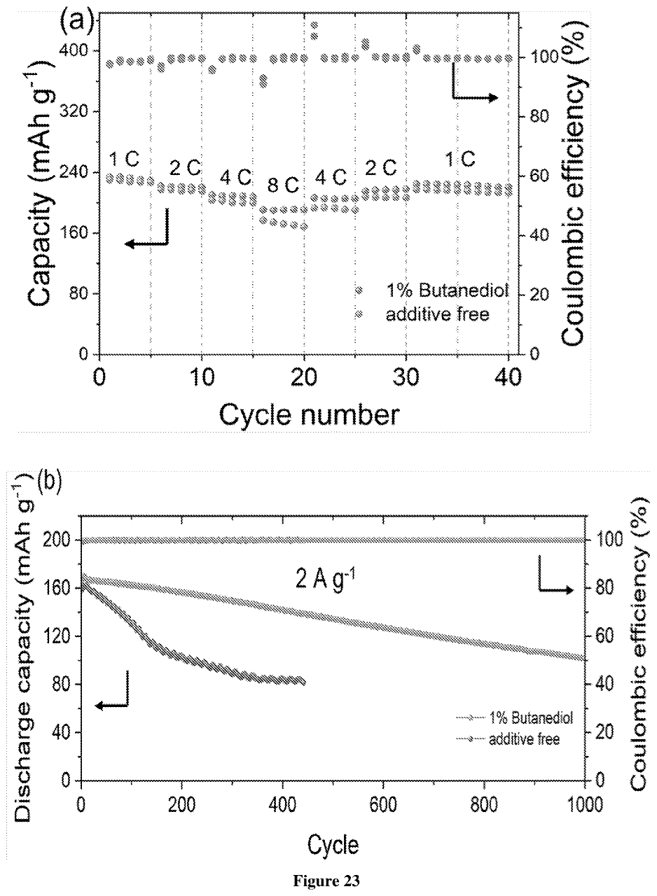

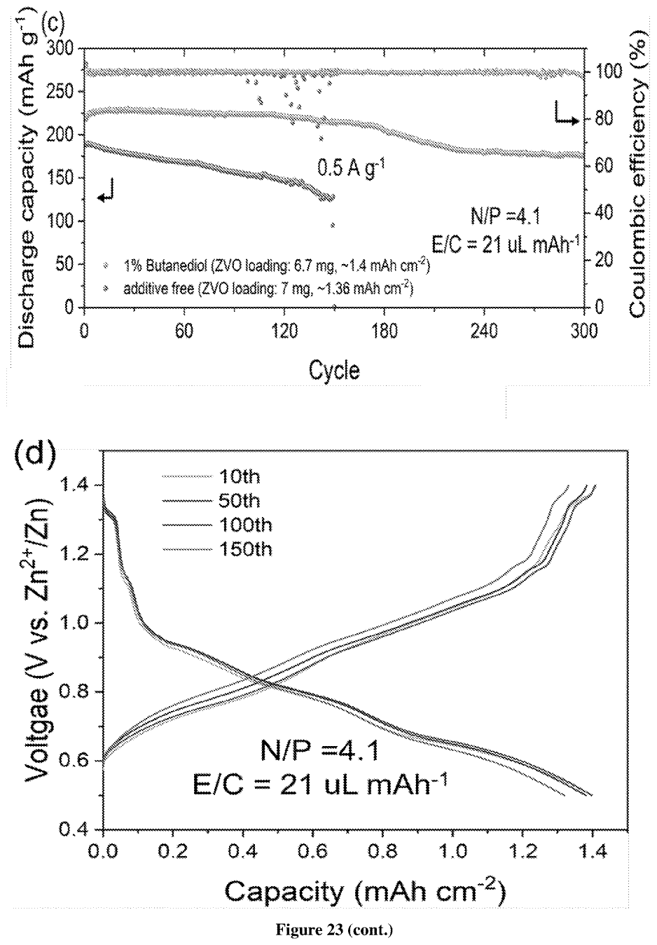

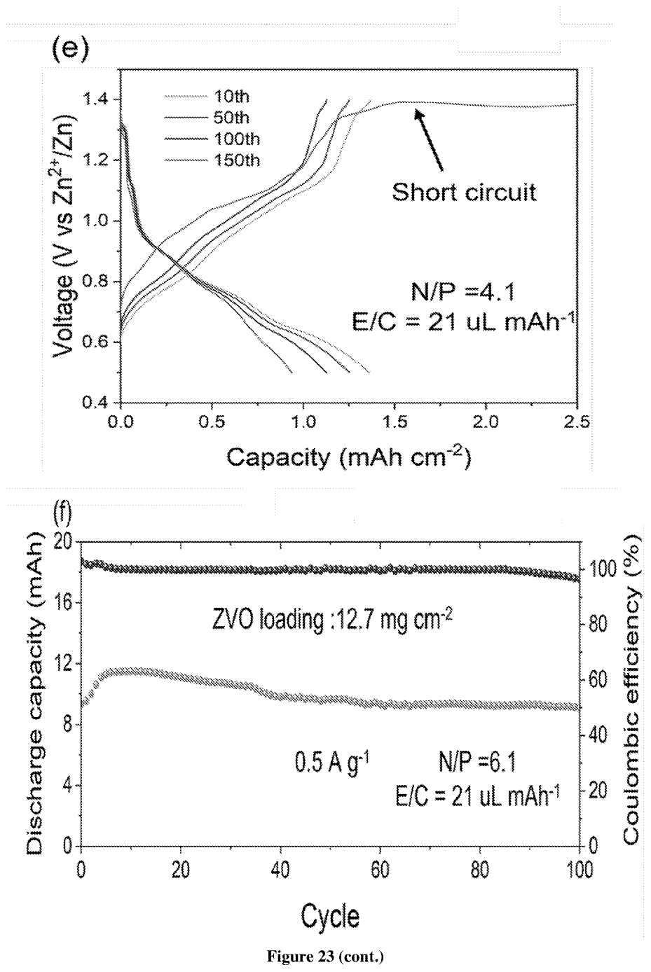

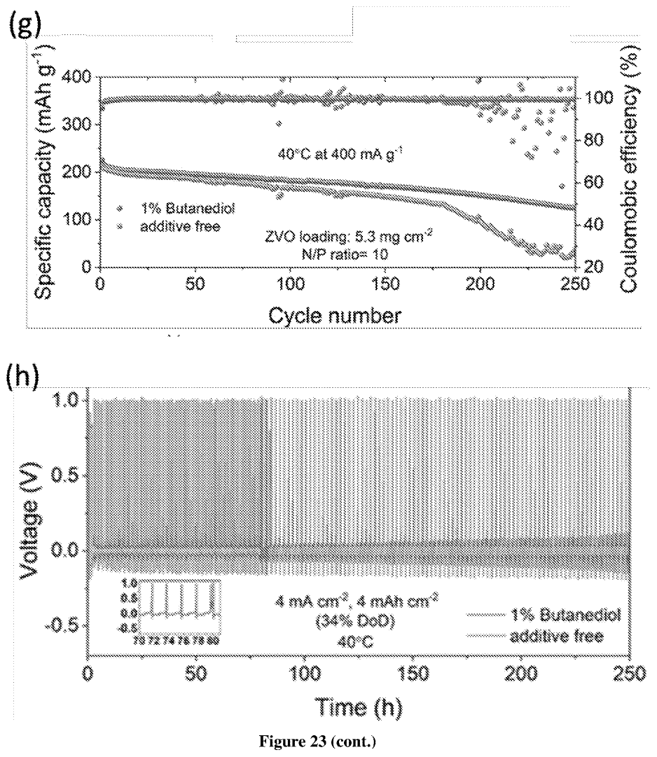

The comparison of rate performance between the two electrolytes, as illustrated in FIG. 23a, showed that the ZVO/Zn full cell in 1% butanediol electrolyte yielded a specific capacity of 233, 220, 209, 190 mAh g⁻¹ at 1, 2, 4, 8 C (1 C=250 mAh g⁻¹), respectively, which was slightly higher than that with the baseline electrolyte, especially at high rates.

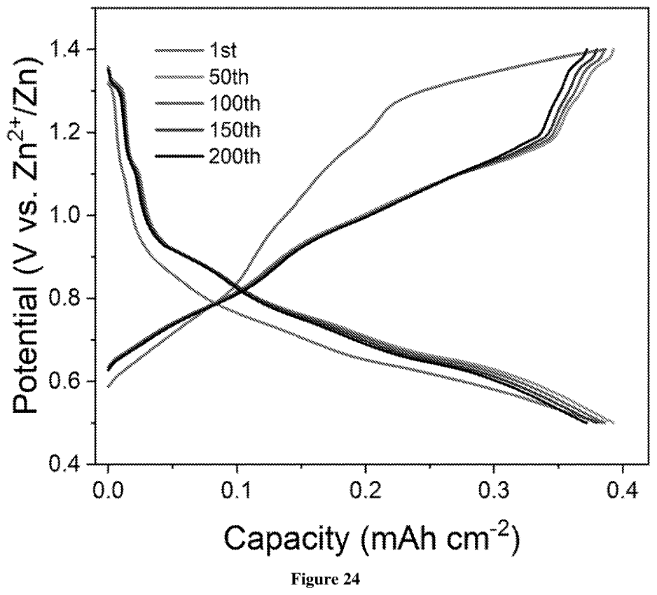

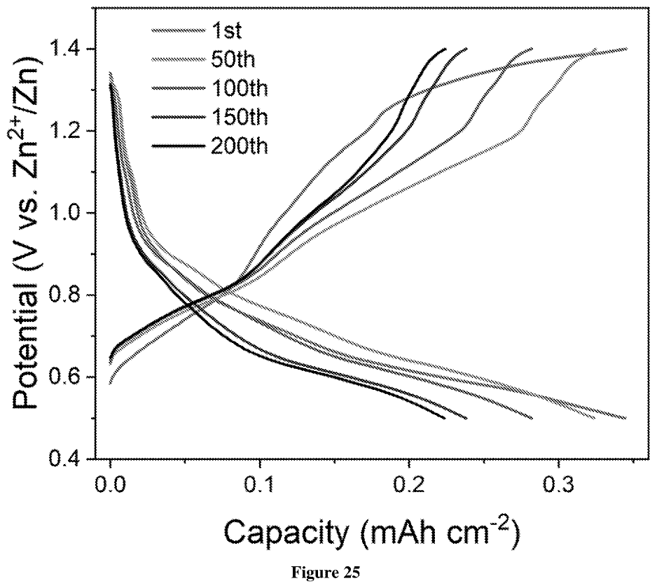

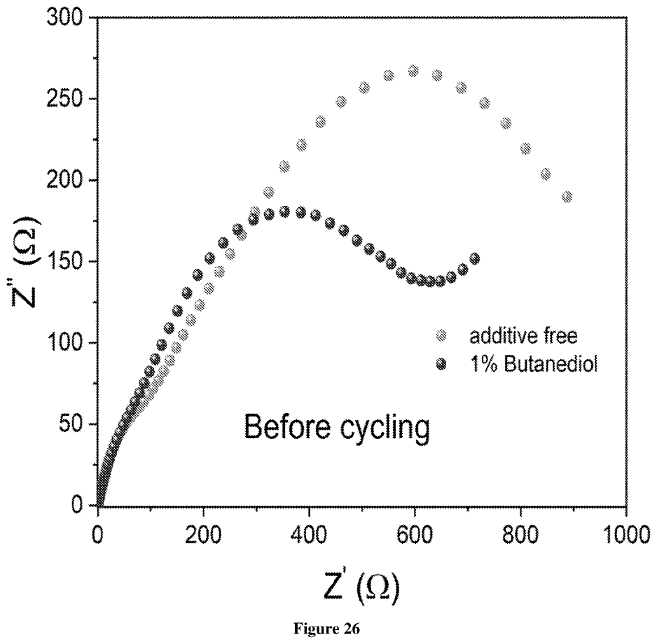

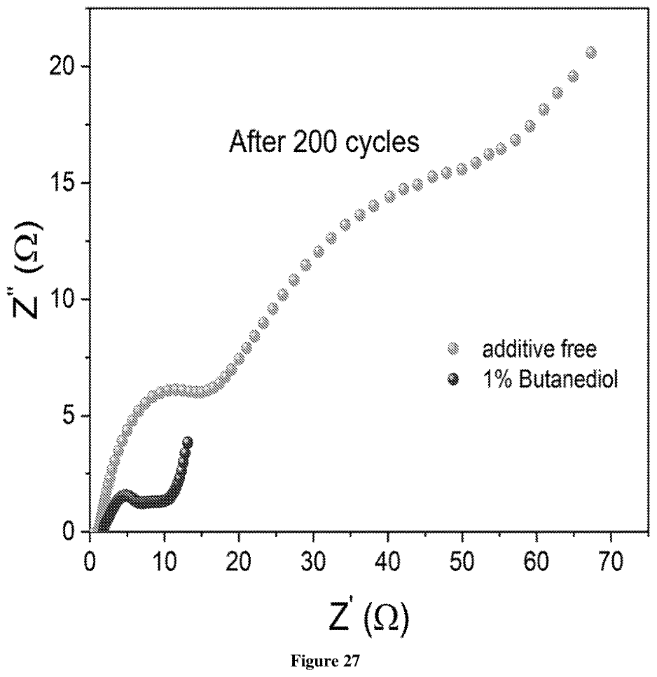

The compatibility of the butanediol additive was further examined by long-term cycling of full cells with 100 um Zn and a ZVO cathode loading of ~2 mg cm⁻². As shown in FIG. 23b and FIG. 24, the presence of butanediol in the electrolyte led to a much superior cycling stability with an average CE of 99.97% and the cell still maintained a capacity of 102 mAh g⁻¹ after 1000 cycles at a high rate of 2 A g⁻¹. Despite delivering a similar initial discharge capacity in the baseline electrolyte, the cell suffered from a dramatic capacity loss on prolonged cycling, which most likely stemmed from aggressive corrosion and insulating LDH accumulation that led to increasing polarization. (FIG. 25) This can be inferred from the EIS data, which revealed that the butanediol additive could facilitate lower impedance both before (FIG. 26) and after cycling (FIG. 27) of the full cell as was observed for the impedance of the zinc half cell (see above).

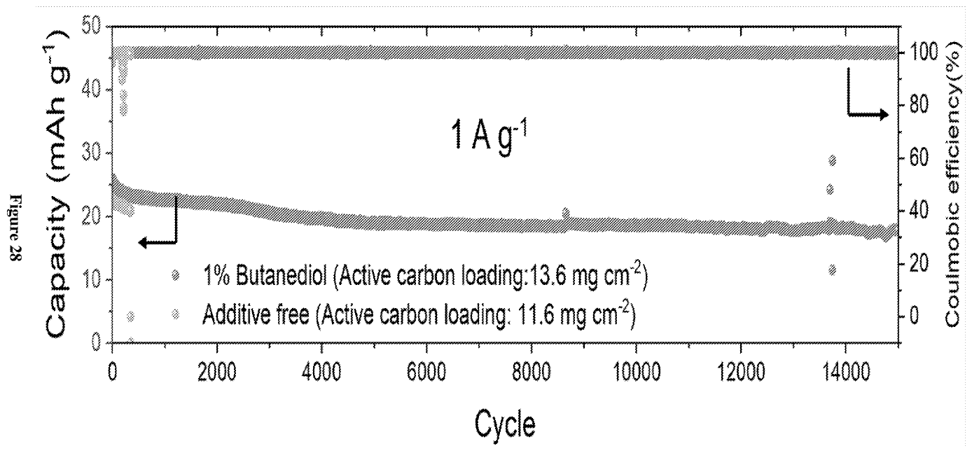

Additionally, the full cell cycling studies with activated carbon (AC) base cathode further confirmed the excellent cyclability of Zn in the 1% butanediol electrolyte (FIG. 28). The AC/Zn full cell with an AC mass loading of 13.6 mg cm⁻² showed stable cycling for over 15000 cycles at a current of 1 A g⁻¹ compared to the early failure of the reference cell (without the additive) after only 355 cycles under the same conditions.

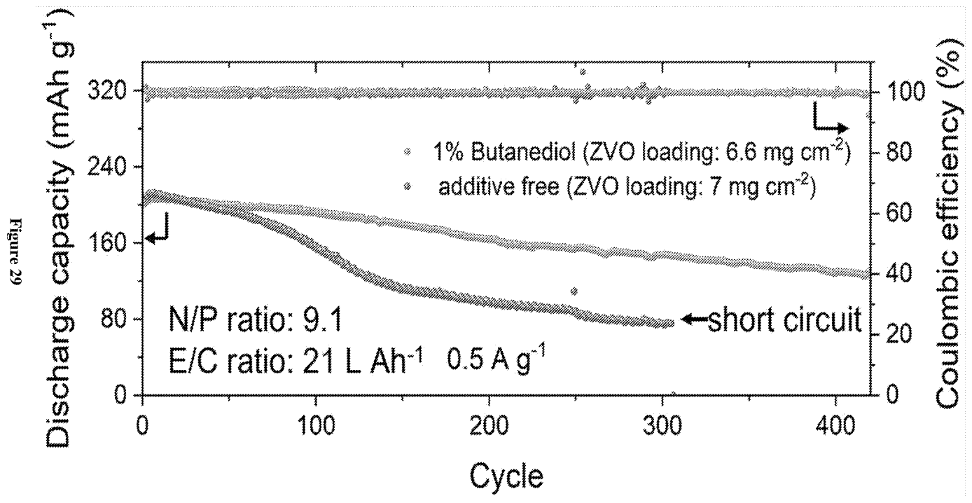

Cycling AZMBs under a high current density with low areal capacity (small cathode loading) can dramatically prolong the Zn and cathode reversibility and conceal the true performance of a full cell. Especially with a large Zn reservoir and excessive electrolytes, Zn anode problems can be masked in full cell studies. Therefore, the full cell performance was further explored with a moderately high cathode areal capacity (~1.4 mAh cm⁻²) that was essential to achieve a high energy density, together with a thin Zn foil (20 μm) and limited volume of electrolyte rendering an N/P and E/C ratio of 9.1 and 21 L mAh⁻¹, respectively. As demonstrated in FIG. 29, at a moderate current density of 0.5 A g⁻¹ (~2 C), the highly reversible operation of Zn in 1% butanediol could enable the ZVO/Zn cell to stably cycle over 400 cycles even under these strict conditions. In sharp contrast, the full cell with the baseline electrolyte displayed an inherent fast capacity decay and failed by short-circuit around the 300 cycle, highlighting the fact that the deep-cycling electrochemistry can bring out the dendritic short-circuit issues of zinc anodes.

To further explore the full cell performance under deep Zn utilization, the ZVO/Zn full cell was cycled with an ultrathin Zn foil (10 um; N/P ratio 4.1) under the same condition as above to approach practical considerations. As shown in FIGS. 23c and 23d, benefiting from the homogeneous deposition and excellent corrosion suppression of zinc, the 1% butanediol cell stably cycled for over 350 cycles at 0.5 A g⁻¹, exhibiting a specific capacity of 158.5 mAh g⁻¹ at the 360th cycle (71.6 capacity retention). However, not surprisingly, the deep zinc cycling further exposed the corrosion and the dendrite formation problems of zinc in the baseline electrolyte, as evident from the severe capacity drop (FIG. 23c) and accelerated short-circuit failure after only 150 cycles (FIG. 23e). Notably, the fluctuation of CE due to continuous consumption of Zn by side reactions as observed after about 100 cycles in the additive-free electrolyte, underpins the fact that the Zn depletion under high zinc utilization, which indirectly promotes the dendritic issue, can be a bigger concern than is otherwise identified in such experiments.

To further test the viability of the butanediol additive, single-layer 3 cm×2 cm pouch cells were fabricated, and two of those were connected in series and galvanostatically cycled. The cycling data for one such cell assembled with a N/P and E/C ratio of 6.1 and 21 μl mAh⁻¹, respectively, is presented in FIG. 23f. At a current of 0.5 A g⁻¹, the capacity attained a maximum of 11.4 mAh (~1.9 mAh cm⁻²) after 10 cycles and maintained a capacity of 9.2 mAh cm⁻² after 100 cycles. On cycling at an elevated temperature of 40° C., which is relatable to the practical operating environment, the 1% butanediol electrolyte rendered an improved ZVO∥Zn full cell stability compared to the additive-free cell (FIG. 23g). As revealed by the Zn∥Ti half-cell cycling at 40° C., the full-cell performance discrepancy in part stems from a much inferior zinc rechargeability in the additive-free electrolyte, leading to accelerated short-circuit (FIG. 23h). A slightly faster capacity decay for the 1% butanediol cell may be blamed on a faster cathode decrepitation at the higher temperature.

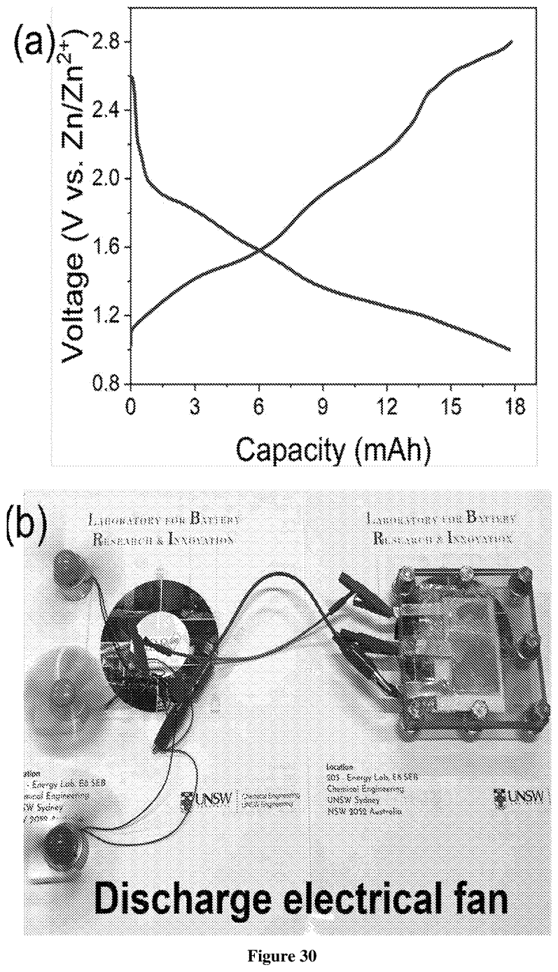

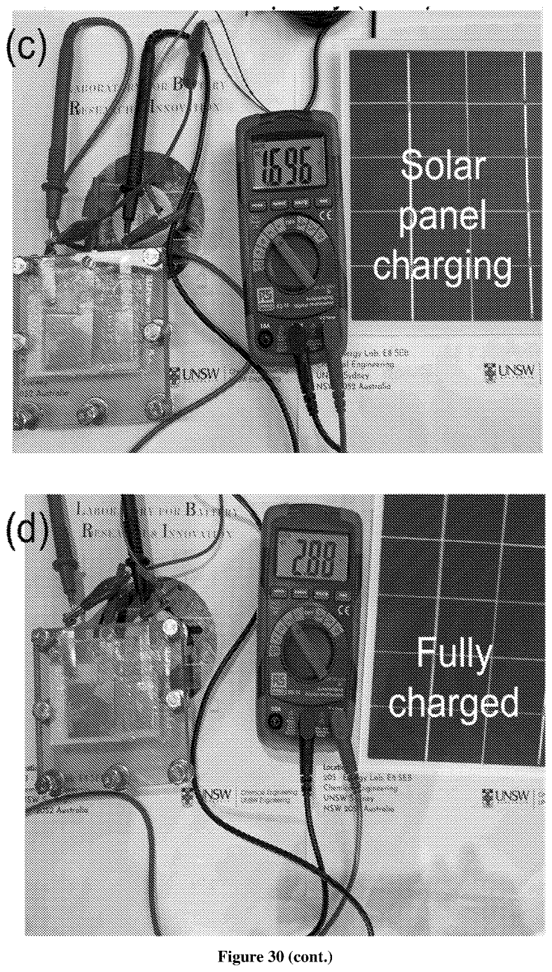

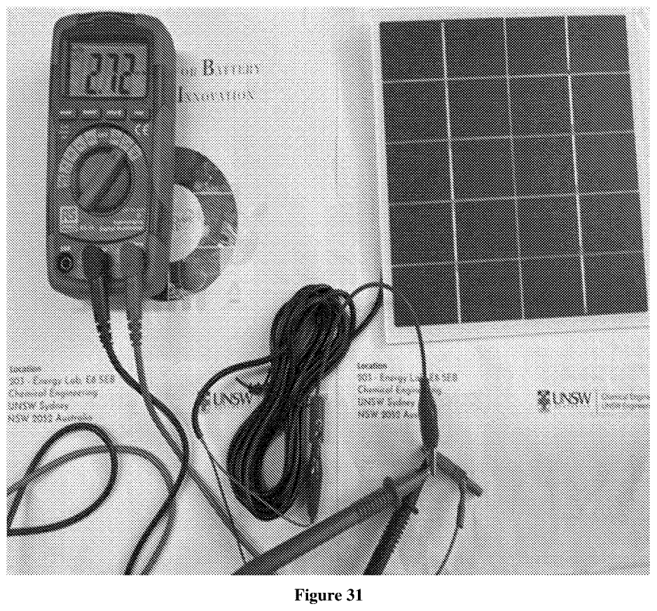

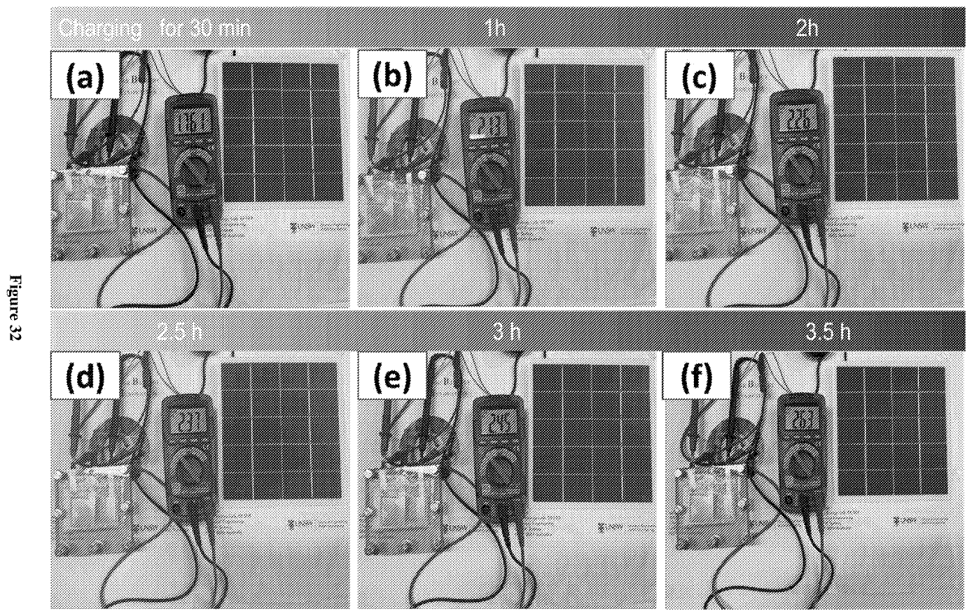

To further demonstrate performance of the electrolyte additive, a similar series connected cell stack with double the areal capacity for which the voltage profile is shown in FIG. 30a, was used to power mini fans (3-12 V DC motor, 1500-6000 rpm). The pouch cell could stably drive three fans (FIG. 30b), and could be subsequently charged by the current output (2-4 mA, depending on the solar irradiation) from a photovoltaic panel (FIG. 31). The gradual increase in voltage of the cell stack (FIG. 30c,d and FIG. 32) from 1.69 V to 2.8 V (fully charged state) due to charging showcased the excellent integrability of the developed AZMB cell chemistry with renewable energy resources, an area of application this battery technology is primed for.

### Other Alcohol Electrolyte Additives

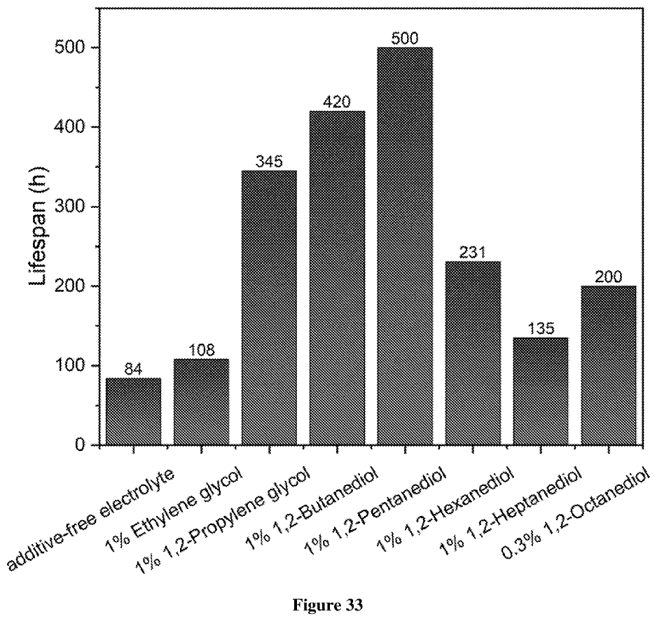

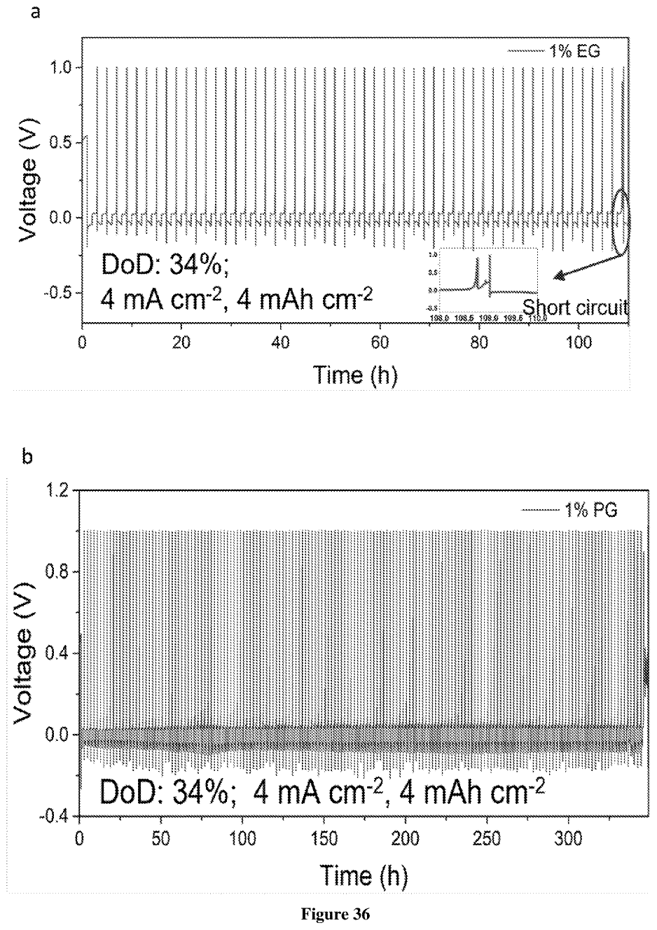

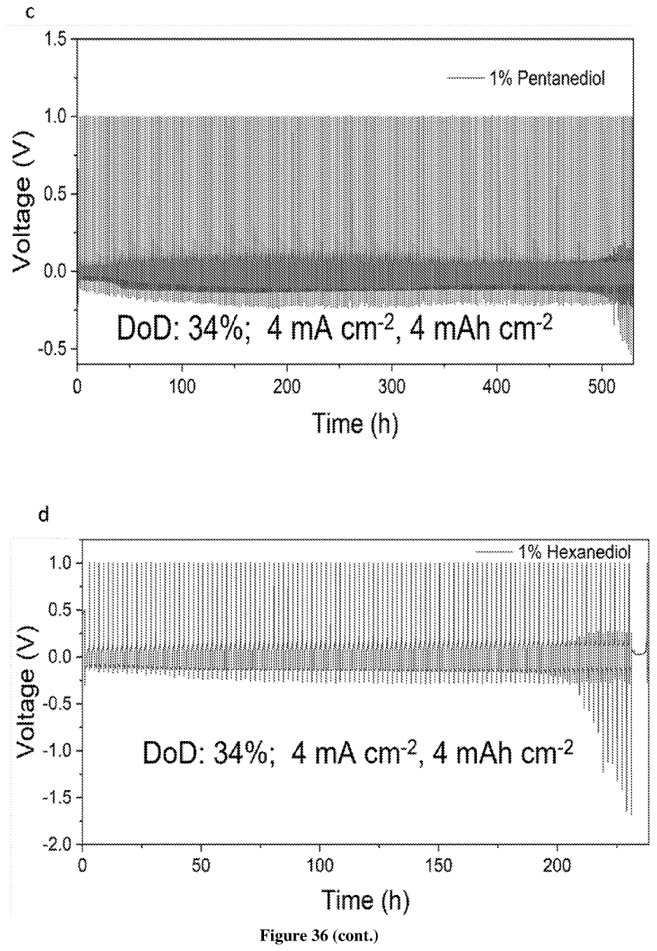

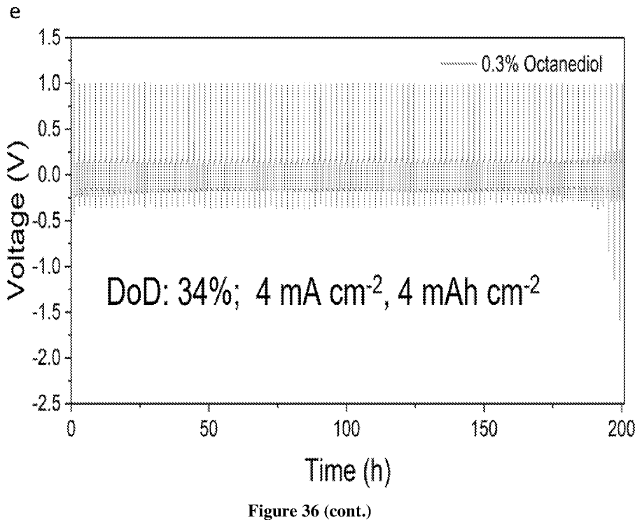

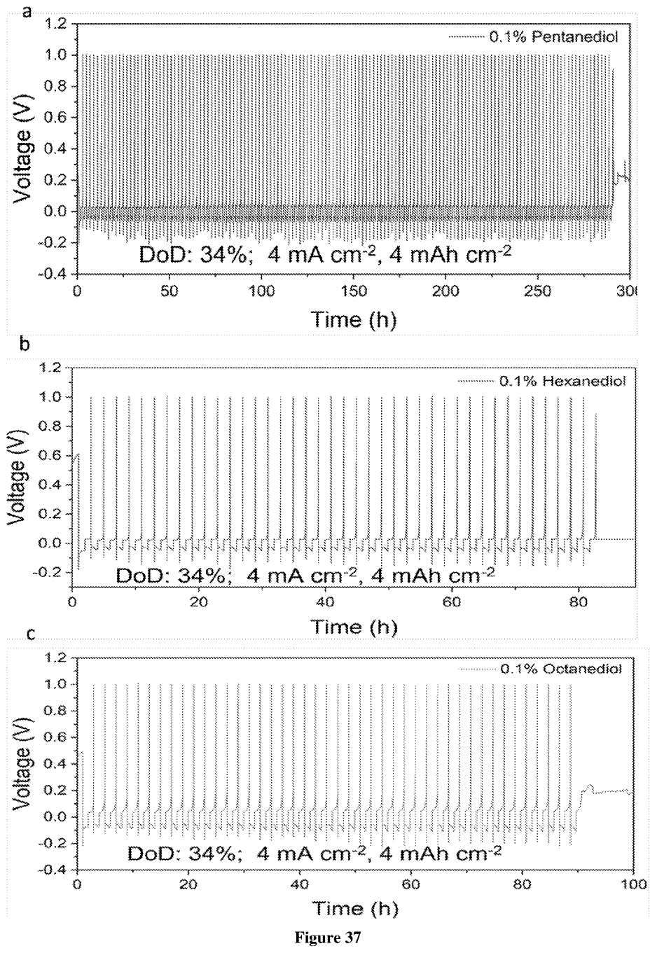

A variety of other alcohol additives were analysed similarly to 1,2-butanediol above. For example, as shown in FIG. 33 (and further at FIGS. 36 and 37), electrolytes containing 1,2-propylene glycol (1 vol. %); 1,2-butanediol (1 vol. %); 1,2-pentanediol (1 vol. %); 1,2-hexanediol (1 vol. %); 1,2-heptanediol (1 vol. %), and 1,2-octanediol (0.3 vol. %) additives all had improved lifespans as compared with additive-free electrolyte.

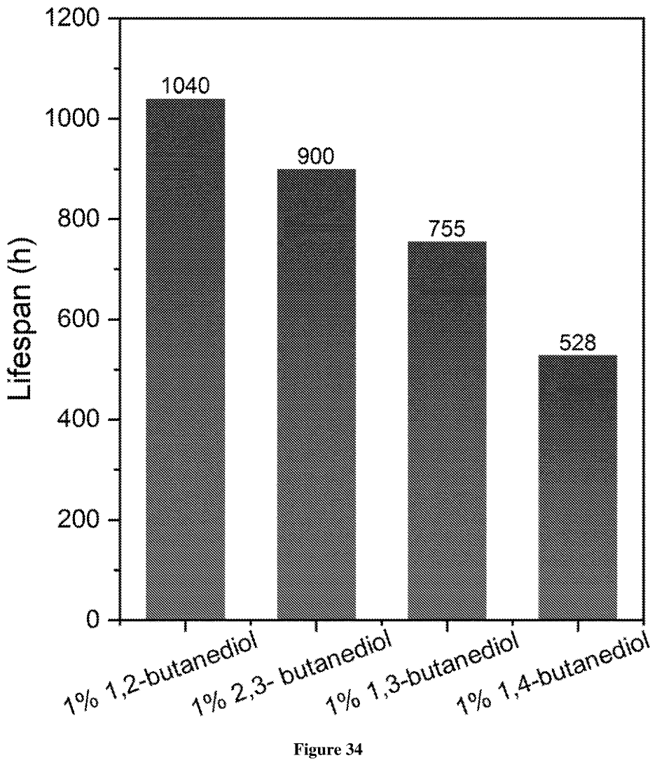

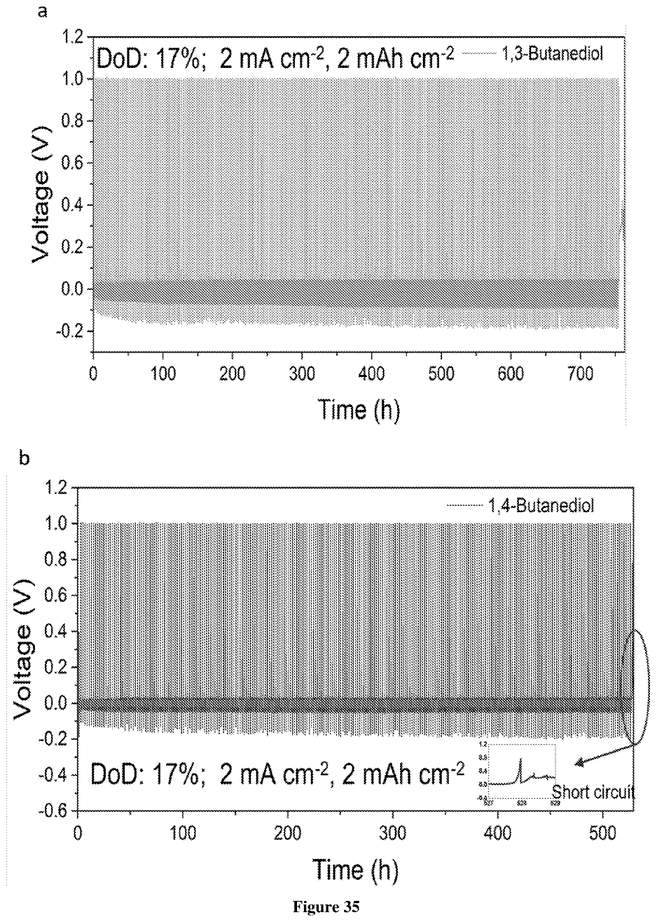

Similarly, electrolytes containing 1,3-butenaediol; 2,3-butanediol; and 1,4-butanediol were found to have comparable lifespans to 1,2-butanediol additive-containing electrolytes (FIGS. 34 and 35), which were also improved over additive-free electrolyte.

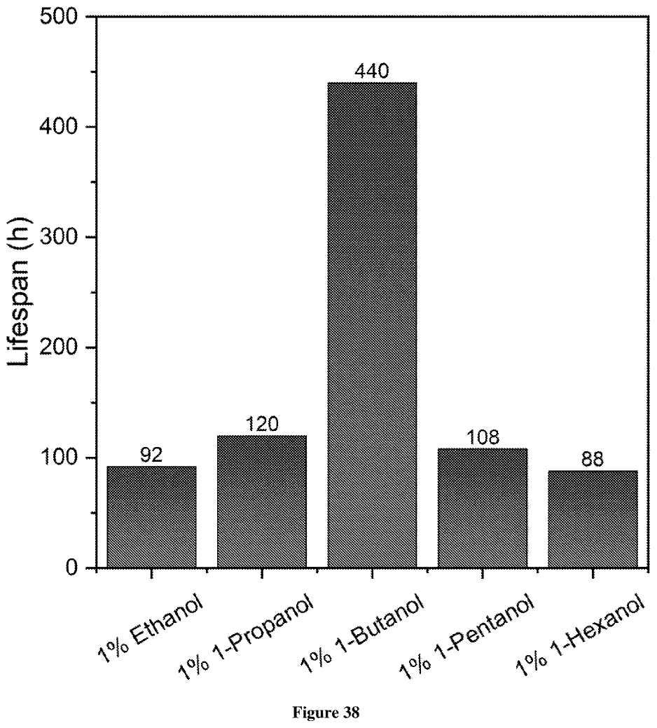

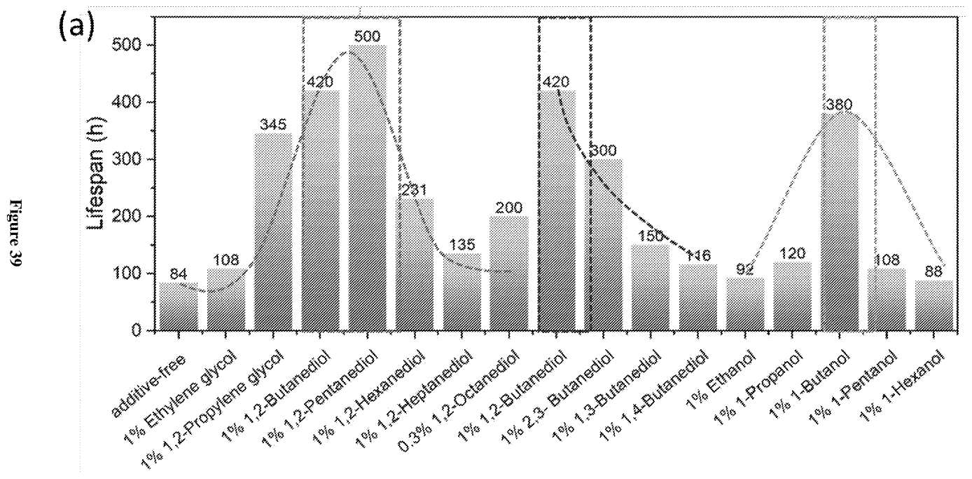

Further, electrolytes containing monohydric alcohols were also found to have improved lifespans as compared with additive-free electrolyte (FIG. 38).

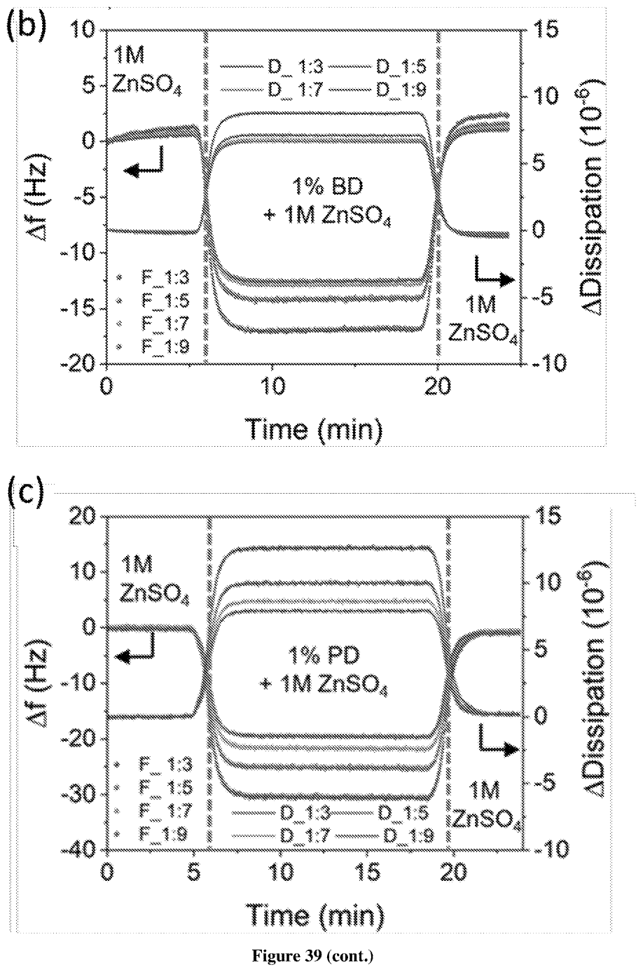

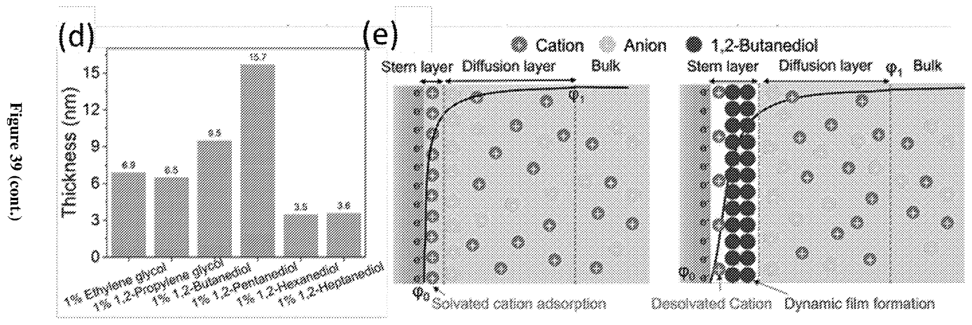

In order to identify additives that could address zinc metal rechargeability issues at low volume concentrations, alkanols (ethanol to hexanol) and alkanediols (ethylene glycol to 1,2-heptanediol) were investigated at 1 volume % concentration in 1 M ZnSO₄—H₂O as the electrolyte (using 0.3 vol % for 1,2 octanediol; its maximum solubility in water at 22° C.). Notably, alkanols and alkanediols were chosen due to their favorable adsorption energies on zinc and, most importantly, their chemical benignness and ease of availability, although a skilled person would appreciate that other alcohols could have also been used. Primary alkanols and the 1,2 variant (—OH position) of the alkanediols were employed for the comparative screening, and the influence of the position of the two OH on the carbon backbone was probed with butanediol isomers. For rapid screening, the zinc cycling was evaluated in a Zn∥Ti asymmetric cell configuration with a limited Zn source (20 μm, 1 cm⁻²) under 4 mA-4 mAh cm⁻², corresponding to 34% zinc utilization or depth of discharge (DoD). A glass fiber filter separator of 190 μm thickness and an electrolyte to capacity ratio of 12.5 μL mAh⁻¹ was employed for all studies unless otherwise mentioned. As demonstrated in FIG. 39(a), 1,2-butanediol, and 1,2 pentanediol emerged as the most efficient additives from the screening experiment. Among butanediol —OH positional isomers (FIG. 39(a)), the 1,2 analogue turned out to be the best-performing variant. The results were consistent across multiple cells tested for all additives with around 5% variation. While most cells failed by the dendritic short circuit, a few died due to the plating polarization reaching the cut-off voltage due to depletion of the zinc anode through corrosion. Corrosion and dendrite formation appear to be strongly correlated, one furthering another and thus accelerating cell failure.

It is conceivable that 1,2 butanediol and pentanediol may have optimal physicochemical attributes, i.e., the right combination of adsorption (on zinc), solvation, and association energies, necessary for the additive film formation at the Zn/electrolyte interface, which acts like a dynamic SEI to suppress corrosion and deposition instability. The term ‘dynamic’ refers to the fact that the SEI is composed of additive molecules, self-organized at the metal interface through a dynamic adsorption/desorption equilibrium. Regarding this, quartz-crystal microbalance with energy dissipation (QCM-D) based measurement, exploiting the changes in the oscillation frequency of a piezoelectric sensor to monitor the real-time formation of viscoelastic films at surfaces, was employed to visualize the film formation mechanism. The measurement was conducted by a three-step process, as presented in FIGS. 39(b) and 39(c). First, the additive-free electrolyte (aqueous 1 M ZnSO₄) was flowed over the QCM-D sensor to establish the baseline for frequency and dissipation shift induced by salt adsorption. Then, the frequency and dissipation change due to the additive filming was observed by flowing the additive-containing electrolyte. After the stabilization of the second step, the additive-free electrolyte was re-flowed back over the sensor to prove the reversibility of the additive filming phenomenon. In essence, the mass accumulation on the surface, due to additive filming during the second step, induced a shift (Δf) in the oscillation frequency of the quartz crystal that was excited by applying a voltage. When this driving voltage was stopped, the time required for the oscillation to cease was quantified as dissipative energy losses (ΔDissipation), which provided an indication of the viscoelasticity of the adsorbed layer. Consequently, the pronounced frequency shift observed for 1% 1,2 butanediol and 1,2 pentanediol electrolytes (as depicted in FIGS. 39(b) and 39(c)) signified enhanced adsorption and filming of the two additives, particularly when compared to other alkanediol additives, namely ethylene glycol, propylene glycol, hexanediol, and heptanediol. To further analyse the film formation, the different harmonics were fitted by ‘Broadfit’ viscoelastic function to obtain the additive-adsorption layer thickness, as presented in FIG. 39(d), revealing thicker film formation with 1,2-butanediol and 1,2-pentanediol molecules (with adsorption layer thickness of 9.5 and 15.7 nm, respectively). Notably, the reversibility of the adsorption process was demonstrated by the return of both frequency and dissipation shift to zero upon reverting the flowing fluid to the additive-free electrolyte in the third step. The observed dissipation values (ΔDissipation>1 ppm) and the nonlinear change of the frequency and dissipation shift with increasing harmonics indicate the film's viscoelastic nature. A similar additive film thickness for hexanediol and heptanediol electrolytes, but their considerably different zinc cycling performance sheds light on the importance of the additive film properties. Without being bound by theory, is believed that the higher hydrophobicity of heptanediol film may lead to an increased plating overpotential, which could trigger accelerated dendritic failure. The fact that the additive film thickness did not linearly increase with the alkanediol chain length suggested that intermolecular interaction-mediated self-organization of the additive molecules at the interface may play a role in determining the film thickness and its properties.

The existence of dynamic SEI furnished by the additive filming was also indirectly confirmed by probing and modelling the electric double layer (EDL) properties. From an analysis perspective, the EDL at the Zn/electrolyte interface can be modelled as the combination of an immobile Stern layer (SL) and a mobile diffusion layer (DL) based on the Gouy-Chapman-Stern model (FIG. 39(e)). For the electrolytes furnishing an interfacial additive film, which was expected to have a dominant hydrophobic nature owing to the extended carbon backbone of the additive molecule, the SL primarily consisted of multiple layers of self-organized additive molecules, resulting in the exclusion of ions from the SL and likely from the DL and a significant drop in the EDL permittivity. This could induce a sharp drop in the EDL capacitance (C_{EDL}), which is the combination of C_{SL} and C_{DL} according to 1/C_{EDL}=1/C_{SL}+1/C_{DL}. This hypothesis was confirmed by the C_{EDL} values, directly measured by cyclic voltammetry of the Ti∥Ti system to eliminate any faradaic interference. The derived C_{EDL} value trend agreed reasonably well with the QCM-D-based analysis, with the 1%-1,2 butanediol and 1%-1,2 pentanediol electrolytes displaying the lowest capacitance. More pronounced additive filming for butanediol and pentanediol electrolytes may lead to a significant drop in the interfacial permittivity and result in a lower C_{EDL}.

Other embodiments of the invention as described herein are defined in the following paragraphs:

1. An aqueous rechargeable zinc battery electrolyte additive comprising: an aliphatic alcohol compound having from 4 to 10 carbon atoms, optionally wherein the concentration of the aliphatic alcohol in the aqueous rechargeable zinc battery electrolyte additive is from about 10% (w/w) to about 100% (w/w), or from about 20% (w/w) to about 100% (w/w), about 30% (w/w) to about 100% (w/w), about 40% (w/w) to about 100% (w/w), about 50% (w/w) to about 100% (w/w), about 60% (w/w) to about 100% (w/w), about 70% (w/w) to about 100% (w/w), about 80% (w/w) to about 100% (w/w), about 90% (w/w) to about 100% (w/w), about 95% (w/w) to about 100% (w/w), about 97% (w/w) to about 100% (w/w), about 50% (w/w) to about 90% (w/w), about 50% (w/w) to about 80% (w/w), about 50% (w/w) to about 70% (w/w), or about 50% (w/w) to about 60% (w/w), or greater than or equal to about 10% (w/w), 20% (w/w), 30% (w/w), 40% (w/w), 50% (w/w), 60% (w/w), 70% (w/w), 80% (w/w), 90% (w/w), 95% (w/w), or 97% (w/w), or about 10% (w/w), 20% (w/w), 30% (w/w), 40% (w/w), 50% (w/w), 50% (w/w), 60% (w/w), 60% (w/w), 70% (w/w), 80% (w/w), 90% (w/w), 95% (w/w), 97% (w/w), 99% (w/w), 99.5% (w/w), 99.7% (w/w), or 100% (w/w).

2. The aqueous rechargeable zinc battery electrolyte additive according to any one or more of the preceding paragraphs, wherein the aliphatic alcohol compound has from 4 to 8 carbon atoms; optionally where the aliphatic alcohol compound has from 4 to 7 carbon atoms; optionally 4 or 5 carbon atoms.

3. The aqueous rechargeable zinc battery electrolyte additive according to any one or more of the preceding paragraphs, wherein the aliphatic alcohol compound is saturated and acyclic.

4. The aqueous rechargeable zinc battery electrolyte additive according to any one or more of the preceding paragraphs, wherein the aliphatic alcohol compound contains one or two hydroxyl groups.

5. The aqueous rechargeable zinc battery electrolyte additive according to any one or more of the preceding paragraphs, wherein the aliphatic alcohol compound is a diol, optionally wherein the diol has the molecular formula O₂CₙHₙ₊₂, wherein n is an integer from 4 to 10, optionally wherein n is an integer from 4 to 8, optionally wherein n is an integer from 4 to 7, or wherein the diol is selected from the group consisting of butanediol, pentanediol, hexanediol, heptanediol, octanediol, and mixtures thereof, or the diol is selected from the group consisting of 1,2-butanediol; 1,3-butanediol; 1,4-butanediol; 2,3-butanediol; 1,2-pentanediol; 1,3-pentanediol; 1,4-pentanediol; 1,5-pentanediol; 2,3-pentanediol; 2,4-pentanediol; 1,2-hexanediol; 1,3-hexanediol; 1,4-hexanediol; 1,5-hexanediol; 1,6-hexanediol; 1,2-heptanediol; 1,2-octanediol; and mixtures thereof, or wherein the diol is a 1,2-diol, or wherein the diol is 1,2-butanediol or 1,2-pentanediol.

6. The aqueous rechargeable zinc battery electrolyte additive according to any one or more of the preceding paragraphs, wherein the diol is selected from the group consisting of butanediol, pentanediol, hexanediol, heptanediol, octanediol, and mixtures thereof.

7. The aqueous rechargeable zinc battery electrolyte additive according to any one or more of the preceding paragraphs, wherein the diol is selected from the group consisting of 1,2-butanediol; 1,3-butanediol; 1,4-butanediol; 2,3-butanediol; 1,2-pentanediol; 1,3-pentanediol; 1,4-pentanediol; 1,5-pentanediol; 2,3-pentanediol; 2,4-pentanediol; 1,2-hexanediol; 1,3-hexanediol; 1,4-hexanediol; 1,5-hexanediol; 1,6-hexanediol; 1,2-heptanediol; 1,2-octanediol; and mixtures thereof.

8. The aqueous rechargeable zinc battery electrolyte additive according to any one or more of the preceding paragraphs, wherein the diol is a 1,2-diol.

9. The aqueous rechargeable zinc battery electrolyte additive according to any one or more of the preceding paragraphs, wherein the diol is 1,2-butanediol or 1,2-pentanediol.

10. The aqueous rechargeable zinc battery electrolyte additive according to any one or more of the preceding paragraphs, wherein the aliphatic alcohol compound is selected from the group consisting of 1-butanol; 1,2-butanediol; and 1,2-pentanediol.

11. An aqueous rechargeable zinc battery electrolyte comprising:
the zinc ion battery electrolyte additive according to any one or more of the preceding paragraphs; and
a zinc salt;
optionally wherein the zinc ion battery electrolyte comprises no, or substantially no glycolate, or the zinc ion battery electrolyte comprises no, or substantially no glycolate in gel form.

12. The aqueous rechargeable zinc battery electrolyte according to any one or more of the preceding paragraphs, which has a pH from about 0 to about 7, optionally from about 3 to about 6, or from about 0 to about 7, or from about 0.4 to about 7, about 0.8 to about 7, about 1.2 to about 7, about 1.6 to about 7, about 2 to about 7, about 2.3 to about 7, about 2.6 to about 7, about 2.9 to about 7, about 3.2 to about 7, about 3.5 to about 7, about 3.8 to about 7, about 4.1 to about 7, about 4.4 to about 7, about 4.7 to about 7, about 5 to about 7, about 0 to about 6.8, about 0 to about 6.6, about 0 to about 6.4, about 0 to about 6.2, about 0 to about 6, about 0 to about 5.8, about 0 to about 5.6, about 0 to about 5.4, about 0 to about 5.2, about 0 to about 5, about 2 to about 5, about 2.6 to about 5, about 3.2 to about 5, about 3.8 to about 5, about 4.4 to about 5, about 2 to about 4.4, about 2 to about 3.8, about 2 to about 3.2, or about 2 to about 2.6, or greater than or equal to about 0, 0.2, 0.4, 0.6, 0.8, 1, 1.2, 1.4, 1.6, 1.8, 2, 2.3, 2.6, 2.9, or 3.2, or less than or equal to about 7, 6.8, 6.6, 6.4, 6.2, 6, 5.8, 5.6, 5.4, 5.2, 5, 4.7, 4.4, 4.1, or 3.8, or about 0, 0.2, 0.4, 0.6, 0.8, 1, 1.2, 1.4, 1.6, 1.8, 2, 2.2, 2.3, 2.4, 2.6, 2.8, 2.9, 3, 3.2, 3.4, 3.5, 3.6, 3.8, 4, 4.1, 4.2, 4.4, 4.6, 4.7, 4.8, 5, 5.4, 5.6, 5.8, 6, 6.2, 6.4, 6.6, 6.8, or 7.

13. The aqueous rechargeable zinc battery electrolyte according to any one or more of the preceding paragraphs, which comprises from about 0.05 vol. % to about 10 vol. % of the aliphatic alcohol compound, or from about 0.01 vol. % to about 15 vol. %, or from about 0.028 vol. % to about 15 vol. %, about 0.046 vol. % to about 15 vol. %, about 0.064 vol. % to about 15 vol. %, about 0.082 vol. % to about 15 vol. %, about 0.1 vol. % to about 15 vol. %, about 0.59 vol. % to about 15 vol. %, about 1.1 vol. % to about 15 vol. %, about 1.6 vol. % to about 15 vol. %, about 2.1 vol. % to about 15 vol. %, about 2.6 vol. % to about 15 vol. %, about 3 vol. % to about 15 vol. %, about 3.5 vol. % to about 15 vol. %, about 4 vol. % to about 15 vol. %, about 4.5 vol. % to about 15 vol. %, about 5 vol. % to about 15 vol. %, about 0.01 vol. % to about 14 vol. %, about 0.01 vol. % to about 13 vol. %, about 0.01 vol. % to about 12 vol. %, about 0.01 vol. % to about 11 vol. %, about 0.01 vol. % to about 10 vol. %, about 0.01 vol. % to about 9 vol. %, about 0.01 vol. % to about 8 vol. %, about 0.01 vol. % to about 7 vol. %, about 0.01 vol. % to about 6 vol. %, about 0.01 vol. % to about 5 vol. %, about 0.1 vol. % to about 5 vol. %, about 1.1 vol. % to about 5 vol. %, about 2.1 vol. % to about 5 vol. %, about 3 vol. % to about 5 vol. %, about 4 vol. % to about 5 vol. %, about 0.1 vol. % to about 4 vol. %, about 0.1 vol. % to about 3 vol. %, about 0.1 vol. % to about 2.1 vol. %, or about 0.1 vol. % to about 1.1 vol. %, or greater than or equal to about 0.01 vol. %, 0.019 vol. %, 0.028 vol. %, 0.037 vol. %, 0.046 vol. %, 0.055 vol. %, 0.064 vol. %, 0.073 vol. %, 0.082 vol. %, 0.091 vol. %, 0.1 vol. %, 0.59 vol. %, 1.1 vol. %, 1.6 vol. %, or 2.1 vol. %, or less than or equal to about 15 vol. %, 14 vol. %, 13 vol. %, 12 vol. %, 11 vol. %, 10 vol. %, 9 vol. %, 8 vol. %, 7 vol. %, 6 vol. %, 5 vol. %, 4.5 vol. %, 4 vol. %, 3.5 vol. %, or 3 vol. %, or about 0.01 vol. %, 0.019 vol. %, 0.028 vol. %, 0.037 vol. %, 0.046 vol. %, 0.055 vol. %, 0.064 vol. %, 0.073 vol. %, 0.082 vol. %, 0.091 vol. %, 0.1 vol. %, 0.34 vol. %, 0.59 vol. %, 0.84 vol. %, 1.1 vol. %, 1.3 vol. %, 1.6 vol. %, 1.8 vol. %, 2.1 vol. %, 2.3 vol. %, 2.6 vol. %, 2.8 vol. %, 3 vol. %, 3.3 vol. %, 3.5 vol. %, 3.8 vol. %, 4 vol. %, 4.3 vol. %, 4.5 vol. %, 4.8 vol. %, 5 vol. %, 7 vol. %, 8 vol. %, 9 vol. %, 10 vol. %, 11 vol. %, 12 vol. %, 13 vol. %, 14 vol. %, or 15 vol. %.

14. The aqueous rechargeable zinc battery electrolyte according to any one or more of the preceding paragraphs, which comprises from about 0.1 vol. % to about 2 vol. % of the aliphatic alcohol compound; optionally about 1 vol. % of the aliphatic alcohol compound.

15. The aqueous rechargeable zinc battery electrolyte according to any one or more of the preceding paragraphs, wherein the concentration of the zinc salt in the electrolyte is from about 0.05 M to about 3 M; optionally wherein the concentration of the zinc salt in the electrolyte is about 1 M, or from about 10 mM to about 5 M, or from about 18 mM to about 5 M, about 26 mM to about 5 M, about 34 mM to about 5 M, about 42 mM to about 5 M, about 50 mM to about 5 M, about 340 mM to about 5 M, about 640 mM to about 5 M, about 940 mM to about 5 M, about 1.2 M to about 5 M, about 1.5 M to about 5 M, about 1.8 M to about 5 M, about 2.1 M to about 5 M, about 2.4 M to about 5 M, about 2.7 M to about 5 M, about 3 M to about 5 M, about 10 mM to about 4.8 M, about 10 mM to about 4.6 M, about 10 mM to about 4.4 M, about 10 mM to about 4.2 M, about 10 mM to about 4 M, about 10 mM to about 3.8 M, about 10 mM to about 3.6 M, about 10 mM to about 3.4 M, about 10 mM to about 3.2 M, about 10 mM to about 3 M, about 50 mM to about 3 M, about 640 mM to about 3 M, about 1.2 M to about 3 M, about 1.8 M to about 3 M, about 2.4 M to about 3 M, about 50 mM to about 2.4 M, about 50 mM to about 1.8 M, about 50 mM to about 1.2 M, or about 50 mM to about 640 mM, or greater than or equal to about 10 mM, 14 mM, 18 mM, 22 mM, 26 mM, 30 mM, 34 mM, 38 mM, 42 mM, 46 mM, 50 mM, 340 mM, 640 mM, 940 mM, or 1.2 M, or less than or equal to about 5 M, 4.8 M, 4.6 M, 4.4 M, 4.2 M, 4 M, 3.8 M, 3.6 M, 3.4 M, 3.2 M, 3 M, 2.7 M, 2.4 M, 2.1 M, or 1.8 M, or about 10 mM, 14 mM, 18 mM, 22 mM, 26 mM, 30 mM, 34 mM, 38 mM, 42 mM, 46 mM, 50 mM, 200 mM, 340 mM, 490 mM, 640 mM, 790 mM, 940 mM, 1.1 M, 1.2 M, 1.4 M, 1.5 M, 1.7 M, 1.8 M, 2 M, 2.1 M, 2.3 M, 2.4 M, 2.6 M, 2.7 M, 2.9 M, 3 M, 3.4 M, 3.6 M, 3.8 M, 4 M, 4.2 M, 4.4 M, 4.6 M, 4.8 M, or 5 M, optionally wherein the concentration of water in the aqueous rechargeable zinc battery electrolyte is from about 50 vol. % to about 99.98 vol. %, or from about 59 vol. % to about 99.98 vol. %, about 68 vol. % to about 99.98 vol. %, about 77 vol. % to about 99.98 vol. %, about 86 vol. % to about 99.98 vol. %, about 95 vol. % to about 99.98 vol. %, about 95.45 vol. % to about 99.98 vol. %, about 95.9 vol. % to about 99.98 vol. %, about 96.35 vol. % to about 99.98 vol. %, about 96.8 vol. % to about 99.98 vol. %, about 97.25 vol. % to about 99.98 vol. %, about 97.7 vol. % to about 99.98 vol. %, about 98.15 vol. % to about 99.98 vol. %, about 98.6 vol. % to about 99.98 vol. %, about 99.05 vol. % to about 99.98 vol. %, about 99.5 vol. % to about 99.98 vol. %, about 50 vol. % to about 99.93 vol. %, about 50 vol. % to about 99.88 vol. %, about 50 vol. % to about 99.84 vol. %, about 50 vol. % to about 99.79 vol. %, about 50 vol. % to about 99.74 vol. %, about 50 vol. % to about 99.69 vol. %, about 50 vol. % to about 99.64 vol. %, about 50 vol. % to about 99.6 vol. %, about 50 vol. % to about 99.55 vol. %, about 50 vol. % to about 99.5 vol. %, about 95 vol. % to about 99.5 vol. %, about 95.9 vol. % to about 99.5 vol. %, about 96.8 vol. % to about 99.5 vol. %, about 97.7 vol. % to about 99.5 vol. %, about 98.6 vol. % to about 99.5 vol. %, about 95 vol. % to about 98.6 vol. %, about 95 vol. % to about 97.7 vol. %, about 95 vol. % to about 96.8 vol. %, or about 95 vol. % to about 95.9 vol. %, or greater than or equal to about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.45 vol. %, 95.9 vol. %, 96.35 vol. %, or 96.8 vol. %, or less than or equal to about 99.98 vol. %, 99.93 vol. %, 99.88 vol. %, 99.84 vol. %, 99.79 vol. %, 99.74 vol. %, 99.69 vol. %, 99.64 vol. %, 99.6 vol. %, 99.55 vol. %, 99.5 vol. %, 99.05 vol. %, 98.6 vol. %, 98.15 vol. %, or 97.7 vol. %, or about 50 vol. %, 54.5 vol. %, 59 vol. %, 63.5 vol. %, 68 vol. %, 72.5 vol. %, 77 vol. %, 81.5 vol. %, 86 vol. %, 90.5 vol. %, 95 vol. %, 95.22 vol. %, 95.45 vol. %, 95.68 vol. %, 95.9 vol. %, 96.12 vol. %, 96.35 vol. %, 96.58 vol. %, 96.8 vol. %, 97.02 vol. %, 97.25 vol. %, 97.48 vol. %, 97.7 vol. %, 97.92 vol. %, 98.15 vol. %, 98.38 vol. %, 98.6 vol. %, 98.82 vol. %, 99.05 vol. %, 99.28 vol. %, 99.5 vol. %, 99.6 vol. %, 99.64 vol. %, 99.69 vol. %, 99.74 vol. %, 99.79 vol. %, 99.84 vol. %, 99.88 vol. %, 99.93 vol. %, or 99.98 vol. %

16. The aqueous rechargeable zinc battery electrolyte according to any one or more of the preceding paragraphs, wherein the zinc salt is a halide, sulfate, acetate, or triflate zinc salt, optionally zinc sulfate.

17. An aqueous rechargeable zinc battery, comprising the aqueous zinc battery electrolyte according to any one or more of the preceding paragraphs, optionally wherein the aqueous rechargeable zinc battery comprises a base electrolyte that comprises a zinc salt and water.

18. Use of the aqueous rechargeable zinc battery electrolyte additive according to any one or more of the preceding paragraphs, to improve the rechargeability of a zinc battery, optionally wherein the use improves the rechargeability of the aqueous rechargeable zinc battery by from about 10% to about 1000%, or from about 18% to about 1000%, about 26% to about 1000%, about 34% to about 1000%, about 42% to about 1000%, about 50% to about 1000%, about 65% to about 1000%, about 80% to about 1000%, about 95% to about 1000%, about 110% to about 1000%, about 120% to about 1000%, about 140% to about 1000%, about 160% to about 1000%, about 170% to about 1000%, about 180% to about 1000%, about 200% to about 1000%, about 10% to about 920%, about 10% to about 840%, about 10% to about 760%, about 10% to about 680%, about 10% to about 600%, about 10% to about 520%, about 10% to about 440%, about 10% to about 360%, about 10% to about 280%, about 10% to about 200%, about 50% to about 200%, about 80% to about 200%, about 110% to about 200%, about 140% to about 200%, about 170% to about 200%, about 50% to about 170%, about 50% to about 140%, about 50% to about 110%, or about 50% to about 80% compared with an otherwise identical aqueous rechargeable zinc battery without the aqueous zinc battery electrolyte additive in its electrolyte, or greater than or equal to about 10%, 14%, 18%, 22%, 26%, 30%, 34%, 38%, 42%, 46%, 50%, 65%, 80%, 95%, or 110% compared with an otherwise identical aqueous rechargeable zinc battery without the aqueous zinc battery electrolyte additive in its electrolyte, or about 10%, 14%, 18%, 22%, 26%, 30%, 34%, 38%, 42%, 46%, 50%, 58%, 65%, 72%, 80%, 88%, 95%, 100%, 110%, 120%, 120%, 130%, 140%, 150%, 160%, 160%, 170%, 180%, 180%, 190%, 200%, 360%, 440%, 520%, 600%, 680%, 760%, 840%, 920%, or 1000% compared with an otherwise identical aqueous rechargeable zinc battery without the aqueous zinc battery electrolyte additive in its electrolyte.

19. A method for improving the rechargeability of an aqueous rechargeable zinc battery
comprising an electrolyte, said method comprising the following step: combining the aqueous zinc battery electrolyte additive according to any one or more of the preceding paragraphs with the electrolyte to thereby improve the rechargeability of the zinc battery.

20. A method for preventing zinc anode corrosion and zinc dendrite growth in an aqueous rechargeable zinc battery comprising an electrolyte, said method comprising the following step:
combining the aqueous zinc battery electrolyte additive according to any one or more of the preceding paragraphs with the electrolyte to thereby prevent zinc anode corrosion and zinc dendrite growth;
optionally wherein method reduces the amount of zinc anode corrosion and zinc dendrite growth by from about 0.5% to about 100%, or from about 4.4% to about 100%, about 8.3% to about 100%, about 12% to about 100%, about 16% to about 100%, about 20% to about 100%, about 27% to about 100%, about 34% to about 100%, about 41% to about 100%, about 48% to about 100%, about 55% to about 100%, about 62% to about 100%, about 69% to about 100%, about 76% to about 100%, about 83% to about 100%, about 90% to about 100%, about 0.5% to about 99%, about 0.5% to about 98%, about 0.5% to about 97%, about 0.5% to about 96%, about 0.5% to about 95%, about 0.5% to about 94%, about 0.5% to about 93%, about 0.5% to about 92%, about 0.5% to about 91%, about 0.5% to about 90%, about 20% to about 90%, about 34% to about 90%, about 48% to about 90%, about 62% to about 90%, about 76% to about 90%, about 20% to about 76%, about 20% to about 62%, about 20% to about 48%, or about 20% to about 34% compared with an otherwise identical aqueous rechargeable zinc battery without the aqueous zinc battery electrolyte additive in its electrolyte, or greater than or equal to about 0.5%, 2.4%, 4.4%, 6.4%, 8.3%, 10%, 12%, 14%, 16%, 18%, 20%, 27%, 34%, 41%, or 48% compared with an otherwise identical aqueous rechargeable zinc battery without the aqueous zinc battery electrolyte additive in its electrolyte, or about 0.5%, 2.4%, 4.4%, 6.4%, 8.3%, 10%, 12%, 14%, 16%, 18%, 20%, 24%, 27%, 30%, 34%, 38%, 41%, 44%, 48%, 52%, 55%, 58%, 62%, 66%, 69%, 72%, 76%, 80%, 83%, 86%, 90%, 92%, 93%, 94%, 95%, 96%, 97%, 98%, 99%, or 100% compared with an otherwise identical aqueous rechargeable zinc battery without the aqueous zinc battery electrolyte additive in its electrolyte.

21. A method for producing an aqueous rechargeable zinc battery electrolyte, comprising combining the aqueous zinc battery electrolyte additive according to any one or more of the preceding paragraphs with a base electrolyte, wherein said base electrolyte comprises a zinc ion.

Although the invention has been described with reference to specific examples, it will be appreciated by those skilled in the art that the invention may be embodied in many other forms. In particular, features of any one of the various described examples may be provided in any combination in any of the other described examples. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. An aqueous rechargeable zinc battery electrolyte additive comprising:
an aliphatic alcohol compound having from 4 to 10 carbon atoms.

2. The aqueous rechargeable zinc battery electrolyte additive of claim 1, wherein the aliphatic alcohol compound has from 4 to 8 carbon atoms; optionally where the aliphatic alcohol compound has from 4 to 7 carbon atoms; optionally 4 or 5 carbon atoms.

3. The aqueous rechargeable zinc battery electrolyte additive of claim 1 or 2, wherein the aliphatic alcohol compound is saturated and acyclic.

4. The aqueous rechargeable zinc battery electrolyte additive of any one of claims 1 to 3, wherein the aliphatic alcohol compound contains one or two hydroxyl groups.

5. The aqueous rechargeable zinc battery electrolyte additive of any one of claims 1 to 4, wherein the aliphatic alcohol compound is a diol.

6. The aqueous rechargeable zinc battery electrolyte additive of claim 5, wherein the diol is selected from the group consisting of butanediol, pentanediol, hexanediol, heptanediol, octanediol, and mixtures thereof.

7. The aqueous rechargeable zinc battery electrolyte additive of claim 5 or 6, wherein the diol is selected from the group consisting of 1,2-butanediol; 1,3-butanediol; 1,4-butanediol; 2,3-butanediol; 1,2-pentanediol; 1,3-pentanediol; 1,4-pentanediol; 1,5-pentanediol; 2,3-pentanediol; 2,4-pentanediol; 1,2-hexanediol; 1,3-hexanediol; 1,4-hexanediol; 1,5-hexanediol; 1,6-hexanediol; 1,2-heptanediol; 1,2-octanediol; and mixtures thereof.

8. The aqueous rechargeable zinc battery electrolyte additive of any one of claims 5 to 7, wherein the diol is a 1,2-diol.

9. The aqueous rechargeable zinc battery electrolyte additive of any one of claims 5 to 8, wherein the diol is 1,2-butanediol or 1,2-pentanediol.

10. The aqueous rechargeable zinc battery electrolyte additive of any one of claims 1 to 4, wherein the aliphatic alcohol compound is selected from the group consisting of 1-butanol; 1,2-butanediol; and 1,2-pentanediol.

11. An aqueous rechargeable zinc battery electrolyte comprising:
the zinc ion battery electrolyte additive of any one of claims 1 to 10; and
a zinc salt.

12. The aqueous rechargeable zinc battery electrolyte of claim 11, which has a pH from about 0 to about 7, optionally from about 3 to about 6.

13. The aqueous rechargeable zinc battery electrolyte of claim 11 or 12, which comprises from about 0.05 vol. % to about 10 vol. % of the aliphatic alcohol compound.

14. The aqueous rechargeable zinc battery electrolyte of any one of claims 11 to 13, which comprises from about 0.1 vol. % to about 2 vol. % of the aliphatic alcohol compound; optionally about 1 vol. % of the aliphatic alcohol compound.

15. The aqueous rechargeable zinc battery electrolyte of any one of claims 11 to 14, wherein the concentration of the zinc salt in the electrolyte is from about 0.05 M to about 3 M; optionally wherein the concentration of the zinc salt in the electrolyte is about 1 M.

16. The aqueous rechargeable zinc battery electrolyte of any one of claims 11 to 15, wherein the zinc salt is zinc sulfate.

17. An aqueous rechargeable zinc battery, comprising the aqueous zinc battery electrolyte of any one of claims 11 to 16.

18. Use of the aqueous rechargeable zinc battery electrolyte additive of any one of claims 1 to 10, to improve the rechargeability of a zinc battery.

19. A method for improving the rechargeability of an aqueous rechargeable zinc battery comprising an electrolyte, said method comprising the following step:
combining the aqueous zinc battery electrolyte additive of any one of claims 1 to 10 with the electrolyte to thereby improve the rechargeability of the zinc battery.

20. A method for preventing zinc anode corrosion and zinc dendrite growth in an aqueous rechargeable zinc battery comprising an electrolyte, said method comprising the following step:
combining the aqueous zinc battery electrolyte additive of any one of claims 1 to 10 with the electrolyte to thereby prevent zinc anode corrosion and zinc dendrite growth.

21. A method for producing an aqueous rechargeable zinc battery electrolyte, comprising combining the aqueous zinc battery electrolyte additive of any one of claims 1 to 10 with a base electrolyte, wherein said base electrolyte comprises a zinc ion.
